(19) United States
(12) Patent Application Publication
(10) Pub. No.: US 2021/0357111 A1
(43) Pub. Date: Nov. 18, 2021

(54) COMMUNICATING WITH AND CONTROLLING LOAD CONTROL SYSTEMS

(71) Applicant: Lutron Technology Company LLC, Coopersburg, PA (US)

(72) Inventors: Karelys Alfonzo, Philadelphia, PA (US); Nayda Aponte, Northhampton, PA (US); Brad Michael Kreschollek, Bethlehem, PA (US); Gregory S. Altonen, Easton, PA (US); Shenchi Tian, Easton, PA (US); Xiangzhu Chen, Allentown, PA (US)

(73) Assignee: Lutron Technology Company LLC, Coopersburg, PA (US)

(21) Appl. No.: 17/321,288

(22) Filed: May 14, 2021

Related U.S. Application Data
(60) Provisional application No. 63/025,075, filed on May 14, 2020.

(51) Int. Cl. G06F 3/0484; G06F 3/0488; H05B 47/10

(52) U.S. Cl. CPC G06F 3/04847; H05B 47/10; G06F 3/04883

(57) ABSTRACT

Systems and methods are disclosed for communicating via a communications network with a load control system of a respective user environment, receiving information on the load control system via the communications network, displaying graphical user interfaces based on the received information, and controlling and configuring the load control system via graphical user interfaces by communicating via the communications network messages the load control system.

### CROSS REFERENCE

This application claims priority from U.S. Provisional Patent Application No. 63/025,075, filed May 14, 2020, which is incorporated by reference in its entirety herein.

### BACKGROUND

A user environment, such as a residence, an office building, or a hotel for example, may be configured to include various types of load control systems. For example, a lighting control system may be used to control the lighting loads in the user environment. A motorized window treatment control system may be used to control the natural light provided to the user environment. A heating, ventilating, and air conditioning (HVAC) system may be used to control the temperature in the user environment.

### SUMMARY

One or more computing device may be implemented in a load control system to perform communication with and control of load control devices. The load control devices may comprise lighting control devices capable of being controlled to lighting intensity values and having different color settings. The one or more computing devices may display a graphical user interface that enables configuration of scenes for controlling zones of lighting control devices configured to control corresponding lighting loads.

The graphical user interface may include a scene identification interface that comprises an indication of each of a plurality of scenes that may be configured for an area of the load control system. The graphical user interface may include a zone identification interface that identifies each of one or more zones with a corresponding lighting intensity and color setting. The graphical user interface may include a control interface that comprises a lighting intensity bar for configuring the lighting intensity and/or a palette for configuring the color setting for at least one of the one or more zones.

The one or more computing devices may receive a selection of a scene indicated in the scene identification interface. In response to receiving the selection of the scene, the one or more computing devices may update the lighting intensity and the color setting identified for each of the one or more zones in the zone identification interface according the selected scene. The one or more computing devices may receive a selection of a zone identified in the zone identification interface. In response to receiving the selection of the zone, the one or more computing devices may update the lighting intensity bar and the palette with the respective lighting intensity setting and color setting that are stored in the selected scene for the selected zone.

The one or more computing devices may receive change to at least one of the lighting intensity setting or the color setting via the control interface. A change may be configured to cause a change from a first lighting intensity setting to a second lighting intensity setting or a first color setting to a second color setting. The one or more computing devices may control the lighting intensity or the color setting of the corresponding lighting load in the selected zone to the second lighting intensity setting or the second color setting.

The one or more computing devices may receive an indication from a user to save the change to the selected scene and update system configuration data to control the selected zone to the second lighting intensity setting or the second color setting in response to an activation of the selected scene. In response to receiving a triggering event configured to trigger the activation of the selected scene, the one or more zones may be controlled according to the updated system configuration data.

The lighting intensity bar may be configured to display in at least one of a first and a second of a plurality of resolution states to enable different resolutions of control for a user. When the lighting intensity bar is displayed in the graphical user interface in the first resolution state, the one or more computing devices may receive a first input from the user in the lighting intensity bar that is configured to cause the lighting intensity to change over a first range of lighting intensity values from a current lighting intensity value to a first lighting intensity value. The first input may cause a control indicator in the lighting intensity bar to move by a first distance on the graphical user interface to indicate the change in the lighting intensity over the first range of lighting intensity values.

The one or more computing devices may receive an indication to change the lighting intensity bar from the first resolution state to the second resolution state. When the lighting intensity bar is displayed in the graphical user interface in the second resolution state, the one or more computing devices may receive a second input from the user in the lighting intensity bar. The second input may cause the lighting intensity to change over a second range of lighting intensity values from the first lighting intensity value to a second lighting intensity value. The second input may cause the control indicator in the lighting intensity bar to move by a second distance on the graphical user interface to indicate the change in the lighting intensity over the second range of lighting intensity values. The second distance over which the control indicator moves may be greater than or equal to the first distance. The second range of lighting intensity values may be less than the first range of lighting intensity values over which the lighting load is controlled.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a system diagram that illustrates an example load control system that includes control-devices.

FIG. 2 is a block diagram of an example network device.

FIGS. 3A and 3B are flowcharts depicting an example procedure for configuring and/or controlling a load control system.

FIGS. 4A-4G show example graphical user interfaces of an application that may allow a user to determine scene information and to control a load control system and/or one or more load control devices.

FIGS. 5A-5Z show additional example graphical user interfaces of an application that may allow a user to determine scene information and to control a load control system and/or one or more load control devices.

FIG. 6 is a block diagram of an example system controller.

FIG. 7 is a block diagram of an example control-target device.

FIG. 8 is a block diagram of an example control-source device.

### DETAILED DESCRIPTION

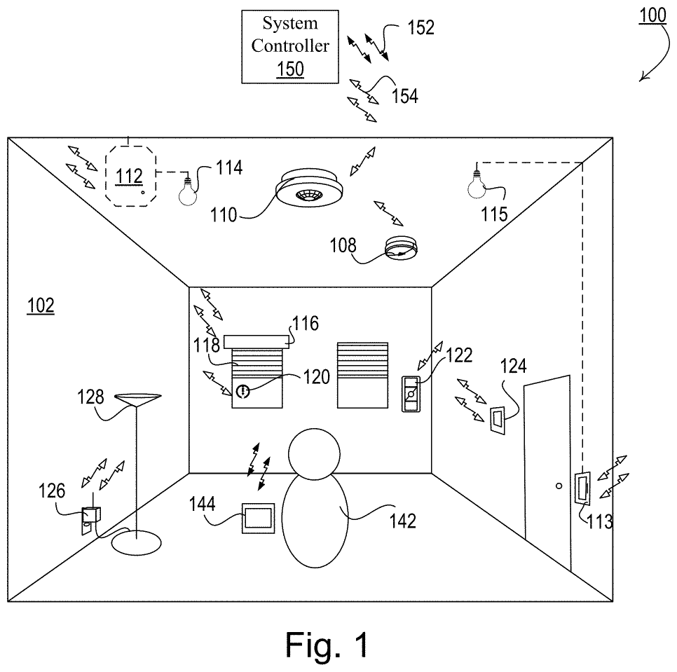

FIG. 1 shows a high-level diagram of an example load control system 100. Load control system 100 may include a system controller 150 and load control devices for controlling (e.g., directly and/or indirectly) one or more electrical loads in a user environment 102 (also referred to herein as a load control environment). Example user environments/load control environments 102 may include one or more rooms of a home, one or more floors of a building, one or rooms of a hotel, etc. As an example, load control system 100 may enable the automated control of lighting systems, shades, and heating, ventilating, and air conditioning (HVAC) systems in the user environment, among other electrical loads.

The load control devices of load control system 100 may include a system controller 150, control-source devices (e.g., elements 108, 110, 120, and 122 discussed below), and control-target devices (e.g., elements 112, 113, 116, 124, and 126 discussed below) (control-source devices and control-target devices may be individually and/or collectively referred to herein as load control devices and/or control devices). The system controller 150, the control-source devices, and the control-target devices may be configured to communicate (transmit and/or receive) messages, such as digital messages (although other types of messages may be communicated), between one another using wireless signals 154 (e.g., radio-frequency (RF) signals), although wired communications may also be used. “Digital” messages will be used herein for discussion purposes only.

The control-source devices may include, for example, input devices that are configured to detect conditions within the user environment 102 (e.g., user inputs via switches, occupancy/vacancy conditions, changes in measured light intensities, and/or other input information) and in response to the detected conditions, transmit messages to control-target devices that are configured to control electrical loads in response to instructions or commands received in the messages. The control-target devices may include, for example, load control devices that are configured to receive messages from the control-source devices and/or the system controller 150 and to control respective electrical loads in response to the received messages. A single control device of the load control system 100 may operate as both a control-source device and a control-target device.

According to one example, the system controller 150 may be configured to receive the messages transmitted by the control-source devices, to interpret these messages based on a configuration of the load control system, and to then transmit messages to the control-target devices for the control-target devices to then control respective electrical loads. In other words, the control-source devices and the control-target device may communicate via the system controller 150. According to another and/or additional example, the control-source devices may directly communicate with the control-target devices without the assistance of the system controller 150. The system controller may still monitor such communications. According to a further and/or additional example, the system controller 150 may originate and then communicate messages with control-source devices and/or control-target devices. Such communications by the system controller 150 may include programming/configuration data (e.g., settings) for the control devices, such as configuring scene buttons on light switches. Communications from the system controller 150 may also include, for example, messages directed to control-target devices and that contain instructions or commands for the control-target devices to control respective electrical loads in response to the received messages. For example, the system controller 150 may communicate messages to change light levels, to change shade levels, to change HVAC settings, etc. These are examples and other examples are possible.

Communications between the system controller 150, the control-source devices, and the control-target devices may be via a wired and/or wireless communications network as indicated above. One example of a wireless communications network may be a wireless LAN where the system controller, control-source devices, and the control-target devices may communicate via a router, for example, that is local to the user environment 102. For example, such a network may be a standard Wi-Fi network. Another example of a wireless communications network may be a point-to-point communications network where the system controller, control-source devices, and the control-target devices communicate directly with one another using, for example, Bluetooth, Wi-Fi Direct, a proprietary communication channel, such as CLEAR CONNECTTM, etc. to directly communicate. Other network configurations may be used such as the system controller acting as an access point and providing one or more wireless/wired based networks through which the system controller, the control-source devices, and the control-target devices may communicate.

For a control-target device to be responsive to messages from a control-source device, the control-source device may first need to be associated with the control-target device. As one example of an association procedure, a control-source device may be associated with a control-target device by a user 142 actuating a button on the control-source device and/or the control-target device. The actuation of the button on the control-source device and/or the control-target device may place the control-source device and/or the control-target device in an association mode for being associated with one another. In the association mode, the control-source device may transmit an association message(s) to the control-target device (directly or through the system controller). The association message from the control-source device may include a unique identifier of the control-source device. The control-target device may locally store the unique identifier of the control-source, such that the control-target device may be capable of recognizing messages (e.g., subsequent messages) from the control-source device that may include load control instructions or commands. The control-target device may be configured to respond to the messages from the associated control-source device by controlling a corresponding electrical load according to the load control instructions received in the messages. This is merely one example of how control devices may communicate and be associated with one another and other examples are possible. According to another example, the system controller 150 may receive configuration instructions from a user that specify which control-source devices should control which control-target devices. Thereafter, the system controller may communicate this configuration information to the control-source devices and/or control-target devices.

As one example of a control-target device, load control system 100 may include one or more lighting control devices, such as the lighting control devices 112 and 113. The lighting control device 112 may be a dimmer, an electronic switch, a ballast, a light emitting diode (LED) driver(s), and/or the like. The lighting control device 112 may be configured to directly control an amount of power provided to a lighting load(s), such as lighting load 114. The lighting control device 112 may be configured to wirelessly receive messages via signals 154 (e.g., messages originating from a control-source device and/or the system controller 150), and to control the lighting load 114 in response to the received messages. One will recognize that lighting control device 112 and lighting load 114 may be integral and thus part of the same fixture or may be separate.

The lighting control device 113 may be a wall-mounted dimmer, a wall-mounted switch, or other keypad device for controlling a lighting load(s), such as lighting load 115. The lighting control device 113 may be adapted to be mounted in a standard electrical wall box. The lighting control device 113 may include one or more buttons for controlling the lighting load 115. The lighting control device 113 may include a toggle actuator. Actuations (e.g., successive actuations) of the toggle actuator may toggle (e.g., turn off and on) the lighting load 115. The lighting control device 113 may include an intensity adjustment actuator (e.g., a rocker switch or intensity adjustment buttons). Actuations of an upper portion or a lower portion of the intensity adjustment actuator may respectively increase or decrease the amount of power delivered to the lighting load 115 and thus increase or decrease the intensity of the receptive lighting load from a minimum intensity (e.g., approximately 1%) to a maximum intensity (e.g., approximately 100%). The lighting control device 113 may include a plurality (two or more) of visual indicators, e.g., light-emitting diodes (LEDs), which may be arranged in a linear array and that may illuminate to provide feedback of the intensity of the lighting load 115.

The lighting control device 113 may be configured to wirelessly receive messages via wireless signals 154 (e.g., messages originating from a control-source device and/or the system controller 150). The lighting control device 113 may be configured to control the lighting load 115 in response to the received messages.

The load control system 100 may include one or more other control-target devices, such as a motorized window treatment 116 for directly controlling the covering material 118 (e.g., via an electrical motor); ceiling fans; a table top or plug-in load control device 126 for directly controlling a floor lamp 128, a desk lamp, and/or other electrical loads that may be plugged into the plug-in load control device 126; and/or a temperature control device 124 (e.g., thermostat) for directly controlling an HVAC system (not shown). The load control system 100 may also, or alternatively, include an audio control device (e.g., a speaker system) and/or a video control device (e.g., a device capable of streaming video content). Again, these devices may be configured to wirelessly receive messages via wireless signals 154 (e.g., messages originating from a control-source device and/or the system controller 150). These devices may be configured to control respective electrical loads in response to the received messages.

Control-target devices, in addition to being configured to wirelessly receive messages via wireless signals and to control respective electrical loads in response to the received messages, may also be configured to wirelessly transmit messages via wireless signals (e.g., to the system controller 150 and/or an associated control device(s)). A control-target device may communicate such messages to confirm receipt of messages and actions taken, to report status (e.g., light levels), etc. Again, control-target devices may also or alternatively communicate via wired communications.

With respect to control-source devices, the load control system 100 may include one or more remote-control devices 122, one or more occupancy sensors 110, one or more daylight sensors 108, and/or one or more window sensors 120. The control-source devices may wirelessly send or communicate messages via wireless signals, such as signals 154, to associated control-target devices for controlling an electrical load. The remote-control device 122 may send messages for controlling one or more control-target devices after actuation of one or more buttons on the remote-control device 122. One or more buttons may correspond to a preset scene for controlling the lighting load 115, for example. The occupancy sensor 110 may send messages to control-target devices in response to an occupancy and/or vacancy condition (e.g., movement or lack of movement) that is sensed within its observable area. The daylight sensor 108 may send messages to control-target devices in response to the detection of an amount of light within its observable area. The window sensor 120 may send messages to control-target devices in response to a measured level of light received from outside of the user environment 102. For example, the window sensor 120 may detect when sunlight is directly shining into the window sensor 120, is reflected onto the window sensor 120, and/or is blocked by external means, such as clouds or a building. The window sensor 120 may send messages indicating the measured light level. The load control system 100 may include one or more other control-source devices. Again, one will recognize that control-source devices may also or alternatively communicate via wired communications.

Turning again to the system controller 150, it may facilitate the communication of messages from control-source devices to associated control-target devices and/or monitor such messages as indicated above, thereby knowing when a control-source device detects an event and when a control-target device is changing the status/state of an electrical load. It may communicate programming/configuration information to the control devices. The system controller 150 may also be the source of control messages to control-target devices, for example, instructing the devices to control corresponding electrical loads. As one example of the later, the system controller may run one or more time-clock operations that automatically communicates messages to control-target devices based on configured schedules (e.g., commands to lighting control device 113 to adjust light 115, commands to motorized window treatment 116 for directly controlling the covering material 118, etc.) For description purposes only, shades will be used herein to describe functions and features related to motorized window treatments. Nonetheless, one will recognize that features and functions described herein are applicable to other types of window coverings such as drapes, curtains, blinds, etc. Other examples are possible.

According to a further aspect of load control system 100, the system controller 150 may be configured to communicate with one or more network devices 144 in use by a user(s) 142, for example. The network device 144 may include a personal computer (PC), a laptop, a tablet, a smart phone, or equivalent device. The system controller 150 and the network device 144 may communicate via a wired and/or wireless communications network. The communications network may be the same network used by the system controller and the control devices, or may be a different network (e.g., a wireless communications network using wireless signals 152). As one example, the system controller 150 and the network device 144 may communicate over a wireless LAN (e.g., that is local to the user environment 102). For example, such a network may be a standard Wi-Fi network provided by a router local to the user environment 102. As another example, the system controller 150 and the network device 144 may communicate directly with one-another using, for example, Bluetooth, Wi-Fi Direct, etc. Other examples are possible such as the system controller acting as an access point and providing one or more wireless/wired based networks through which the system controller and network device may communicate.

In general, the system controller 150 may be configured to allow a user 142 of the network device 144 to determine, for example, the configuration of the user environment 102 and load control system 100, such as rooms in the environment, which control devices are in which rooms (e.g., the location of the control devices within the user environment, such as which rooms), to determine the status and/or configuration of control devices (e.g., light levels, HVAC levels, shade levels), to configure the system controller (e.g., to change time clock schedules), to issue commands to the system controller in order to control and/or configure the control devices (e.g., change light levels, change HVAC levels, change shade levels, change presets, etc.), etc. Other examples are possible.

The load control system 100 of FIG. 1 may be configured such that the system controller 150 is only capable of communicating with a network device 144 when that device is local to the system controller, in other words, for the two to directly communicate in a point-to-point fashion or through a local network specific to the user environment 102 (such as a network provided by a router that is local to the user environment). It may be advantageous to allow a user of network device 144 to communicate with the system controller 150 and to control the load control system 100 from remote locations, such as via the Internet or other public or private network. Similarly, it may be advantageous to allow third-party integrators to communicate with the system controller 150 in order to provide enhanced services to users of user environment 102. For example, a third-party integrator may provide other systems within user environment 102. It may be beneficial to integrate such systems with load control system 100.

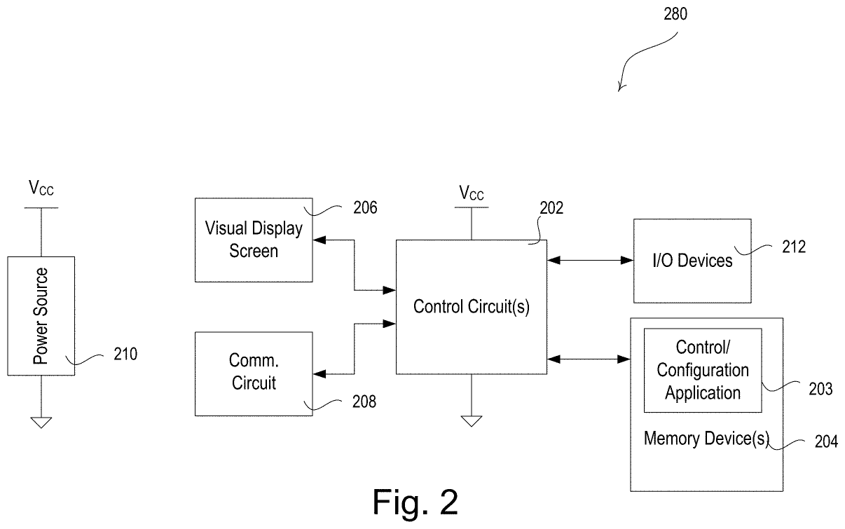

FIG. 2 shows an example block diagram of network device 280 (this diagram may also apply to the network devices 144, a remote network device, or another computing device capable of network communications, for example). Network device 280 may include one or more general purpose processors, special purpose processors, conventional processors, digital signal processors (DSPs), microprocessors, microcontrollers, integrated circuits, programmable logic devices (PLD), application specific integrated circuits (ASICs), or the like and/or may further include other processing element(s) such as one or more graphic processors (hereinafter collectively referred to as control circuits(s) 202). Control circuit(s) 202 may control the functionality of the network device and may execute the control/configuration application 203, in addition to other software applications such an operating system(s), database management systems, etc., to provide features and functions as describe herein. The control circuit(s) 202 may also perform signal coding, data processing, power control, input/output processing, and any other functionality that enables the network device 280 to perform as described herein. The network device 280 may also include one or more memory 204 (including volatile and non-volatile memory) which may be non-removable memory and/or a removable memory.

Memory 204 may be communicatively coupled to the control circuit(s) 202. Non-removable memory 204 may include random-access memory (RAM), read-only memory (ROM), a hard disk(s), or any other type of non-removable memory storage. Removable memory 204 may include a subscriber identity module (SIM) card, a memory stick, a memory card, or any other type of removable memory. The one or more memory 204 may store the control/configuration application 203 and may also provide an execution space as the processor(s) execute the control/configuration application. Network device 280 may also include a visual display screen(s)/terminal(s) 206 that may be communicatively coupled to the control circuit(s) 202. Together with control circuit(s) 202, visual display screen(s) 206 may display information to the user via one or more GUI based interfaces/GUI based “window(s)” as described herein. The display screen(s) 206 and the control circuit(s) 202 may be in two-way communication, as the display screen 206 may include a touch sensitive visual screen component configured to receive information from a user and providing such information to the control circuit(s) 202

Network device 280 may also include one or more input/output (I/O) devices 212 (e.g., a keyboard, a touch sensitive pad, a mouse, a trackball, audio speaker, audio receiver, etc.) that may be communicatively coupled to the control circuit(s) 202. The I/O devices may allow the user to interact with the control/configuration application 203, for example. Network device 280 may further include one or more transceivers/communications circuits (collectively, communications circuit(s) 208) for communicating (transmitting and/or receiving) over wired and/or wireless communication networks, for example. The communications circuit(s) 208 may include an RF transceiver(s) or other circuit(s) configured to perform wireless communications via an antenna(s). Communications circuit(s) 208 may be in communication with control circuit(s) 202 for transmitting and/or receiving information. Each of the components within the network device 280 may be powered by a power source 210. The power source 210 may include an AC power supply and/or DC power supply, for example. The power source 210 may generate a supply voltage(s) Vcc for powering the components within the network device 280.

In addition to including GUI based software components, for example, that provide the graphical features and visual images described herein, the control/configuration application 203 may also include a logic engine(s) for providing features of the GUI and features of the application in general as described herein. The GUI based software components and/or logic engine may be one or more software based components that include instructions, for example, that are stored on and/or execute from one or more tangible memory devices/components of the network device as indicated above. Features of the control/configuration application may also and/or alternatively be provided by firmware and/or hardware in addition to/as an alternative to software based components. Again, network device 280 is an example and the control/configuration application may execute on other types of computing devices.

As indicted, network device 280 may be similar to the network device 144 (e.g., including an external network device accessed via a cloud), as described herein. Accordingly, the control/configuration application may communicate with the other devices of the user environment (e.g., the system controller, control-source devices, control-target devices etc.) via a network local to the user environment (such as a Wi-Fi network). Nonetheless, one will recognize that the control/configuration application 203/network device 280 may communicate with other devices using other communication systems and/or protocols, etc. In addition, the control/configuration application 203 is described herein as being a self-contained application that executes on the network device 280 and communicates messages with the system controller, for example. In other words, logic of the control/configuration application and generated graphics associated with the application are described herein as executing from the network device. Nonetheless, features and/or graphics of the control/configuration application may be implemented in other fashions, such as a web hosted application with the network device interfacing with the web hosted application using a local application (e.g., a web browser or other application) for providing features and functions as described herein. As one example, the system controller may function as the web host.

In general, while a user environment may include control devices that the control/configuration application/network device 280 may interact with, control, and/or configure via a system controller (e.g., the system controller 150), the user environment may also include other types of control devices that may be, for example, Wi-Fi enabled and/or internet of things enabled control devices for example (e.g., devices that are configured to communicate via wireless and/or wired based networks, such as HomeKit). For description purposes, such other control devices (e.g., control devices to which the control/configuration application and/or network device 280 does not communicate with via the system controller) may be referred to herein as Wi-Fi enabled and/or HomeKit enabled control devices. Nonetheless, one will recognize that the features described herein are not limited to Wi-Fi enabled and/or HomeKit enabled control devices. Examples of such other control devices may include lighting control devices/bulbs, thermostats, fans, etc.

Network device 280 and the Wi-Fi enabled control devices, for example, may be configured to directly communicate with each other without having to communicate through a system controller (e.g., if the network device is also HomeKit enabled), and/or may communicate via one or more cloud based servers, for example, again without communicating through the system controller. According to one aspect of the control/configuration application 203 described herein, assuming the network device 280 is configured to communicate with such Wi-Fi enabled control devices (e.g., via HomeKit), for example, the control/configuration application may be configured to also interact with, control, and/or configure these devices, in addition to control devices. In so doing, the control/configuration application may combine within the graphical interfaces described herein information obtained from such Wi-Fi enabled devices, for example, and information obtained on control devices that are controlled by the system controller.

The control/configuration application 203 may also provide interfaces that allow a user to control and/or configure both Wi-Fi enabled control devices, for example, and control devices that are controlled by the system controller. For ease of description, the control/configuration application 203 will be described herein as interacting with control devices of a load control system. Nonetheless, similar functionality as described herein may also apply to Wi-Fi enabled devices that may not be controlled via the system controller and to which the network device may directly and/or indirectly communicate. One will also recognize that the control/configuration application described herein may alternatively control Wi-Fi enabled devices, for example, with which the network device 280 is configured to directly and/or indirectly control/interact with. Again, one will further recognize that while control/configuration application 203 is described herein in the context of a load control system and communication systems, the features and functions of the control/configuration application are applicable to other types of control devices, load control systems, and communication systems including for example, Wi-Fi enabled and/or HomeKit enabled systems

As one example, the network device 280 may display to a user via a visual display screen 206 an icon associated with the control/configuration application 203. The network device 280 may detect the selection of the icon by the user (e.g., such as detecting the using touching the icon) and in response, may start (e.g., which may also be referred to herein as launching, running, executing, activating and/or invoking) the control/configuration application 203. The control/configuration application may be started in other ways, including the network device being configured to automatically start the application upon being reset and/or powered on. In response to being started or launched, the control/configuration application (in addition to performing security/authentication procedures, for example) may communicate one or more messages to the system controller, for example, to obtain/request/query for various information, such as status/state and/or configuration information of the load control system, and use this information to initially generate and display to the user via the display screen of the network device 280 a graphical user interface. Again, at starting, for example, the control/configuration application may also communicate with Wi-Fi enabled devices, for example, the network devices have been configured to communicate with. Thereafter, the control/configuration application may continue to request and/or receive various information from the system controller at various times depending on what information the control/configuration application may need to display to the user and/or is being generated by the system controller. Again, the control/configuration application 203 may also communicate with Wi-Fi enabled devices in a similar fashion.

Upon receiving information requests from the control/configuration application 203 (such as requests for status and configuration information), the system controller may respond by communicating with control devices and/or a database(s), for example, to determine and provide the requested information and respond to the control/configuration application with one or more response messages. In addition to determining status and configuration of the load control system, for example, the control/configuration application 203 may also allow a user to communicate messages to the system controller to modify, edit, or change the configuration and/or state of the load control system as further described herein. In addition, the system controller may also asynchronously provide status and configuration information to the control/configuration application (e.g., provide an indication of status/state changes of control devices without the control/configuration application querying for such changes). The control/configuration application may use this information to update various graphical user interfaces displayed to the user via the network device 280. Again, Wi-Fi enabled devices and the control/configuration application and/or network device may interact in similar fashions.

Before turning to the various graphical user interfaces, the control/configuration application 203 may provide to a user, a description of example types of information the control/configuration application may request/receive and/or configure, for example, to generate interfaces is discussed. For example, as described herein, the control/configuration application may request/obtain this information from another device (e.g. system controller and/or one more control source devices). Also, or alternatively, the information may be maintained or stored locally (e.g., stored at the memory device(s) 204). In addition to receiving this information, the control/configuration application may also alter such information at the system controller, as described herein.

The control/configuration application may request/obtain information related to the configuration and current state/status of a load control system from another device in the load control system, such as the system controller and/or one or more control source devices (e.g., the remote-control device 122). Also, or alternatively, the network device 280 may itself store or maintain the configuration and current state/status information (e.g. or a subset of the configuration and current stat/status information), and the control/configuration application 203 may request/obtain this information from the memory device(s) 204. Such information may include, for example, the specific control devices that are part of the load control system including an identifier that indicates the type of the control device The specific control device types may include, for example, one or more lighting control devices (also referred to herein also as lighting devices) that each directly controls one or more respective electrical lighting loads/lights, one or more temperature control devices (such as and hereinafter also referred to as a thermostat device(s)) that directly control respective HVAC systems, one or more ceiling fan devices (also referred to herein as fan devices) that each directly controls one or more respective fans (e.g., on, off, fan speed), one or more audio control devices (e.g., a speaker system), and one or more window shade devices that each directly controls positions or levels of one or more respective shades (One will recognize that while shade devices and shades are discussed herein as an example of motorized window treatments and window covering, other types of motorized window treatments and window coverings are possible such as drapes, curtains, blinds, etc.).

The control source devices may include one or more keypads, such as wall-mounted keypads, tabletop keypads, and/or remote-control/handheld keypads and devices (e.g., remote-control device 122). As an example, a given keypad may include one or more actuators such as buttons (although other types of actuators are possible), and may be configured to control one or more control devices/electrical loads (e.g., lighting control devices/lighting load(s), HVAC system(s), shade(s), fan(s), and/or speaker(s), etc.). A keypad may include different types of actuators such as on/off actuators, raise lower actuators for lights or shades, fan speed actuators, scene actuators, etc. For example, a scene actuator may set one or more control devices/electrical loads controlled by the keypad to a pre-set configuration (e.g., a scene, as described herein).

The configuration and current state/status information may also include a location indicator for each control device that may indicate a location of the device within the user environment and/or the location of the electrical loads the device controls. This indicator may be in the form of a location name (e.g., a text string) and/or an indicator that may be translated into a location name (e.g., a text string), although other mechanisms may be used. For example, assuming the user environment is a home, possible locations may include standard locations like “kitchen,” “living room,” “family room,” “dining room,” “master bedroom,” “bedroom,” “master bathroom,” “bathroom,” “basement,” “front porch,” “office,” “lobby,” “conference room,” etc. Locations may also include sub-locations in a room like “basement—sitting area,” “basement—game area,” basement—work area,” basement—storage area,” etc. Locations may also include user defined/customized locations like: “Mary's bedroom,” “John's bedroom,” etc. The location of a control device may be programmed into the load control system (and stored in database, for example) by a user when installing the system within the user environment. One will recognize these are examples.

For lighting control devices, the configuration and current state/status information may also include a type indicator that may indicate a type of a lighting load(s) (also referred to herein as a light(s)) controlled by the control device. A type of a lighting load may include, for example, the function/purpose of the lighting load within its defined location and/or indicate/suggest a specific location of the lighting load within its defined location (e.g., ceiling light vs floor lamp). A type indicator may be in the form of a name/function (e.g., a text string) and/or an indicator that may be translated into a name/function (e.g., a text string), although other mechanism may be used. As an example, assuming the user environment is a home, standard types may include ceiling or overhead light, chandelier, pendant(s), table lamp(s), floor lamp(s), sconce(s), sink light(s) (e.g., for a kitchen or bathroom), island light(s) (e.g., for a kitchen), closet light(s), accent lights, downlights, desk area lights, etc. Types may also include user defined/customized types. The type of lighting load may be programmed into load control system (and stored in a database, for example) by a user when installing the system within the user environment. One will recognize these are examples. Types may also apply to other control devices such as fans, shades, and keypads. Again, the type indicator may provide an indication of a specific function and or location within the device's defined location. Other example types may include “left shade,” “right shade,” “center shade,” “wall keypad,” “tabletop keypad,” etc.

As described herein, the current state/status information may also include a current status/state and/or configuration of one or more of the control devices. For example, for a lighting control device the status information may include whether the respective lighting load(s) are in an on or off state, and if in the on state whether it is a dimmed state and possibly further the dimming level, color setting, vibrancy setting, etc. The control/configuration application may allow the user to modify scenes and to create new scenes via the network device. For an occupancy sensor, the status information may include, for example, whether the sensor has detected an occupancy event/condition and/or is in an occupancy state, has detected a continued occupancy event/condition and/or is in a continued occupancy state, and/or has detected a vacancy condition and/or is in a vacancy state. Again, these are examples and other information is possible.

As another example, a device in the load control system, such as the system controller and/or one or more control source devices, may maintain information related to one or more pre-programmed scenes that may be actuated by a user from an application, such as the control/configuration application 203 or a control source device, such as the remote-control device 122. A scene may include, for example, certain settings for one or more lights, shades, etc. The device may maintain respective scene configuration information in a database. The control/configuration application may request/obtain information related to these pre-programmed scenes and as further described below, thereafter allow the user, via the network device, to a select a given scene, resulting in the control/configuration application instructing the another device (e.g., the system controller and/or one more control source devices) to configure control devices according to the selected scene (e.g., set one more light levels, fan speeds, shade levels, etc.). As also described below, the control/configuration application may allow a user to modify the pre-programmed scenes maintained and to create and store new scenes that may subsequently be selected by the user. After the scenes are created and stored, the scenes may be assigned. For example, a scene may be assigned to one or more zones in the load control system, and enabled by, for example, pressing a certain button at a remote control device.

As a still further example, various time clock schedules may be maintained where a schedule may be, for example, a certain setting for one or more control devices (e.g., lights, shades, etc.) that the system controller or one more control-source devices automatically configure based on the schedule. For example, the system controller may maintain respective time clock schedules in a database and the status of these schedules, such as whether a given schedule is active, inactive, or disabled. The control/configuration application may obtain control information related to these time clock schedules and as further described below, thereafter allow the user via the network device to modify these schedules and to create new schedules.

A load control system may be configured and/or controlled according to one or more defined scenes. Also, or alternatively, the load control system may be further divided into one or more areas or locations (e.g., depending on the size of the load control system or user environment), and each of the areas or locations within the load control system may be configured and/or control according to one or more scenes. The scenes may be activated, for example, in response to a button press at a control source device (e.g., remote control device 122), via a graphical user interface on a network device (e.g., the network devices 144, 280), and/or based on a time clock, as described herein.

As described herein, the devices in a load control system may be grouped or organized together based on their respective location within the user environment. For example, the devices in a load control system may be grouped and/or organized based on their respective location in the user environment (e.g. the devices in a single room may be organized or grouped together). After the devices are grouped or organized based on their location in the user environment, the devices may also be assigned to a certain zone. For example, the lighting devices in a certain location of a user environment may be assigned to a zone based on their respective function (e.g., the lighting control devices that are intended to emit light a certain surface, such as desk, may be grouped or organized together in a “Desk Area” zone).

Grouping or organizing the devices in a load control system based on their location and then assigning them to a zone (e.g., based on their function) may allow a user to configure or control the devices within a load control system more efficiently. For example, as the number of device in the load control system increases, the settings that may be configured by the user may also increase. And without grouping or organizing the device into a more manageable subset of devices, the user may fail to accurately and efficiently control the increased number of devices in the load control system. Moreover, the capabilities and, as a result, the configurable settings of each of the devices may differ, further increasing the complexity of configuring or controlling the load control system. If, however, the devices are grouped by their respective location and then assigned to a zone (e.g., based on their respective function), the user may configure the devices in the load control system by zone, which may improve the accuracy and efficiency of configuring and controlling the load control system.

After the devices in a load control system are organized and grouped by location and subsequently assigned to a zone, a user may collectively configure or control the devices that are assigned to a given zone. Further, since the devices that are assigned to a given zone based on their respective function, the settings for devices in that zone (e.g., lighting intensity and/or color) may be configured to be the same, which may improve the accuracy and efficiency of configuring and controlling the load control system.

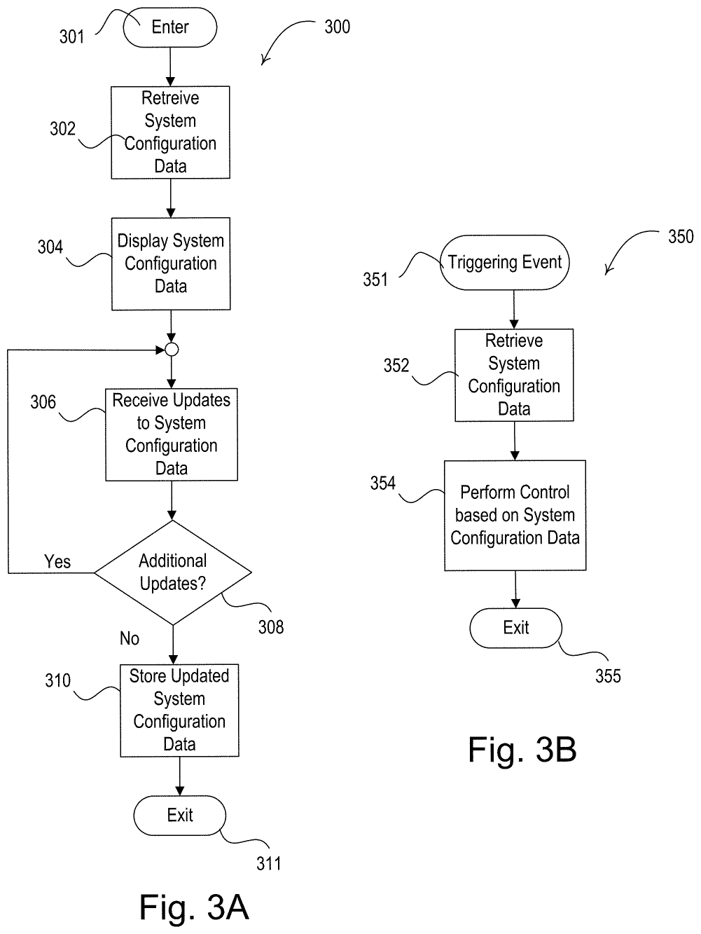

FIGS. 3A and 3B are flowcharts that illustrate example procedures for configuring or controlling a load control system. Referring first to FIG. 3A, there is shown an example procedure 300 for displaying and updating system configuration data for a load control system. The procedure 300 may be performed by a control/configuration application, such as the control/configuration application 203, and may enter at 301. For example, the procedure 300 may enter in response to an indication from a user to update the system configuration data (e.g., configuration and current state/status information) for a load control system (e.g., via a network devices, such as the network devices 144, 280). The procedure 300 may be performed after the devices in a load control system have been grouped or organized by their respective location in a user environment and subsequently assigned to zones. Also, or alternatively, the procedure 300 may be performed prior to the devices in a load control system being grouped or organized by their respective location in a user environment and/or assigned to a zone, which may be stored and/or maintained in the system configuration data.

At 302, the control/configuration application may retrieve the system configuration data for the load control system. For example, the system configuration data may indicate or otherwise describe the devices that are configured in the load control system. The system configuration data may include a unique identifier of the locations or areas of the user environment/load control system that the devices are organized or grouped by. The system configuration data may also include a unique identifier of the zones within each of the locations or areas that the devices are assigned to, and/or one or more defined scenes for controlling the devices assigned to the zones. The system configuration data may be retrieved from a single device (e.g., a system controller, such as the system controller 150), or portions of the system configuration data may be retrieved from multiple devices (e.g., a system controller, network device, one or more control source devices, and/or one or more control target devices). The system configuration data may also be obtained from devices external to the load control system, such as from cloud based system or other load control systems to which a given load control system is integrated with.

After retrieving the system configuration data, the control/configuration application may display a representation of the system configuration data (e.g., or a portion of the system configuration data) at 304. For example, the control/configuration application may display a representation of a defined scene for controlling one or more zones in an area of user environment or load control system via a graphical user interface. In addition, one or more lighting control device configured to control a corresponding lighting load may be assigned to each of the one or more zones. The graphical user interface may display various controls or control interfaces based on the lighting control device/lighting loads assigned to a given zone. For example, the graphical user interface may display a lighting intensity (e.g., via lighting intensity bar) for each of the one or more zones in the defined scene and/or a palette that identifies a color setting for controlling each of the one or more zones in the scene. The palette may be configured to display colors at different color temperatures at which the lighting control devices/lighting loads are capable of being controlled to, or a full color gamut of colors at which the lighting control devices/lighting load are capable of being controlled to.

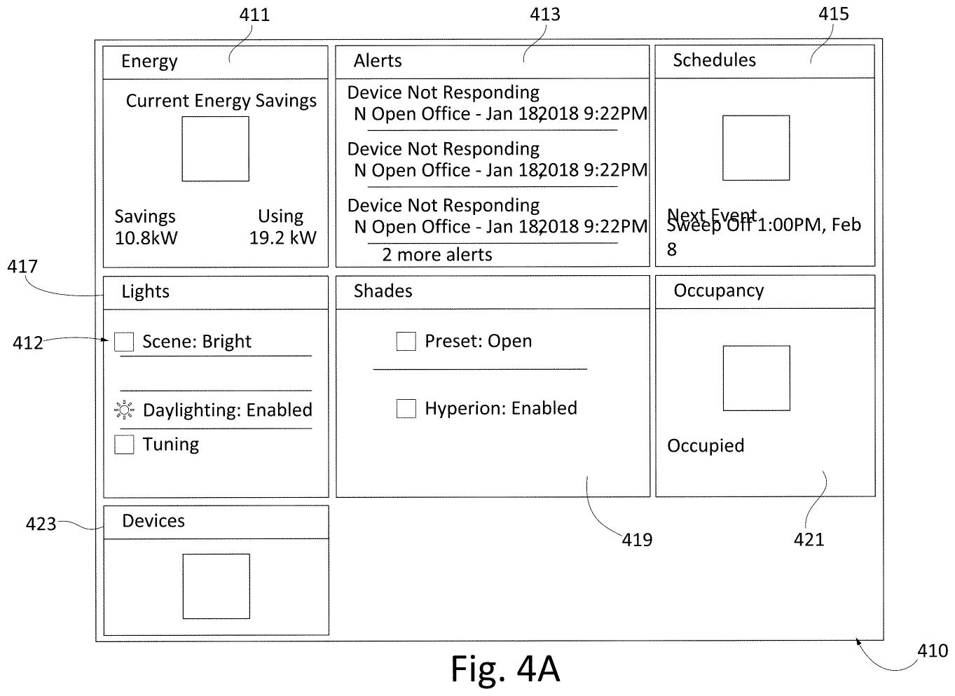

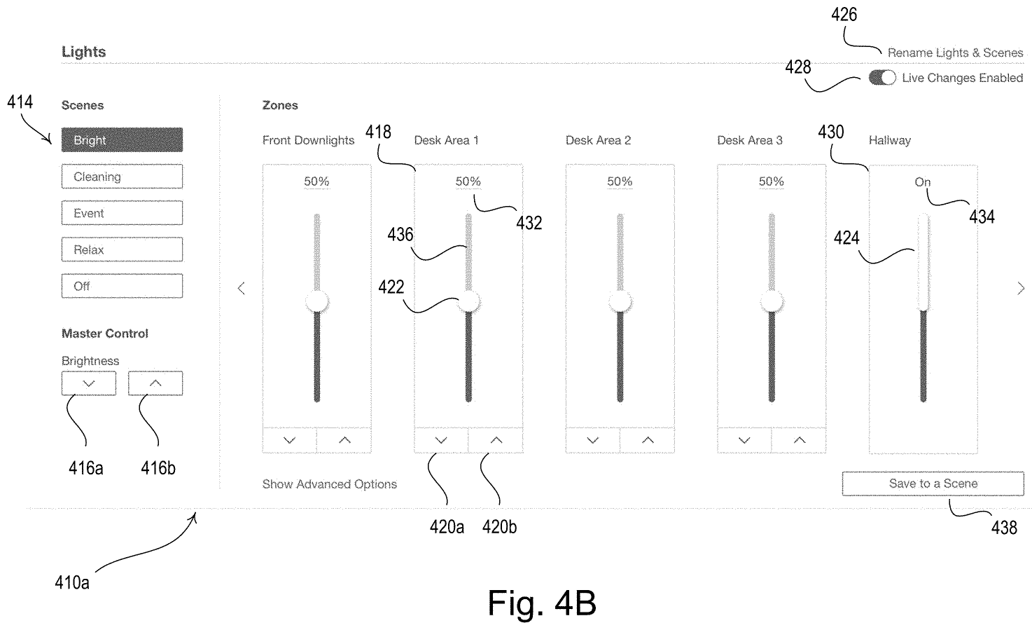

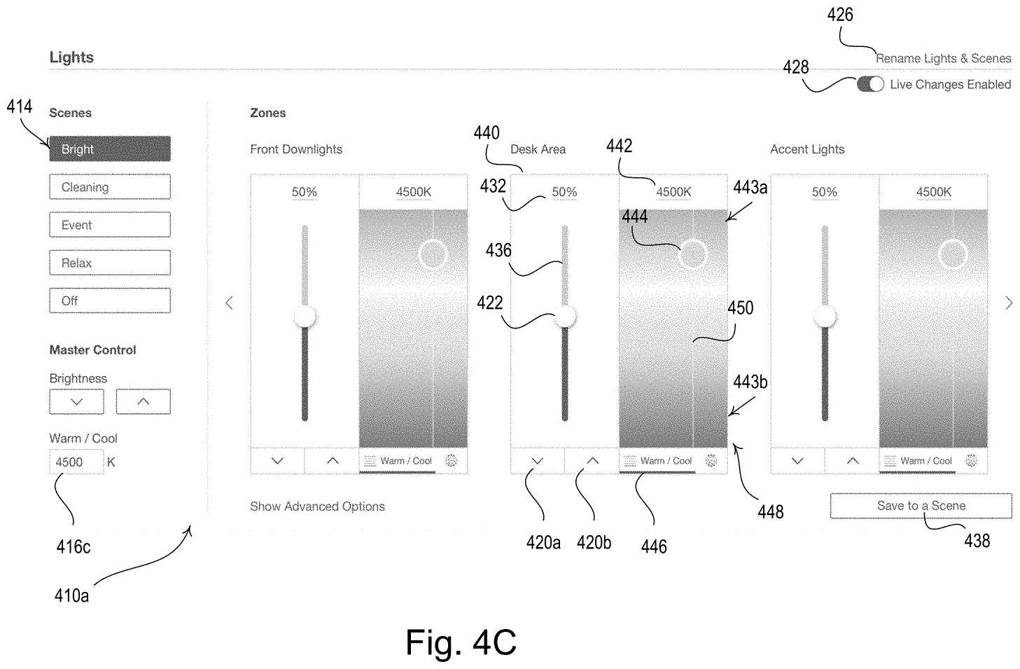

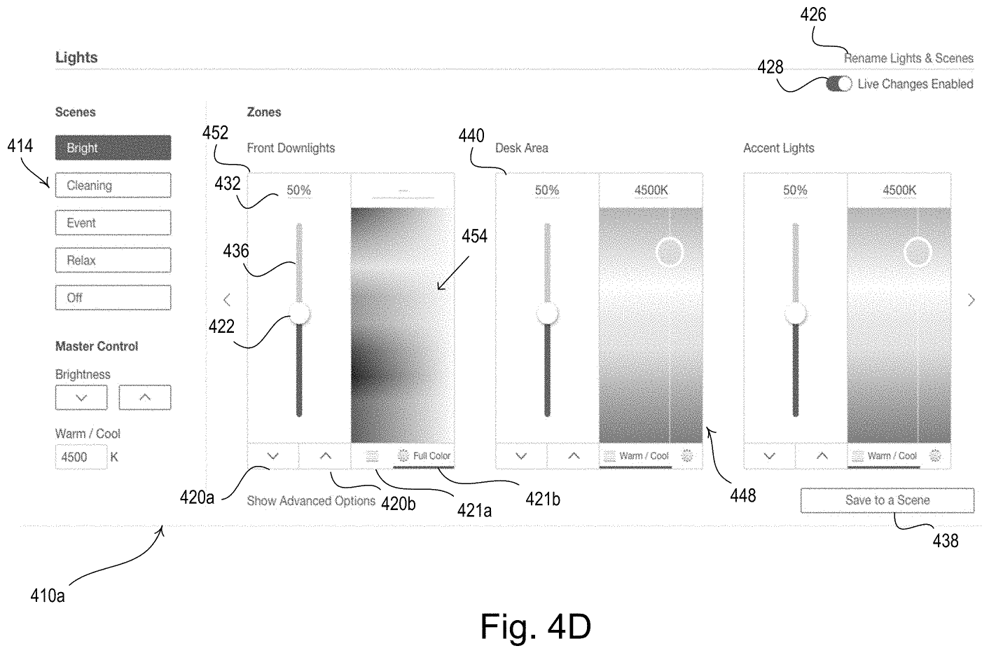

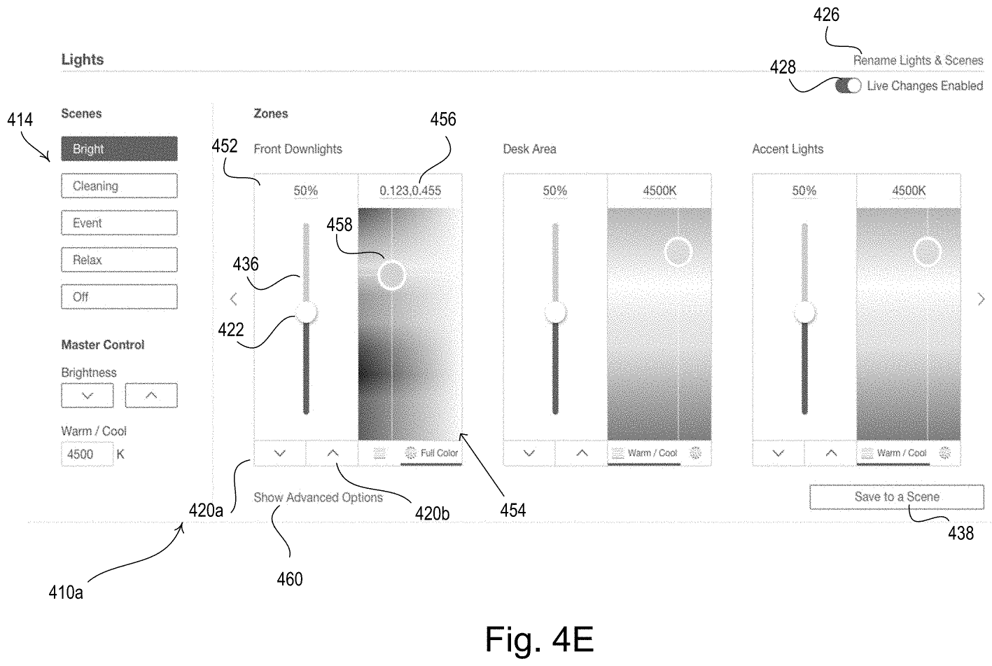

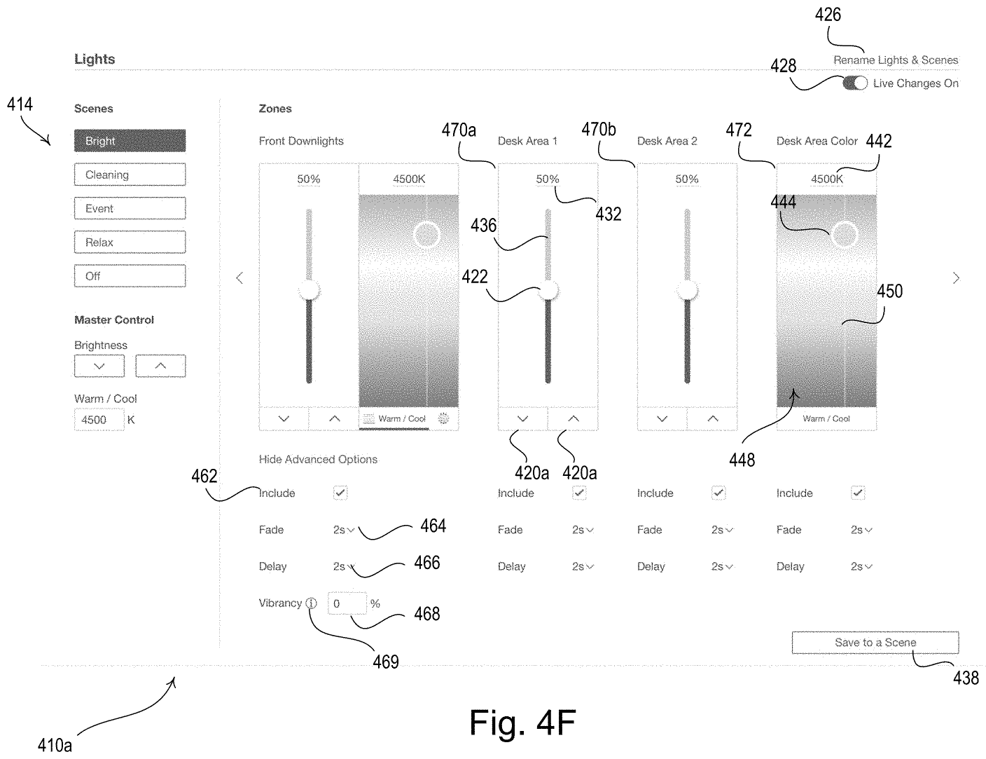

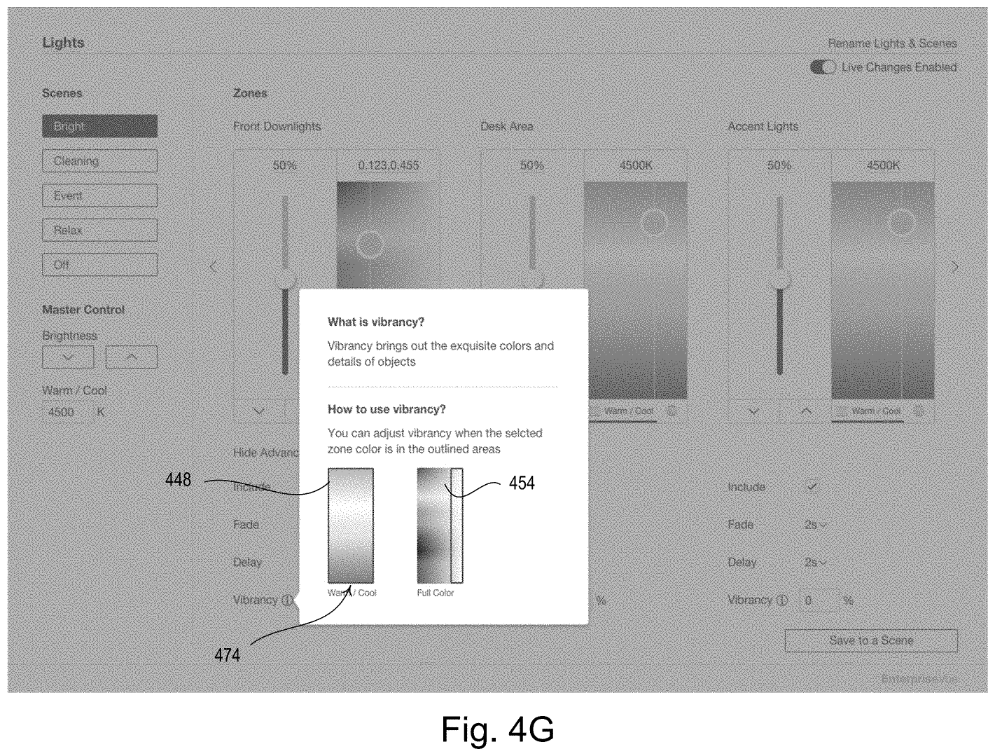

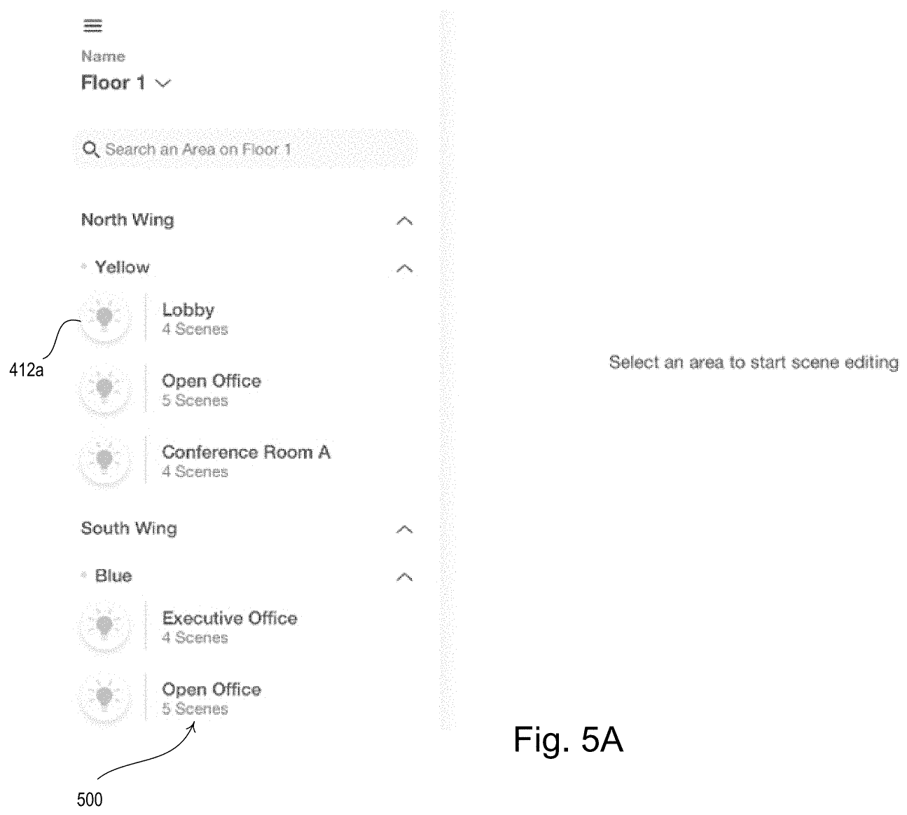

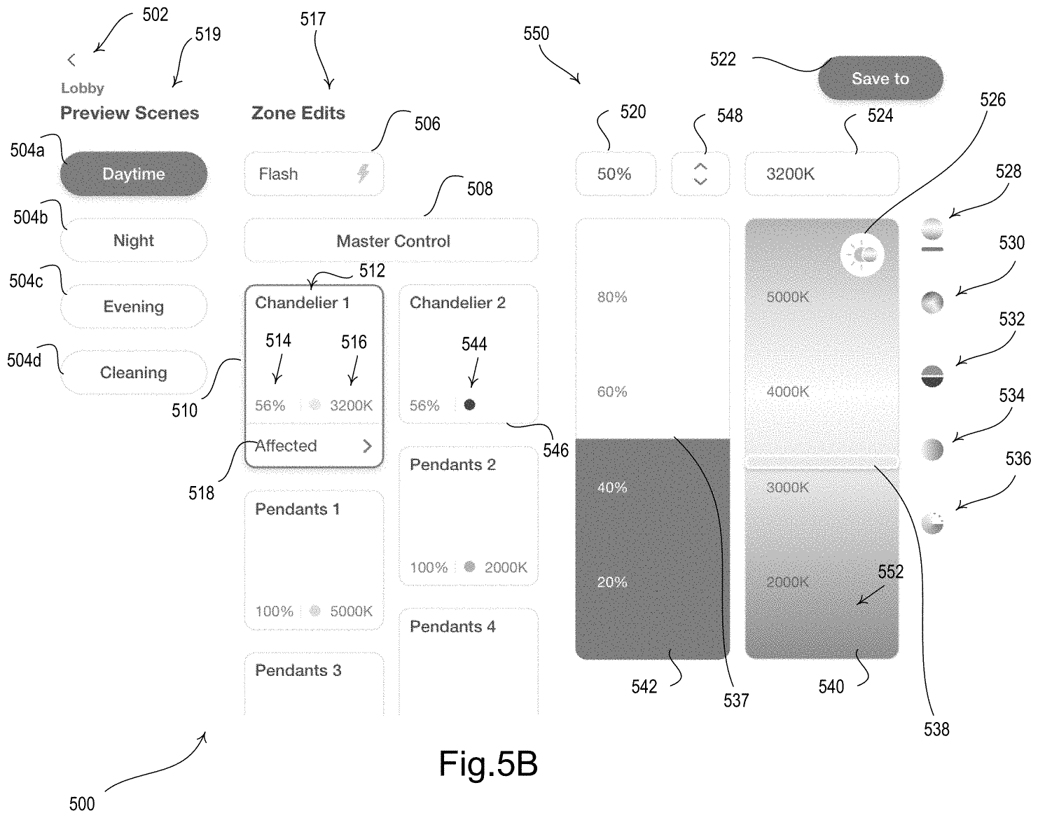

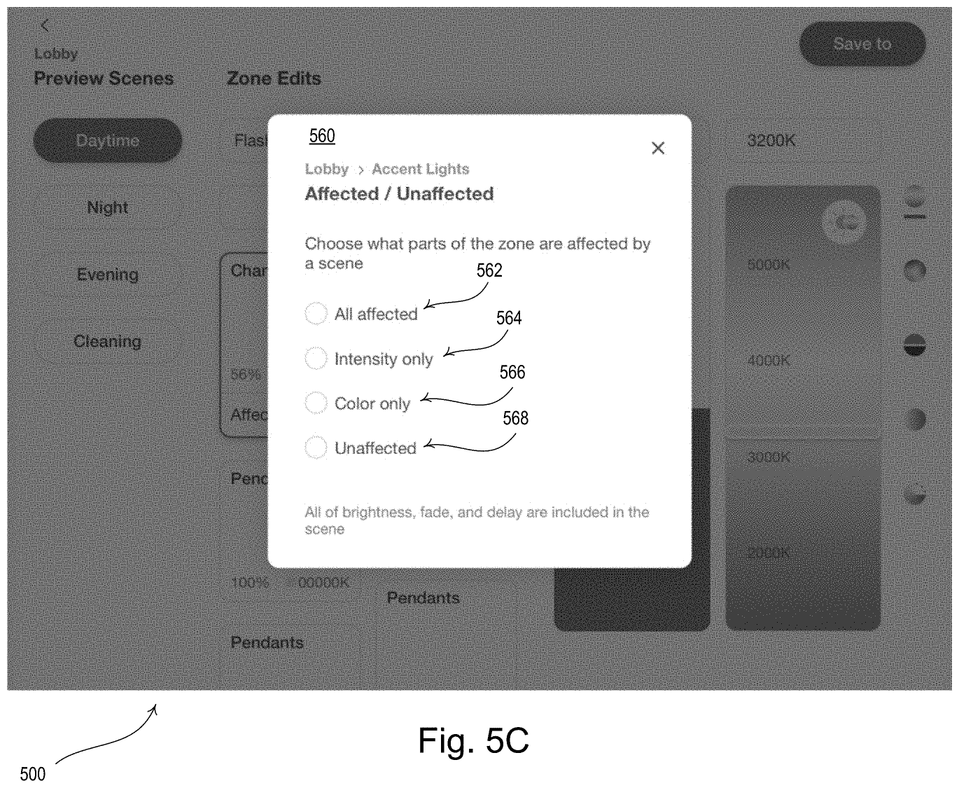

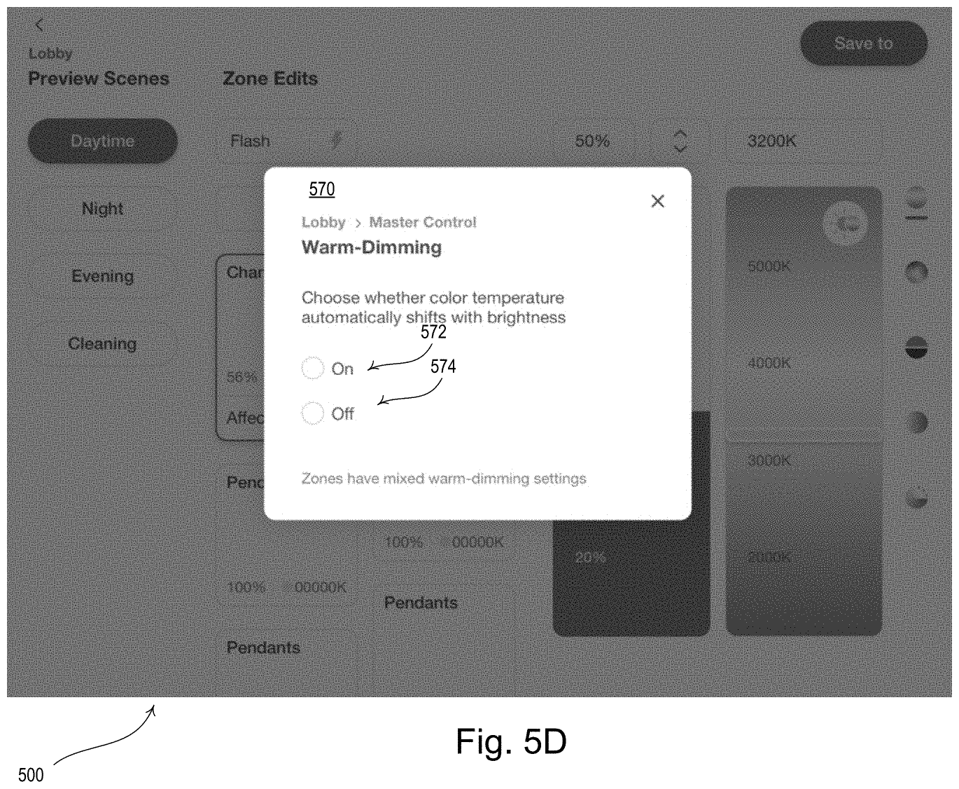

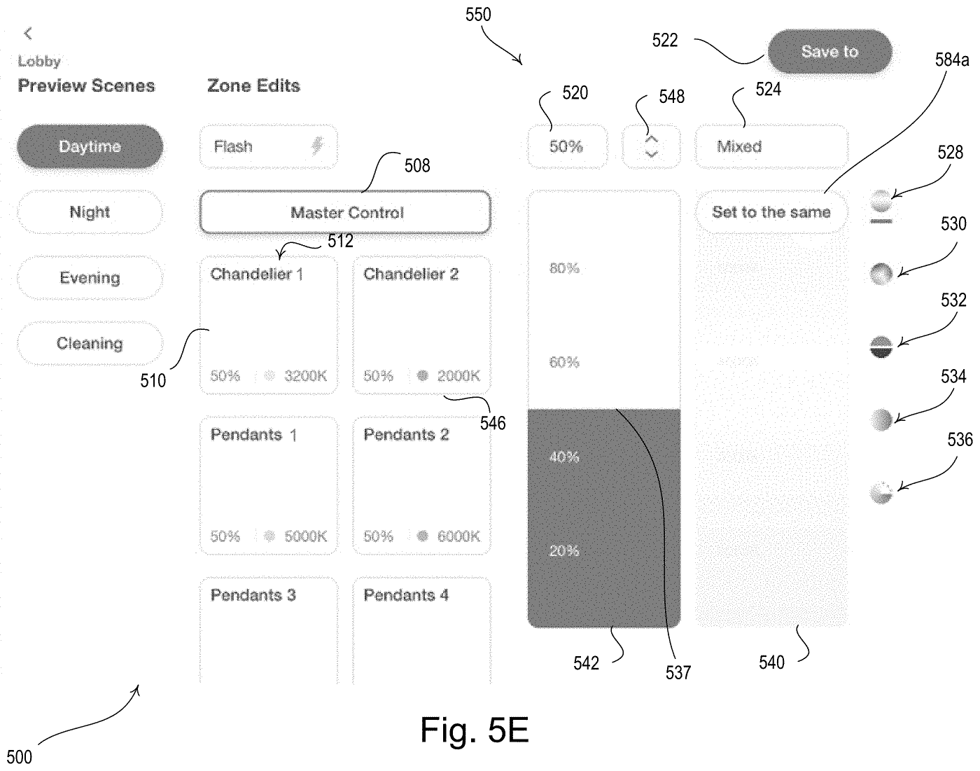

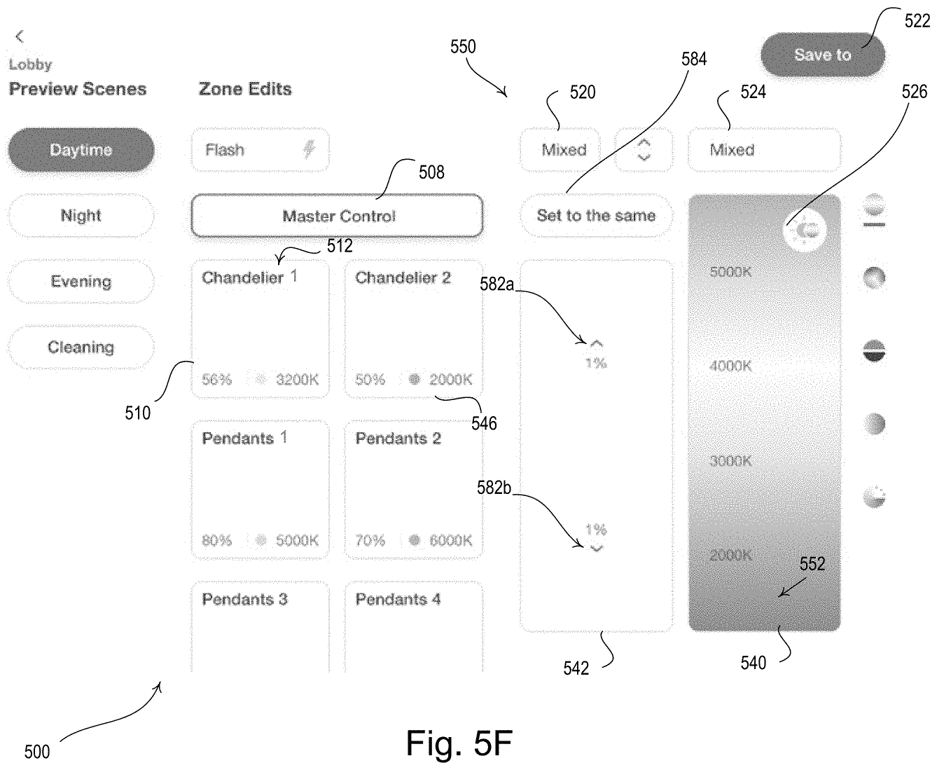

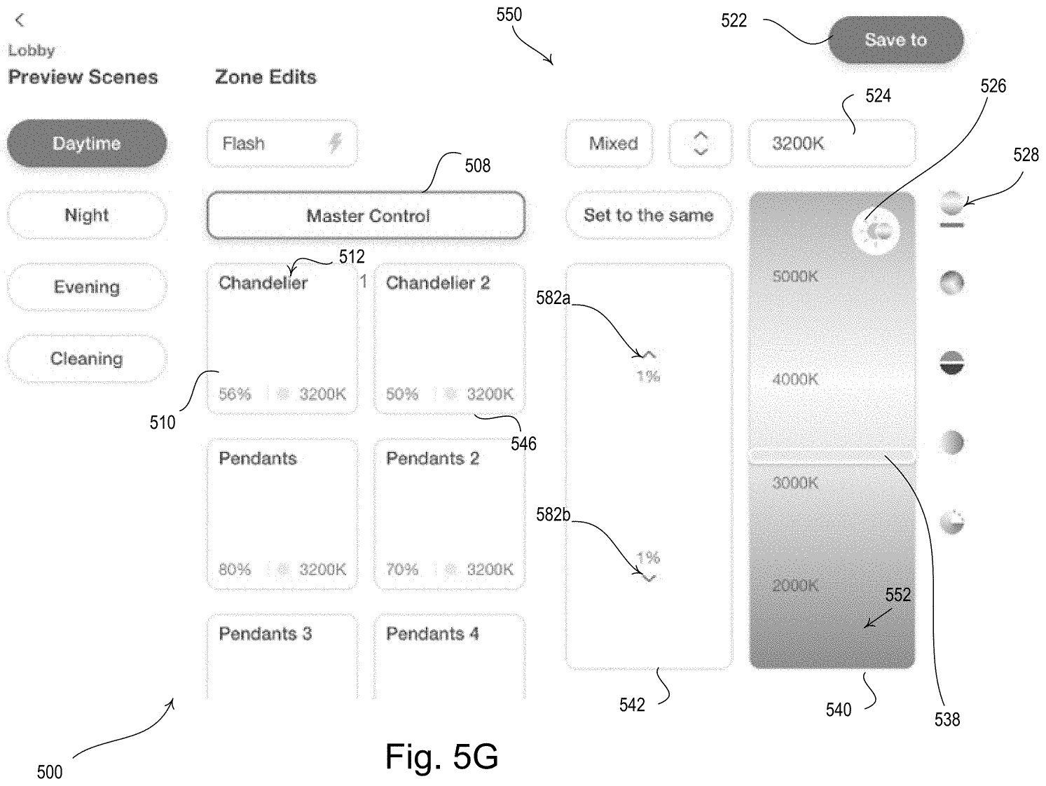

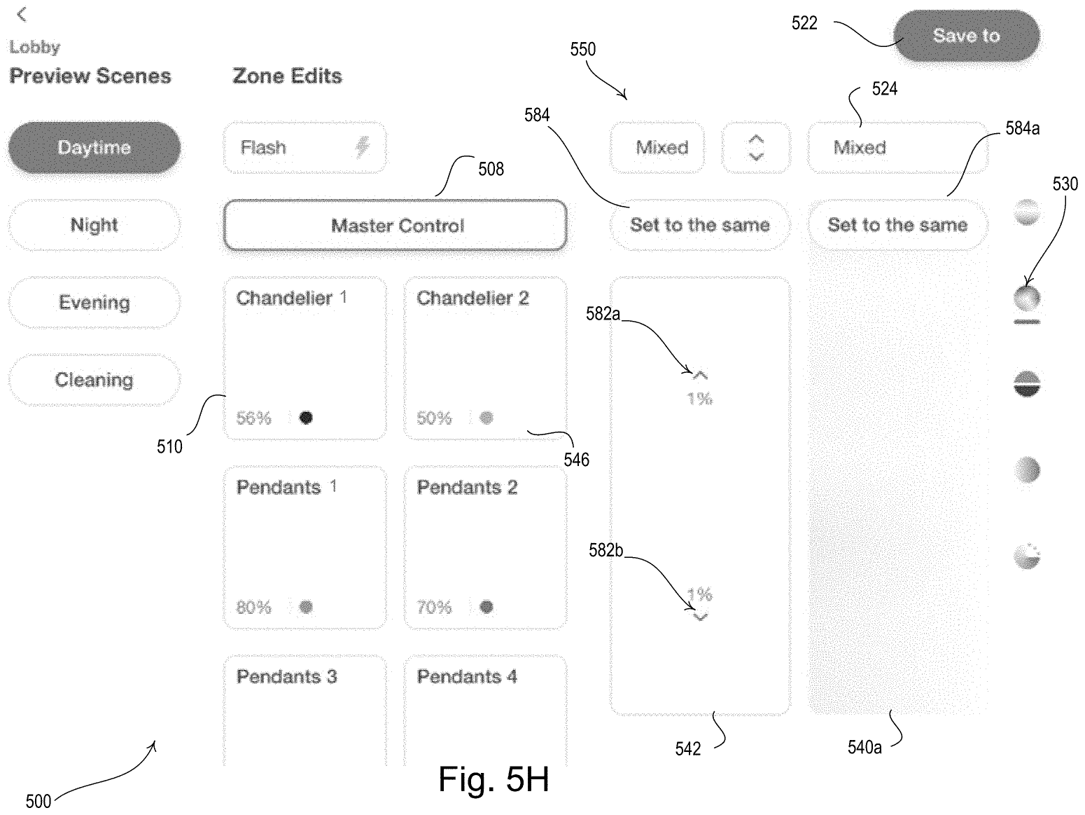

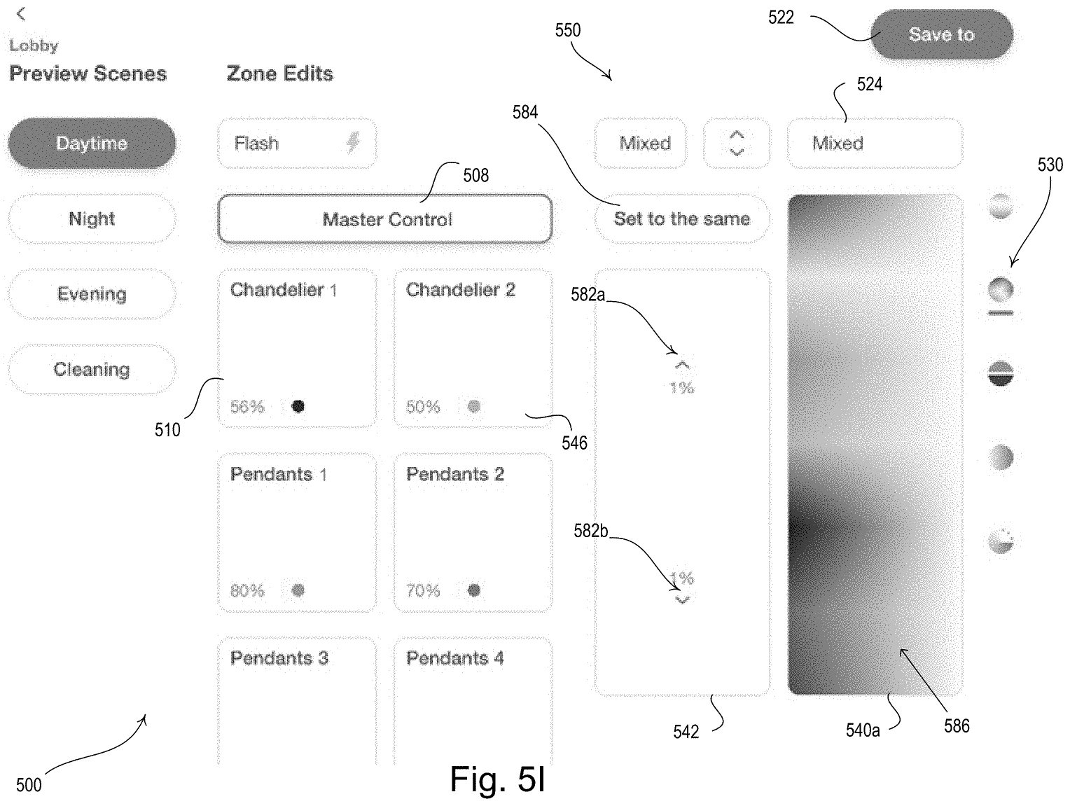

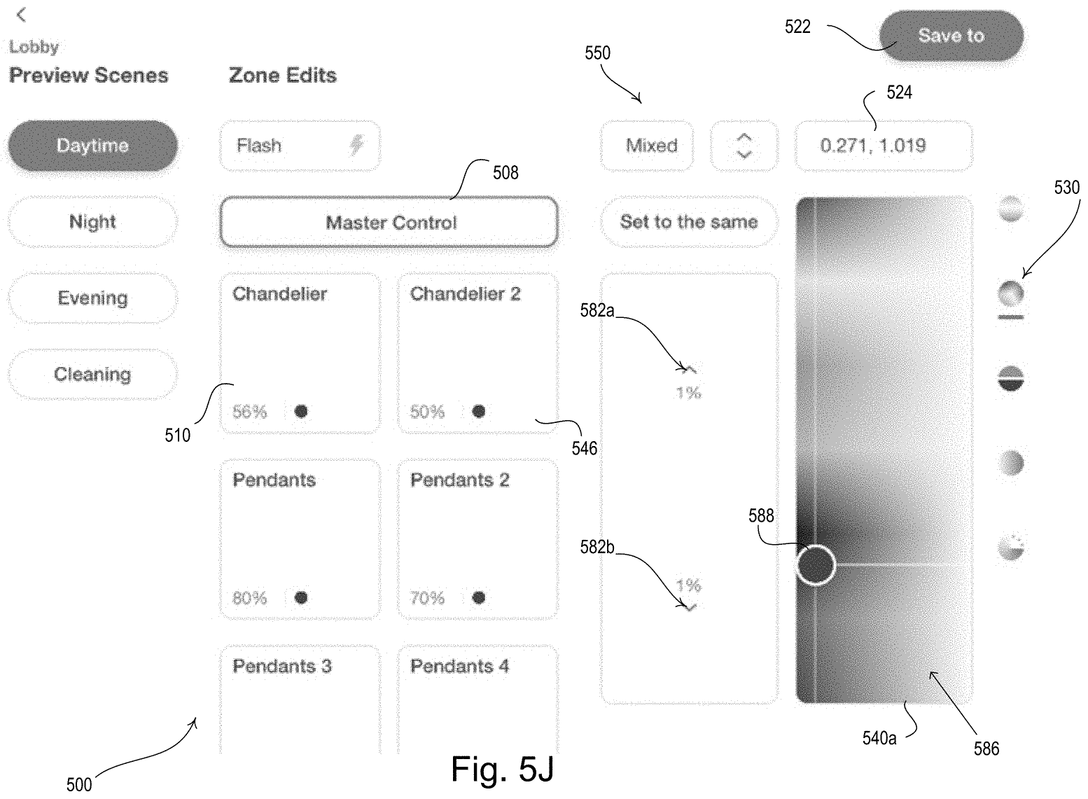

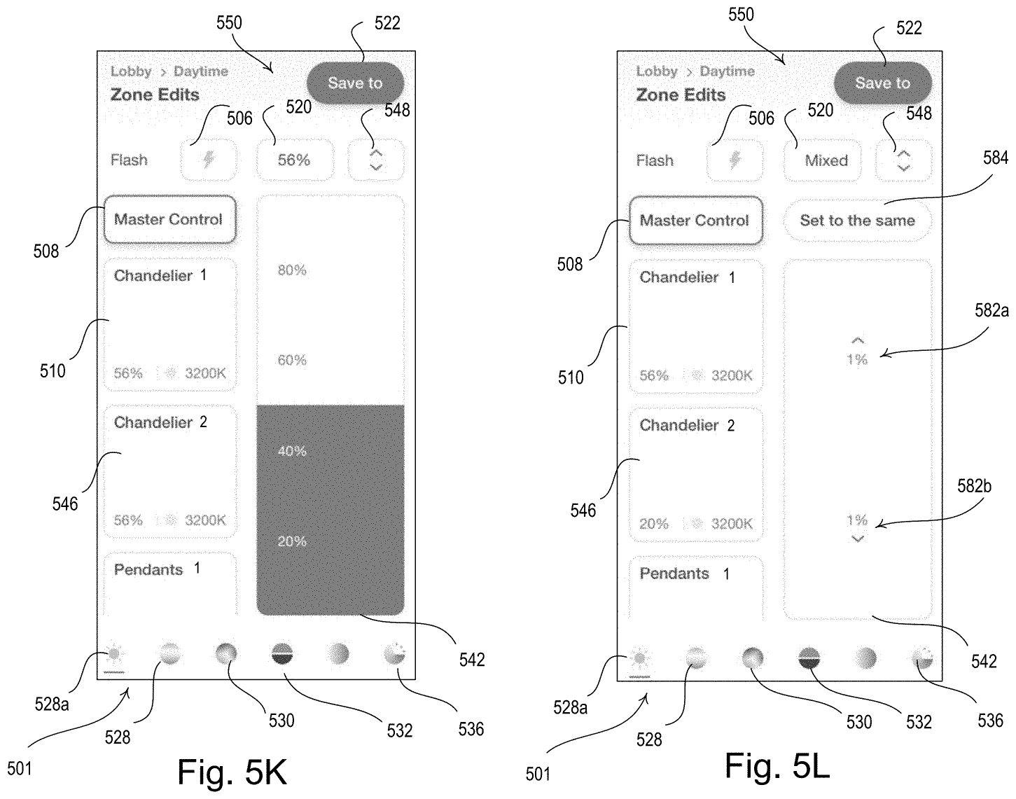

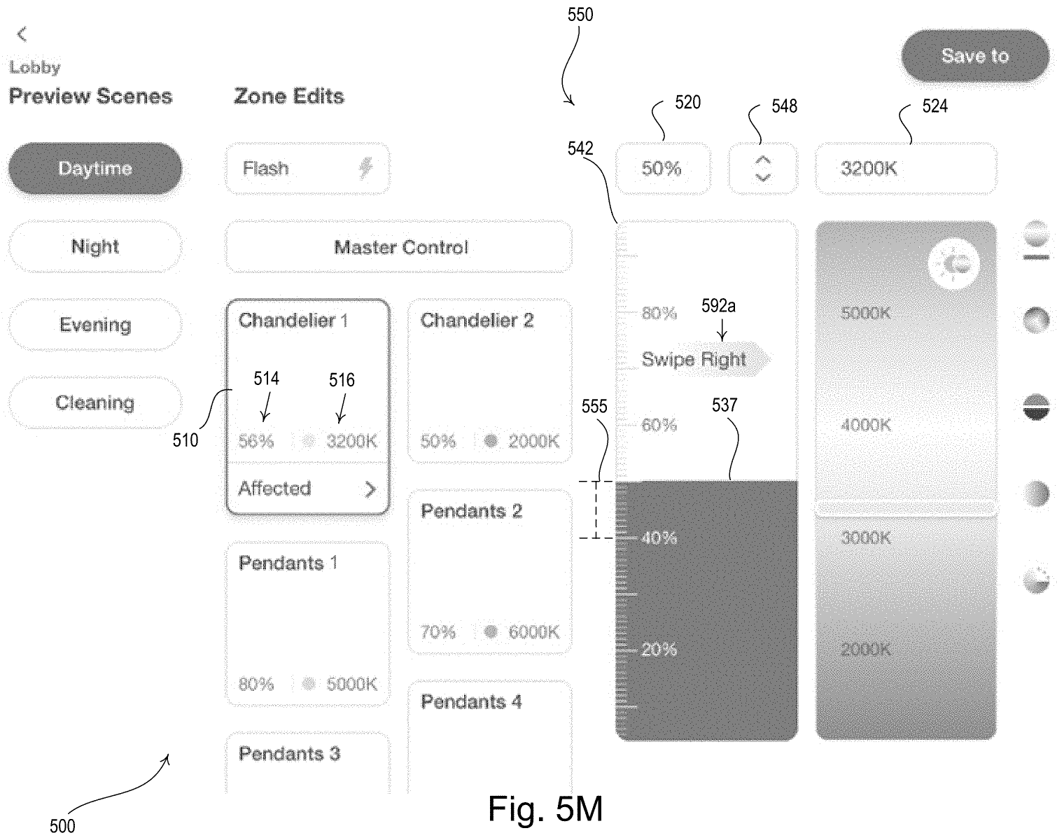

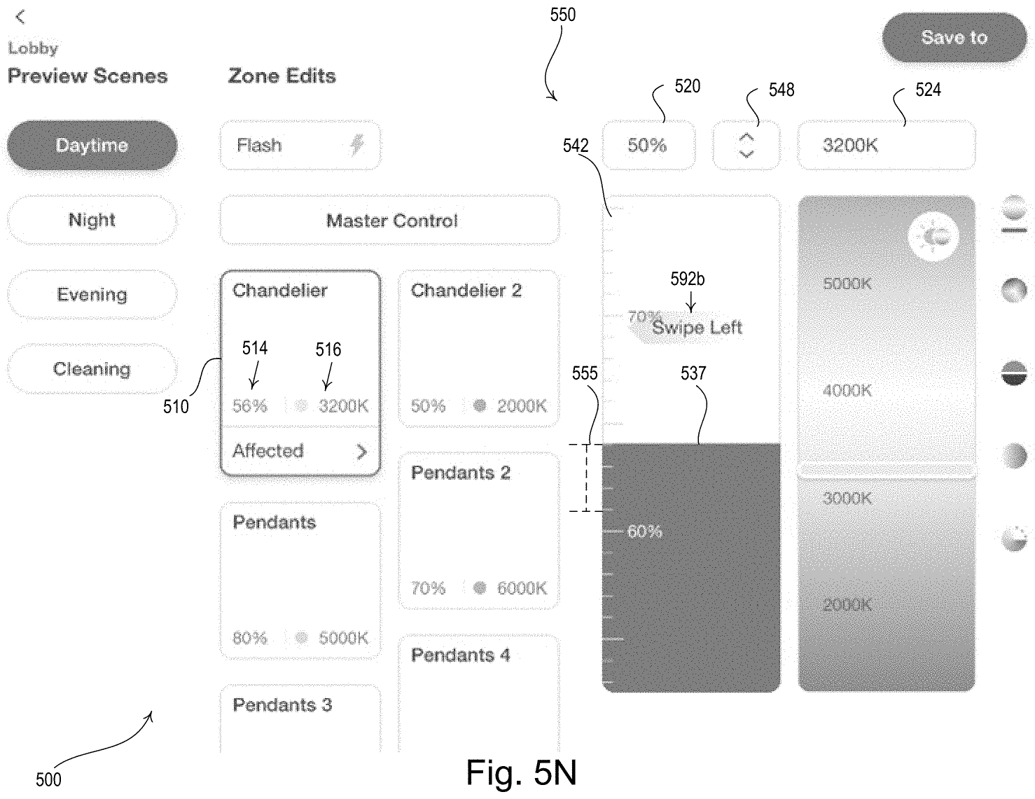

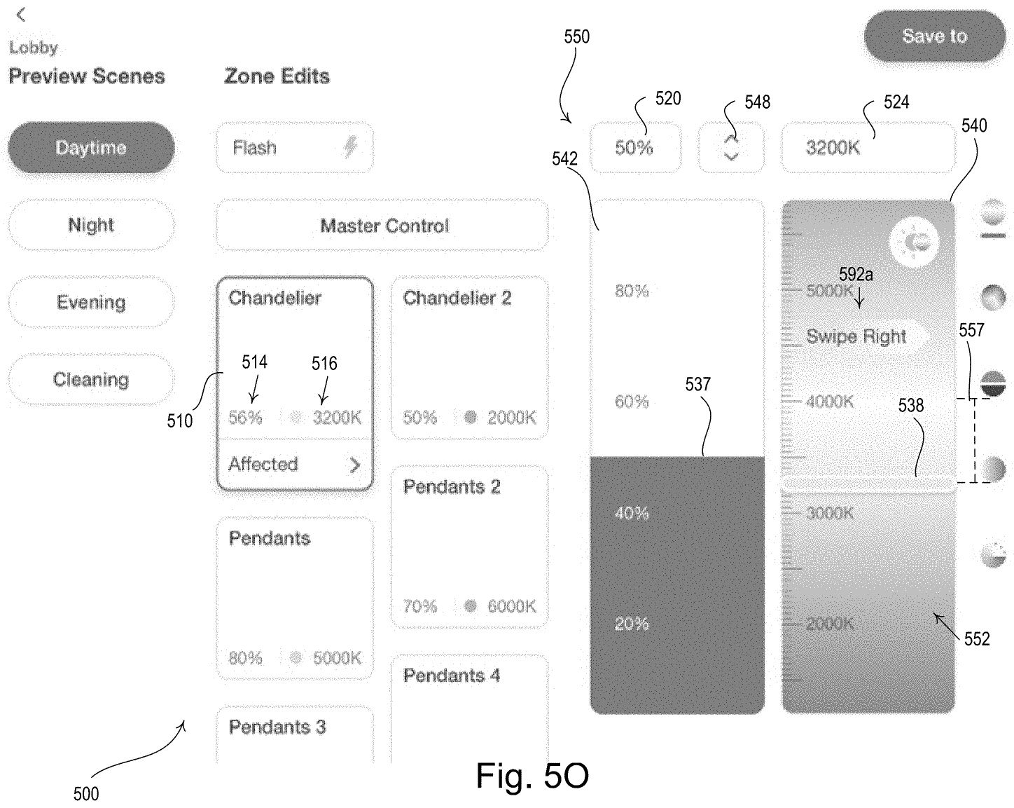

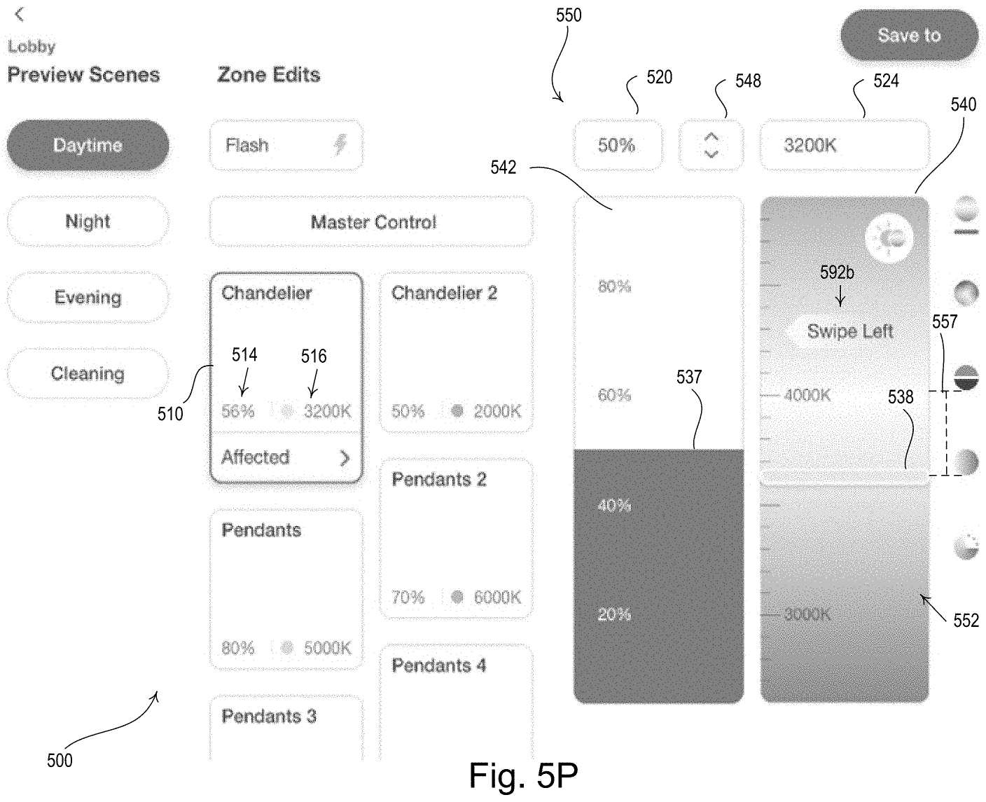

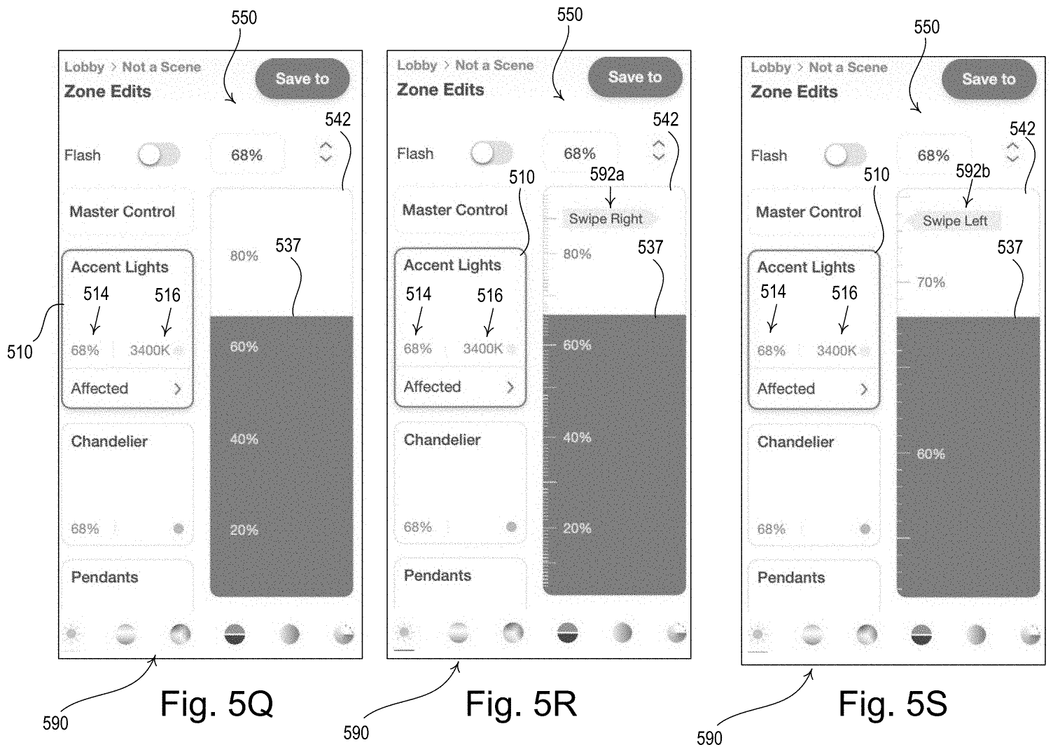

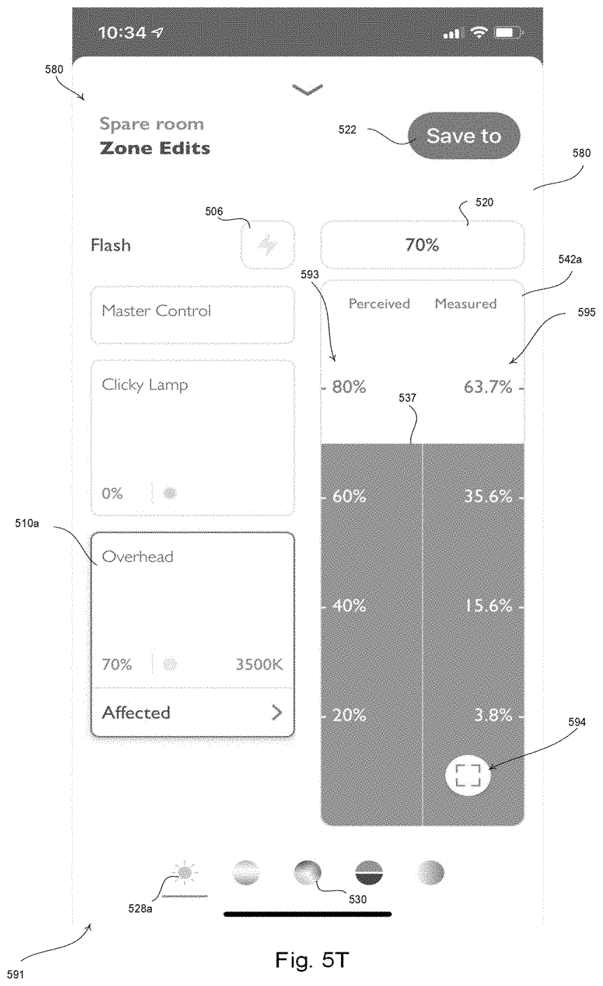

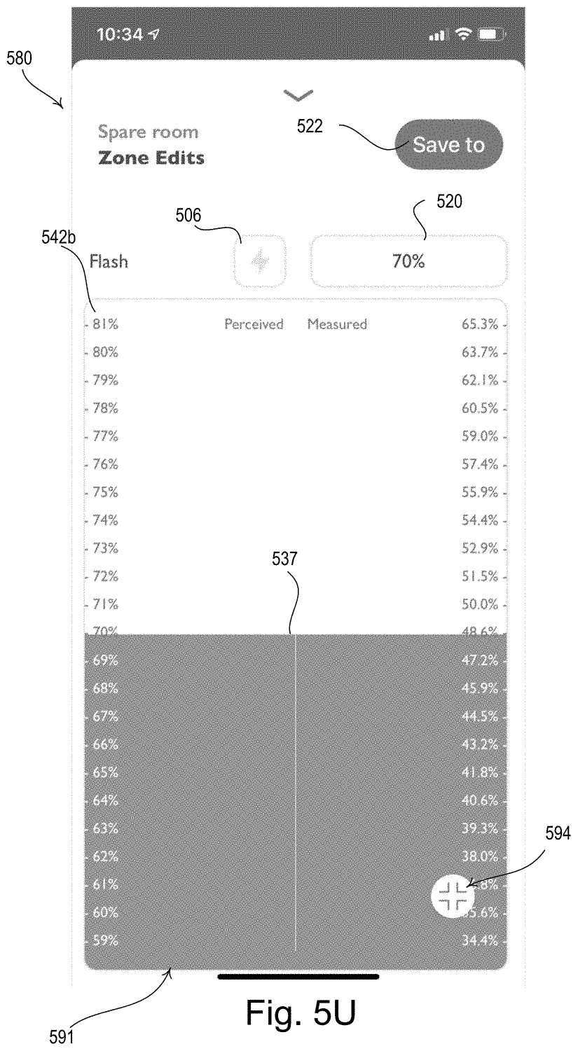

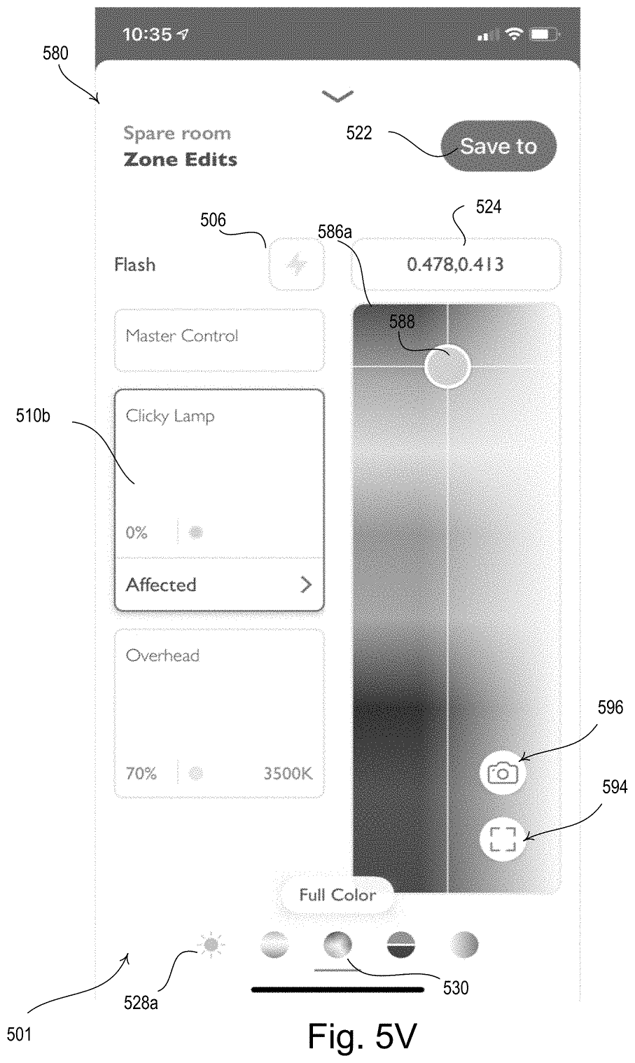

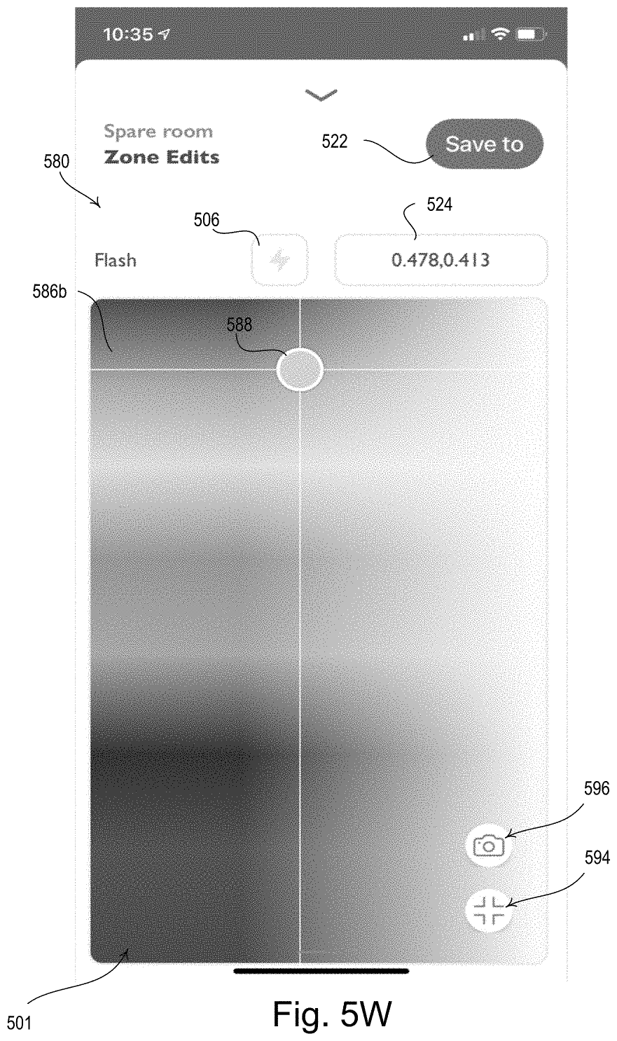

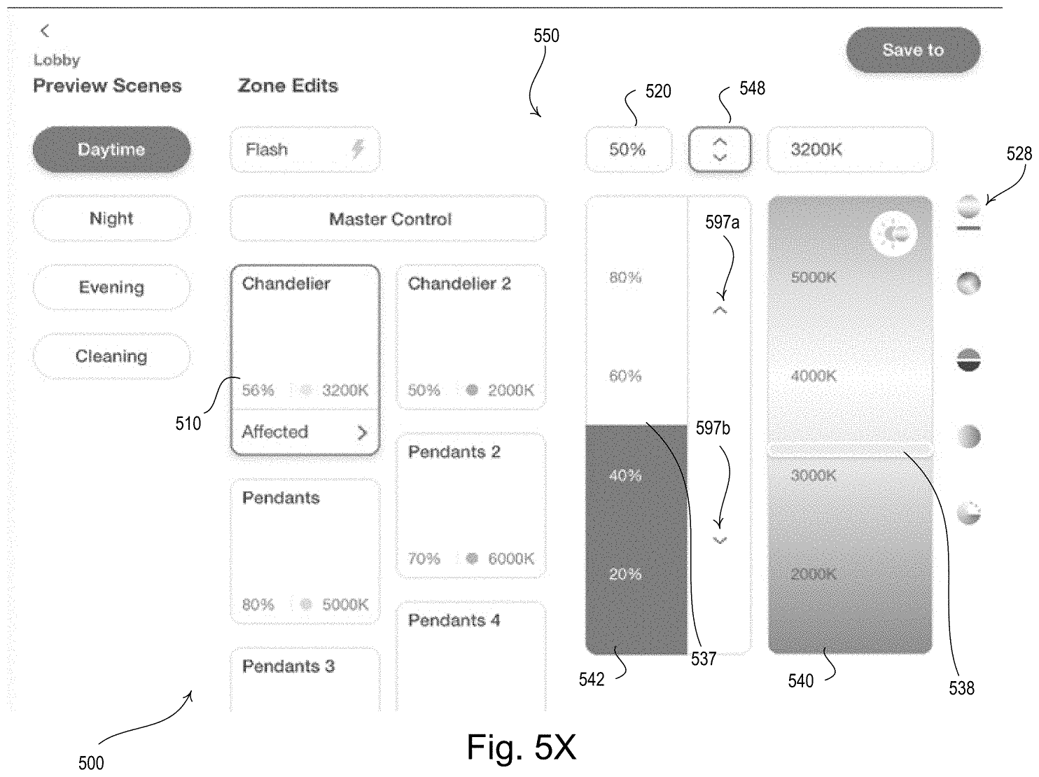

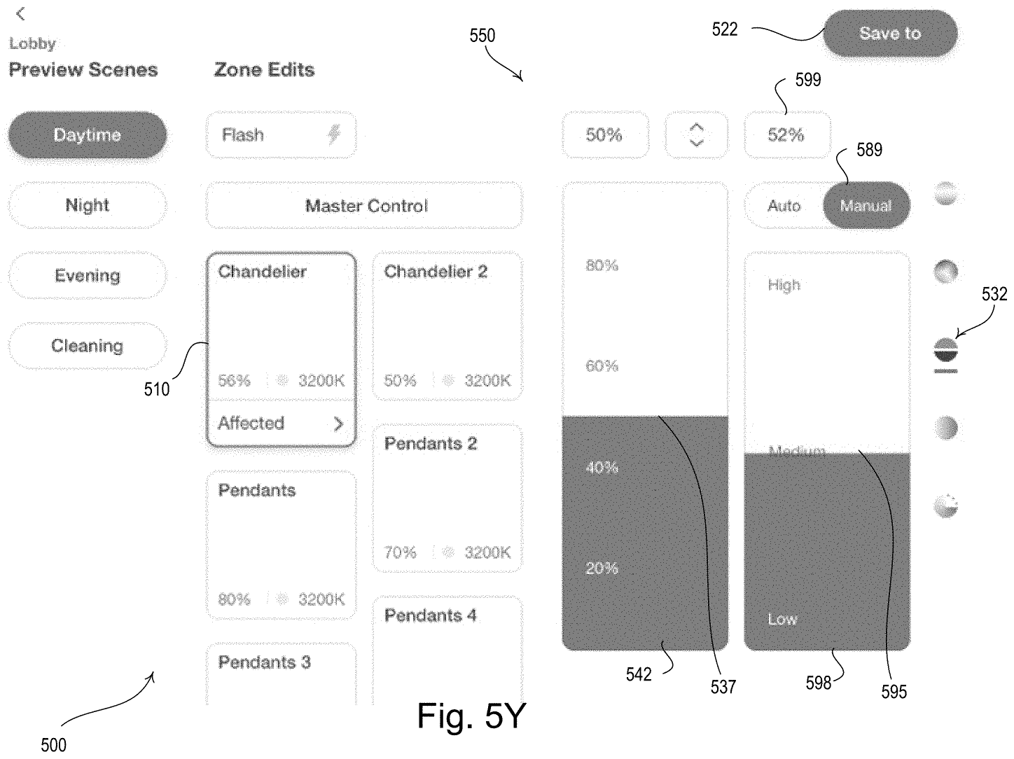

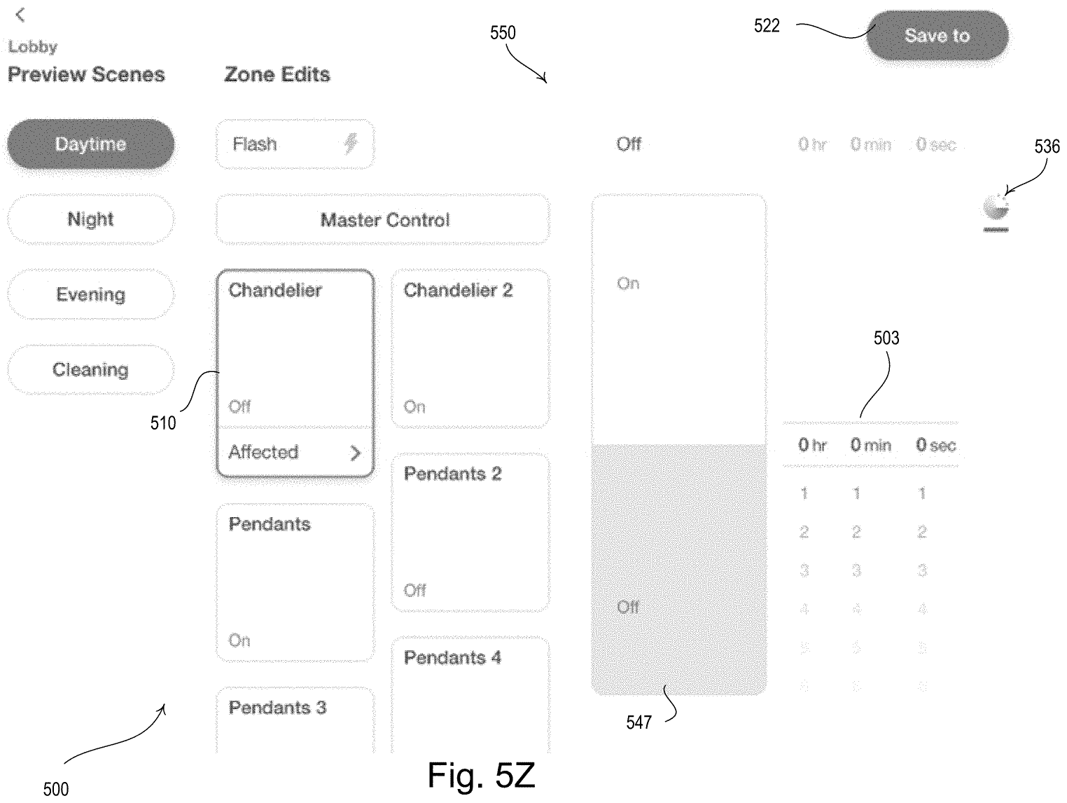

At 306, the control/configuration application may receive updates or changes to the system configuration data, for example, from a user. As described herein, changes to the system configuration data may include changes or updates to the settings (e.g., lighting intensity, color, CCT, vibrancy, etc.) for a defined scene. Accordingly, the control/configuration application may receive changes or updates to the system configuration data via the displayed lighting intensity and/or palette. FIGS. 4A to 4G and FIGS. 5A to 5Z illustrate example graphical user interfaces that may be displayed by the control/configuration application to represent the system configuration data and/or receive updates to the system configuration data.

At 308, control/configuration application may determine whether there are additional updates to the system configuration data. If the control/configuration application determines that there are additional updates, the control/configuration application may receive the additional updates. If, however, the control/configuration application determines that there are no additional updates, the control/configuration may store or send (e.g., store the updated configuration data locally or send the configuration data to another device, such as a system controller) the updated system configuration data at 310 and the procedure 300 may exit at 311. For example, the control/configuration application may determine that there are no additional updates when the control/configuration application receives an indication from a user that there are not additional updates to the system configuration data (e.g., selecting a “Save” or “Finished” button, such as the “Save to Scene” button 438 described herein with respect to FIG. 4B).

Referring now to FIG. 3B, there is shown an example procedure 350 for controlling a load control system based on a system configuration data, which, as described herein, may be defined or updated using the procedure 300. The procedure 350 may be performed by a single device. For example, the procedure 350 may be performed by a system controller, a lighting control device, a network device, or another control device to perform control using the system configuration data stored thereon. Also, or alternatively, the procedure 350 may be performed by multiple devices (e.g., a portion of the procedure 350 may be performed by a first load control device and another portion of the procedure 350 may be performed by a second load control device). For example, the system controller may retrieve the system configuration data (e.g., either locally or from another device) and perform control based on the system configuration data (e.g., by transmitting one or more message that include control instructions to perform control based to one or more lighting control devices based on the system configuration data).

As illustrated in FIG. 3B, the procedure 350 may be performed in response to the detection of a triggering event at 351. A triggering event may be an event that causes the devices in a load control system to be controlled according to the system configuration data. For example, as described herein, a triggering event may be caused by a user actuation for activating a scene (e.g. by pressing a button that corresponds to a scene at a remote control device); a scheduled event (e.g., based on a time clock); and/or a sensor event (e.g., an occupancy sensor detecting occupancy). Accordingly, the system configuration data may be retrieved at 352. As described herein, the system configuration data may be stored at a system controller and/or across one or more other devices (e.g., remote-devices, network devices, lighting control devices, other control devices, etc.). Therefore, the system configuration data may be retrieved from a system controller and/or from one or other devices in the load control system. After retrieving the system configuration data, control may be performed based on the system configuration data at 354. For example, control may be performed by transmitting one or more messages that include control instructions to the load control device(s) based on the system configuration data. In another example, the control instructions may be stored locally thereon for performing control of the electrical load via the load control device. The procedure 350 may exit at 355.

Turning now to FIGS. 4A-5Z they illustrate example graphical user interfaces of control/configuration applications that may be executed at least in part on a network device, such as the control/configuration application 203 of the network device 280, for configuring or controlling a load control system. For example, FIGS. 4A-4G and FIGS. 5A-5Z may illustrate graphical user interfaces that may be displayed by the control/configuration application to display and/or update the system configuration data for a load control system. Again, the network device may be similar to the network devices 144, 280 as described herein and may be a personal computer (PC), a laptop, a tablet, a smart phone, or equivalent device, for example, although it may also be another type of computing device. The control/configuration application may be a graphical user interface (GUI) based application that may provide a GUI based interface/GUI based “window(s)” to a user via the network device and may allow a user of the network device to interact with, control, and/or configure control devices within a user environment (e.g., user environment 102) or load control system (e.g. the load control system 100). For description purposes only, the load control system 100 of user environment 102 and the communication systems described with respect to FIG. 1 will be used herein as an example load control system and communication system to describe the control/configuration application. Nonetheless, the features and functions of the control/configuration application described herein are applicable to other types of control devices, load control systems, and communication systems. As an example, the user environment 102 may be a residence or home and the user of the network device may be a resident of the home. Nonetheless, the example control/configuration application may also be applicable to other types of user environments, such as a building, hotel, etc. and the user of the network device may be a system administrator.

FIGS. 4A to 4G and FIGS. 5A to 5Z show example graphical user interfaces that may be displayed by a control/configuration application. The graphical user interfaces may provide for the control of one or more lighting control devices, for example, by defining one or more scenes. In addition, the lighting loads may be located at a residential home or commercial space. Accordingly, the graphical user interfaces of FIGS. 4A to 4F may be used to control or configure the control devices in a space. Referring now to FIG. 4A, there is shown a graphical user interface 410 that may be displayed by the control/configuration application. The graphical user interface 410 may be displayed to a user via the network device 280, for example. The graphical user interface 410 may be similar to the other graphical user interfaces described herein (e.g., the graphical user interface 500 etc.). Although FIG. 4A illustrates one type of example graphical user interface that may be displayed to provide configuration or control, other types of graphical user interfaces may also be used to control or configure the control devices in a space.

The graphical user interface 410 may include a number of tiles 411, 413, 415, 417, 419, 421, 423. Each of tiles 411, 413, 415, 417, 419, 421, 423 may convey information to the user and/or allow for user-selection for providing additional information and/or configuration. Each of the tiles 411, 413, 415, 417, 419, 421, 423 may provide information about devices in a preselected area within a floor of a building. An energy tile 411 may indicate an amount of energy usage and/or savings. An alerts tile 413 may provide alerts about devices in the system. A schedules tile 415 may provide information about scheduled events to the user and/or allow a user to schedule events in the system. For example, after selection of the schedules tile 415, the user may configure lighting schedules for controlling lighting control devices in the system. A lights tile 417 may provide information about current lighting configurations in the system and/or allow a user to configure control of lighting control devices and/or lighting loads within the system. A shades tile 419 may provide information about current shade configurations in the system and/or allow a user to configure control of shades within the system. An occupancy tile 421 may provide information about current occupancy conditions in the system and/or allow a user to configure control of devices within the system in response to occupancy and/or vacancy events/conditions. A devices tile 423 may allow a user to manage and perform maintenance of devices.

A scene indicator 412 may be displayed in the lights tile 417. The scene indicator 412 may be an indication of the scene set for one or more lighting control devices of the preselected area (e.g., the “Bright” scene as shown in FIG. 4A). The scene indicator 412 may be selectable or configurable, and/or may allow the user to select or define the scene for one or more lighting control devices (e.g., the one or more lighting control devices in the preselected area). After selecting the scene indictor 412, the control application may display a graphical user interface that provides a user with the ability to configure the settings (e.g., static settings) for a scene. As an example, after selecting the scene indicator 412, the control/configuration application may display the graphical user interface 410a to configure the static settings for a scene, as described herein with respect to FIGS. 4B to 4G. As another example, the control/configuration application may also, or alternatively, display the graphical user interface 500 to configure the static settings for a scene, as described herein with respect to FIGS. 5A to 5Z.

Turning now for FIG. 4B, there is shown an example of the graphical user interface 410a that may be displayed by the control/configuration application to control the lighting intensity defined for scenes (e.g., after selection of the scene indicator 412). The graphical user interface 410a may be provided for configuring scenes in response to the scene indicator 412 (shown in FIG. 4A), for example. The graphical user interface 410a may include scene icons 414. The scene icons 414 may indicate the scenes that are defined for the particular area of the load control system. For example, referring to FIG. 4B, the defined scenes may include: “Bright,” “Cleaning,” “Event,” “Relax,” and “Off.” As described herein, the scenes defined for the area of the load control system may be stored and/or maintained at the system controller. Further, when a scene is selected, the system controller may transmit one or more messages that include control instructions to control the loads as defined by the scene. In addition, the scenes defined for the area of the load control system may be selected via the graphical user interface 410a. The scenes (e.g., and their respective configurations) may be communicated to a system controller. In response, the scenes may be activated by the system controller. Each of the scenes may be separately configurable and/or programmable via the graphical user interface 410a. Further, the scene that is presently being configured/programmed and is active may be indicated by being highlighted. For example, referring to FIG. 4B, the “Bright” scene may be that scene that is presently being configured/activated.

After configuration, a scene may be activated via a graphical user interface, such as the graphical user interface 410a, or a control device, such as the remote-control device 122. For example, as described herein, the remote-control device 122 shown in FIG. 1 may include one or more buttons, each of which may correspond to a configured scene of FIG. 4B. The scene may then be activated by actuating (e.g., pressing) the button on a graphical user interface or control device (e.g., remote control device) that corresponds to that scene. Upon activation, the configurations defined for the scene may be retrieved. For example, the configurations may be stored and retrieved from the graphical user interface, the control device, and/or a system controller, such as the system controller 150. Also, or alternatively, the configurations for the scene, or portions thereof, may be stored at and/or retrieved from multiple devices. For example, part of the configuration for a scene may be stored and retrieved from the system controller, and another part of the configuration for the scene may be stored at and/or retrieved from the control device. After the configuration for the scene has been retrieved, one or more messages including control instructions may be transmitted to control one or more load control devices based on the configuration of the scene.

The lighting control devices configured for being controlled in a given scene may be organized into one or more zones. Referring to FIG. 4B, the “Bright” scene may include a “Front Downlight” zone, a “Desk Area” 1 zone, a “Desk Area 2” zone, a “Desk Area 3” zone, and a “Hallway” zone. Each of the zones may be separately controllable via a respective control interface. For example, the “Desk Area 1” zone may be controlled by the control interface 418 and the “Hallway” zone may be controlled by control interface 430.

The control interface of a respective zone may vary based on the load control device associated with the zone. For example, referring to FIG. 4B, the load control device associated with the “Desk Area 1” zone may be a dimmer. Accordingly, control interface 418 may include an indicator 432, control line 436, and/or actuators 422, 420a, 420b. The indicator 432 may indicate the configured lighting intensity for the “Desk Area 1” zone (e.g., 50% as shown in FIG. 4B). As described herein, the actuator 422 may be actuated along the control line 436 to control the lighting intensity of the “Desk Area 1” zone. Similarly, actuator 420a may be actuated to decrease the lighting intensity of the “Desk Area 1” zone and actuator 420b may be actuated to increase the lighting intensity of “Desk Area 1” zone. Though described herein as a control line 436, the control line 436 may be another type of control indicator or actuator configured to control and/or indicate the lighting intensity value.

The load control device associated with the “Hallway” zone may be an electrical switch. Accordingly, the graphical user interface 410a may include control interface 430 to control the lighting intensity of the “Hallway” zone. Control interface 430 may include an indictor 434 to indicate the state of the Hallway zone and an actuator 424 to control the state on the “Hallway” zone. For example, referring to FIG. 4B, the “Hallway” zone may be set to On or Off.

The lighting intensities of the respective zones in a scene may be uniformly controlled. Accordingly, the graphical user interface 410a may include master control actuators 416a, 416b. The master control actuators 416a, 416b may be used to uniformly increase and/or decrease the lighting intensities of each of the zones. Referring now to FIG. 4B, master control actuator 416a may be actuated to uniformly decrease the lighting intensity (e.g., or brightness) of each of the zones and master control actuator 416b may be actuated to uniformly increase the lighting intensity of each of the zones. In addition, the actuators 416a, 416b may respectively increase and decrease the lighting intensity of each of the zones by a relative amount to a current lighting intensity setting (e.g., respectively increase or decrease the lighting intensity of each of the zones by 1%).

Two or more zones may similarly be associated with one another for common color and/or intensity control. For example, the “Desk Area 1” zone and the “Front Downlights” zone may be associated with one another for common control. Each zone may be controlled by the master control actuators 416a, 416b, or through control of one of the zones. The graphical user interface 410a may include an indicator, such as a lock symbol or other indicator, to indicate each of the zones being collectively controlled.

The graphical user interface 410a may include a rename light and scenes button 426. The rename light and scenes button 426 may be actuated to adjust the name of the lights and/or scenes defined for the area of the load control system. The graphical user interface 410a may include a save scene button 438, which, when actuated may save the configuration of and/or changes to a respective scene.

The graphical user interface 410a may include a “Live Changes Enabled” actuator 428. When the Live Changes Enabled actuator 428 is enabled (e.g., as show in FIG. 4B), the lighting controls that are defined by the user via the graphical user interface 410a may be present at the respective lighting control devices in the load control system. For example, control instructions that indicate the defined lighting intensities may be transmitted to the respective lighting control devices, and the lighting control devices may transition to indicate the lighting intensities. In response, the user may be provided with live and real-time feedback of the defined lighting intensities. When the “Live Changes Enabled” actuator 428 is disabled, the lighting controls may be defined by the user via the graphical user interface 410a and may be saved for being implemented in the defined zones in the area when the defined scene is triggered (e.g., via occupancy event/condition, actuation of a button, a scheduling event, etc.).

A scene may define the intensity and/or correlated color temperature of a respective zone, assuming the lighting loads are configured to emit colored light. Turning now to FIG. 4C, the graphical user interface 410a may be displayed by the control/configuration application to control the warm or cool color temperatures defined by a zone. As shown in in FIG. 4C, when a respective scene further defines a color temperature, the scene indicators 414 may be highlighted with the color temperature defined for the scene (not shown). The graphical user interface 410a may include a master color control box 416c. The master color control box 416c may be used by the user to uniformly control the color temperature defined for each of the zones in a scene. For example, referring to FIG. 4C, the color temperature defined for each of the zones in the Bright scene may be set to 4500 K. When the color temperature is set to different colors for one or more of the zones for the area, the master color control box 416c may be set to a default or null value. A value may be entered into the master color control box 416c to automatically conform the color temperatures in each of the zones.

The graphical user interface 410a may include a control interface 440 to control the lighting intensity and color temperature defined for a zone (e.g., the “Desk Area” zone as shown in FIG. 4C). The control interface 440 may include an indicator 442, a “warm/cool” actuator 446, a palette 448, an actuator 444, and/or a control line 450. The palette 448 may show a range of colors ranging from cool colors 443a at the top of the palette 448 to warm colors 443b m at the bottom of the palette 448. As described herein, these colors may correspond to colors that lie along the black body curve. For example, the palette 448 may show colors along a range of correlated color temperatures (CCTs) ranging from “warm white” (e.g., roughly 2600 K-3700 K) at 443b, to “neutral white” (e.g., 3700 K-5000 K) to “cool white” (e.g., 5000 K-8300 K) at 443a. The actuator 444 may be superimposed over the palette 448. The actuator 424 may be movable/slide-able (e.g., here vertically movable) along the control line 450 to select different CCTs along the black body curve.

The control interface 440 may include similar indicators and/or controls for controlling the intensity of the lighting control devices as illustrated in the control interface 418 shown in FIG. 4B. For example, the control interface 440 may include an indicator 432, control line 436, and/or actuators 422, 420a, 420b. The control interface 440 may allow the user to control the intensity and color temperature of lighting control devices in the defined zone.

A scene may provide for full color control of a respective zone. Turning now to FIG. 4D, the graphical user interface 410a may be displayed by the control/configuration application to control the full color defined by a zone. The graphical user interface 410a may include a control interface 452 to control the lighting intensity and full color for a zone (e.g., the “Front Downlights” zone as shown in FIG. 4D). The control interface 452 may include control line 436 and actuators 422, 420a, 420b to control the lighting intensity of the “Front Downlight” zone. The control interface 452 may include a palette 454 showing a plurality of colors that lie within the color gamut formed by the various RGBW LEDs, for example, that make up the one or more lighting loads in the defined zone.

The one or more lighting loads in the defined zone may be controlled to provide full color and/or the warm/cool colors on the black body curve. The control interface 452 may include a warm/cool color tab 421a and full color tab 421b. Selection of the warm/cool color tab 421a may display a palette in the control interface 452 that is similar to the palette 448 shown in the control interface 440 for the “Desk Area” zone to allow the user to define warm/cool color temperatures for the lighting control devices in the “Front Downlights” zone. Selection of the full color tab 421b may display the palette 454 that provides colors available for full color control.

The user may select a location within the color palette 454 to define a color for the corresponding zone. The color palette 454 is displayed such that different color bands are displayed from top to bottom (e.g., red, yellow, green, teal, blue, purple, etc.). The color palette 454 is displayed such that a user may select the x-y coordinates on an x-axis and a y-axis corresponding to a given color. The color palette 454 may include white colors on the far-right side of the color palette 454, though the white colors may be located in other areas of the color palette 454.

Turning now to FIG. 4E, the control interface may identify a user selection on the color palette 454. Superimposed over the palette 454 may be an actuator 458 that identifies a user selection within the color palette 454. The actuator 458 may be movable/slide-able by the user to any of a plurality of locations/colors within palette 454. The graphical user interface 410a may display together with actuator 458 two perpendicular control lines that intersect at the center of the actuator 458. These control lines and the intersection point may move with the actuator 458 as it is moved by a user within palette 454, or as the user selects another location within the palette 454 independently. These control lines may assist the user in moving actuator 458 either horizontally or vertically. Accordingly, actuator 458 may allow a user to configure the zone such that the zone produces colored light at a color point that lies within the color gamut formed by the various RGBW LEDs, e.g., that make up the one or more lighting loads of the defined zone.

The color gamut formed by the various RGBW LEDs that make up the lighting load may be referenced using an x-y coordinate system. Accordingly, the control interface 452 may include a coordinate indicator 456. The coordinate indicator 456 may illustrate the x-y coordinates of the selected color. For example, referring to FIG. 4E, the color selected for the “Front Downlights” zone may be indicated by the x-y coordinates [0.123, 0.455] indicating a value on the x-axis and the y-axis.

Upon the full color tab 421b being actuated by a user from control interface 452, or prior to the color being defined for the zone, the control/configuration application may initially display control interface 452 without actuator 458 and without the control lines, as shown in FIG. 4D. Upon the user performing a selection within the palette 454, the graphical user interface 410a may display actuator 458 and the control lines at a relative point within palette 454 to indicate the color being defined and/or produced by the one or more lighting loads within the zone.

The graphical user interface 410a may include a “Show Advanced Options” button 460, which, when actuated may cause the graphical user interface 410a to display advanced options for control of a scene. FIG. 4F shows an example of the graphical user interface 410a displaying advanced options for control of a scene. As shown in FIG. 4F, the graphical user interface 410a may include an Include box 462, Fade time box 464, Delay time box 466, and/or Vibrancy selector 468 for each of the respective zones in the area. When the Include box 462 is selected, the respective zone may be included in the scene. For example, referring to FIG. 4F, the “Front Downlights” and “Desk Area . . . ” zones may be included in the Bright scene.

Fade time box 464 may be used by the user to select the fade time of a zone when the selected scene is implemented. The fade time may be the period of time over which a respective zone is to transition to the lighting intensity and/or color temperature and/or color defined by a scene. For example, referring to FIG. 4F, the Front Downlights zone may transition, at the time the Bright scene is implemented, from a current lighting intensity to a 50% lighting intensity and from a current color temperature/color to a color temperature of 4500K over a period of 2 seconds. Similarly, the Delay time box 466 may be used by the user to select the delay time of a zone when the selected scene is implemented. The delay time may include the period of time during which a respective zone delays the transition indicated by the scene. For example, referring to FIG. 4F, at the time the Bright scene is implemented the “Front Downlights” zone may delay the transition to a 50% lighting intensity and a color temperature of 4500K for 2 seconds. The delay may be implemented prior to the fade time. Accordingly, upon a user implementing the Bright scene, the “Front Downlights” may wait 2 seconds before transitioning from a current intensity and color temperature/color to a 50% lighting intensity and a color temperature of 4500K over a 2 second period of time.

The graphical user interface may include a “Vibrancy” selector 468. The Vibrancy selector 468 may be used by the user to select the vibrancy for a particular zone within a scene. For example, the vibrancy may adjust the wavelength of the light emitted by the zone, which may affect the color of the light (e.g., the reflected light) on objects within the zone. The increased/decreased vibrancy may increase/decrease saturation of the color of objects in the area without changing the color of the light when the user looks at the light (e.g., the color of the emitted light). The Vibrancy selector 468 may allow the user to select a relative level of vibrancy (e.g., between zero and one-hundred percent) for increasing/decreasing the vibrancy of the one or more lighting loads for a defined zone. Changing the relative level of vibrancy may include decreasing or increasing the intensity of one or more white LEDs that make up the one or more lighting loads for a defined zone, thereby increasing or decreasing vibrancy, respectively. Changing vibrancy in this manner may also include changing the intensities of other LEDs (e.g., red, green, and/or blue LEDs) of the loads in the zone to maintain the same color output of the lighting loads (e.g., to maintain the same (or approximately the same) chromaticity coordinates of the mixed color output of the lighting loads in the zone). Vibrancy selector 468 may be referred to as an adjustable vibrancy mode.

The user may select the information button 469 to obtain information about how the vibrancy may be selected for a zone. FIG. 4G is an example display 474 that may be shown if the user selects the information button 469. The vibrancy may be changed for each of the zones that are configured for control along the black body curve. The vibrancy may be enabled for zones that are defined for control using the warm/cool color temperature palette. The vibrancy may be controlled for lighting control devices in a zone that are being controlled along the black body curve, as the lighting control devices may be using a number of colored LEDs to generate the color temperatures that are generated along the black body curve, while also allowing variation in the use of different LEDs to increase the color being reflected to saturate the colors in the area (e.g., by reducing the intensities of the white LEDs). For zones that are being controlled using full color, the vibrancy control may be limited to colors that are within a predefined range of the colors. For example, referring to the color palette 454 shown in FIG. 4D and 4E, the vibrancy control may be limited to a predefined set of colors on the right side of the palette 454 indicated in FIG. 4G. The predefined colors may be the 10% or 20% of colors on the right side of the palette. Vibrancy control may be disabled when the user selects colors in the palette that are outside of this predefined set of colors, as it may not be possible to render these colors in multiple ways using, for example, different intensities of RGB and white LEDs.

Referring again to FIG. 4F, the graphical user interface 410a may control the lighting intensity of different zones or lighting control devices separately, while controlling the color temperature in uniform. For example, the graphical user interface 410a may include control interfaces 470a, 470b to control the lighting intensities of two or more zones (e.g., “Desk Area 1” and “Desk Area 2”) separately and control interface 472 to control the color temperature of the two or more zones in uniform. The control interfaces 470a, 470b may each include an indicator 432, a control line 436 and actuators 422, 420a, 420b to separately control the lighting intensity of their respective zones or lighting control devices. Similarly, the control interface 472 may include an indicator 442, a palette 448, an actuator 444, and/or a control line 450 to uniformly control the color temperature of the zones. Though control interface 472 includes a warm/cool color palette 448 for setting a color temperature along the black body curve, full color control may similarly be implemented.

Referring now to FIG. 5A, there is shown another example graphical user interface 500 that may be displayed by the control/configuration application to a user via a network device. The user may use the graphical user interface 500 to configure and/or control one or more lighting control devices, which may each be assigned to a respective zone. The graphical user interface 500 may be displayed to enable selection of an area indicator 412a that defines an area within which one or more scenes are defined. The area indicator 412a may be selected to edit or define predefined scenes within the area. A user may interact with the graphical interface 500 to configure/define a given scene in an area. For example, the graphical user interface 500 may display a list of areas and/or sub-areas in the load control system that may be configured. As shown in FIG. 5A, for example, the list of areas that may be configure include: “Lobby,” “Open Office,” “Conference Room A,” “Executive Office,” and “Open Office.” These areas may be sub-areas of a larger area, such as a floor in a building (e.g., “Floor 1”) and/or a portion of a floor (e.g., “North Wing,” “South Wing”, etc.). After selecting the area to configure by selecting the corresponding area indicator, the graphical user interface 500 may display scenes that may be further configured/defined for that area.

After selection of a defined area, the control/configuration information may access the zones in the configuration information that are defined for the selected area and enable control/configuration of the zones in the area. For example, as shown in FIG. 5A, the user may have selected to configure the “Lobby” area by selecting the area indicator 412a shown in FIG. 5A, which may cause the graphical user interface to display the scene icons 504a, 504b, 504c, 504d, shown in FIG. 5B, that may each be respectively configured via graphical user interface 500.

As shown in FIG. 5B, the graphical user interface 500 may be used to configure and store the intensity and/or color settings for one or more lighting control devices for a corresponding scene in the selected area. The graphical user interface 500 shown in FIG. 5B may include a scene identification interface 519. The scene identification interface 519 may include an indication of each of the plurality of scenes defined for the selected area. For example, the scene identification interface 519 may include one or more scene icons 504a, 504b, 504c, 504d, which may be examples of similar scene icons 414 described herein. As described herein, the scene icons 504a, 504b, 504c, 504d may indicate the scenes that are defined for the particular area of the load control system. For example, the scene icons 504a, 504b, 504c, 504d may correspond to respective buttons on a remote control device or keypad in the selected area. When the button on a graphical user interface or a device (e.g., remote control device) that corresponds to a given scene is selected, the remote control device or a system controller may transmit one or messages including control instructions to control the one or more lighting control devices in that area based on the configurations of the selected scene. The displayed interface may return to the graphical user interface 500 shown in FIG. 5A (or another interface, such as the graphical user interface 410 shown in FIG. 4A) after selection of the back button 502.

The scenes that correspond to the scene icons 504a, 504b, 504c, 504d may be configured and saved to the network device using the control/configuration application that is being used to display the graphical user interface 500. In another example, the scenes that correspond to the scene icons 504a, 504b, 504c, 504d may be predefined (e.g., using a design software on another computing device) and the scene icons 504a, 504b, 504c, 504d may be displayed and selected on the graphical user interface 500 for changing the settings for the selected scene.

The graphical user interface 500 may indicate the selected scene that is being configured. For example, the graphical user interface 500 includes a “Daytime” scene icon 504a, a “Night” scene icon 504b, an “Evening” scene icon 504c, and a “Cleaning” scene icon 504d. Each of the scenes icons 504a, 504b, 504c, 504d may enable the corresponding scene to be separately configurable and/or programmable via the graphical user interface 500. For example, the “Daytime” scene icon 504a is indicated as being selected for configuration of the “Daytime” scene by highlighting “Daytime” scene icon 504a with a different color on the graphical user interface 500 than the other scene icons 504b, 504c, 504d.

After selection of the “Daytime” scene icon 504a for configuration of the “Daytime” scene, the current settings for the “Daytime” scene may be displayed in the graphical user interface 500. The network device may also send one or more messages that causes the lighting control devices in the respective zones that are included in the “Daytime” scene to be controlled in the user environment according to the settings of each of the lighting control devices in the “Daytime” scene in order to allow the user to preview the scene, which may allow for the user to efficiently and accurately configure the scene in real time.

After the settings for the selected scene have been displayed in the graphical user interface 500, the settings for the selected scene may be configured. The “Flash” button 506 may be selected to identify the lighting control devices that are included in the zone or zones that are a part of the selected scene corresponding to the Daytime” scene icon 504a. After the “Flash” button 506 is selected, the user may select the zone for identification, for example, by selecting the tile that corresponds to that zone. In response to the selection of the “Flash” button 506 and the zone for identification, the network device may send a message to the lighting control devices in the zone including control instructions for identifying themselves to the user in the user environment. For example, the lighting control devices in the zone selected for identification may flash on and off a predefined number of times, for a predefined period of time, or until receiving another message instructing the lighting control devices to stop identifying themselves. Referring to FIG. 5B, for example, after selecting the “Flash” button 506 and the tile 510, the lighting control devices located in the “Chandelier 1” zone may flash on and off, which, as described herein, may assist the user in accurately and efficiently configuring the one or more lighting control devices. Similarly, if the user were to select a the “Flash” button 506 with a different zone, such as the “Chandelier 2” zone, the lighting control devices in the “Chandelier 2” zone may flash on and off. Though the lighting control devices are described as identifying themselves in the user environment by flashing, the lighting control devices may identify themselves by otherwise changing an intensity, changing a color or color temperature, or otherwise identifying themselves (e.g., flashing for a set period of time, flashing until the flash button 506 is unselected).

The graphical user interface 500 may include a zone identification interface 517. The zone identification interface may be populated with tiles that identify each of the one or more zones in the selected scene corresponding to the scene icon 504a. Each tile may be displayed with a corresponding lighting intensity and color setting for the selected scene corresponding to the scene icon 504a. For example, referring to FIG. 5B, the graphical user interface may display a tile 510 to illustrate the settings for the “Chandelier 1” zone, and a tile 546 to illustrate the settings for the “Chandelier 2” zone. The tile 510, may include a zone identifier 512, to show the identifier assigned to a given zone (e.g., “Chandelier 1”, as shown in FIG. 5B). The user may select the zone identifier 512 to adjust the identifier or name assigned to a given zone. For example, the identifier assigned to the zone associated with tile 510 may be “Chandelier 1” and the user may select the zone identifier 512 to adjust the identifier or name assigned to that zone. The zone identifier 512 may correspond to a unique identifier in the load control system for controlling the lighting control devices in the zone. The user may scroll down the graphical user interface 500 to display tiles for additional zones defined for the area.

The tile 510 may include a lighting intensity box 514. The lighting intensity box 514 may provide the configured lighting intensity for the “Chandelier 1” zone in the selected scene. The lighting intensity box 514 may show the current lighting intensity for the “Chandelier 1” zone (e.g., when previewing the settings for the scene) as the lighting intensity is being changed, or the configured lighting intensity for when the zone is implemented during the “Daytime” scene. The tile 510 may include color temperature box 516. The color temperature box 516 may define a warm/cool color temperature for setting a color temperature along the black body curve. The color temperature box 516 may provide the configured color temperature (e.g., in degrees Kelvin) for the “Chandelier 1” zone in the selected scene. Similarly, the tile 546, which illustrates the settings defined or configured for the “Chandelier 2” zone, may include a full color box 544, which may show the configured color for the “Chandelier 2” zone that is capable of full color. The color temperature box 516 may show the current color temperature for the “Chandelier 1” zone (e.g., when previewing the settings for the scene) as the color temperature is being changed, or the configured color temperature for when the zone is implemented during the “Daytime” scene. Similarly, the full color box 544 may show the current color for the “Chandelier 2” zone, or the configured color for the “Chandelier 2” zone when the “Daytime” scene is activated. The user may change the lighting intensity or the color temperature by changing the values in the lighting intensity box 514 or the color temperature box 516, respectively.

The user may select a zone for configuration by selecting the title associated with a given zone. For example, as show in FIG. 5B, the user may select the tile 510 to configure the “Chandelier 1” zone. The graphical user interface 500 may indicate the selected zone that is being configured, for example, by highlighting an outline around the tile for that zone (e.g., as shown in FIG. 5B). After selecting the zone for configuration, the user may use the graphical user interface 500 to configure the respective settings of that zone for the selected scene.

The graphical user interface 500 may include a control interface 550 that may be used to configure the settings of the selected zone corresponding to the tile 510. The control interface 550 may include control type icons 528, 530, 532, 534, 536. Each of the control type icons 528, 530, 532, 534, 536 may correspond to a type of control that a user may configure for the selected zone. The control interface 550 may display different settings for configuring different types of control based on the control type icon that is selected. For example, as illustrated in FIG. 5B, control type icon 528 may be selected to configure the color temperature settings (e.g., intensity and/or warm/cool color) for a zone; control type icon 530 may be selected to configure the full color settings (e.g., intensity and/or color) for a zone; control type icon 532 may be selected to configure the vibrancy settings for a zone; control type icon 534 may be selected to configure the fade settings (e.g., rate at which the selected zone transitions to the settings defined by the scene) for a zone; and control type icon 536 may be selected to configure the delay (e.g., the period of time after which the zone begins the transition to the setting defined by the scene) for a zone.

A user may select one of the control type icons 528, 530, 532, 534, 536 to configure the settings for the selected zone. After selection, the graphical user interface 500 may indicate the control type icon that has been selected by the user by highlighting the selected control type icon. In FIG. 5B, the control type icon 528 is indicated as being selected by an underline of the control type icon 528. After a control type icon is selected by a user, the graphical user interface 500 may display one or more settings corresponding to the control type.

After selection of the control type icon 528, the control interface 550 may display a lighting intensity bar 542 and/or a color temperature bar 540 for enabling configuration of the intensity and color temperature settings respectively for the selected zone. The control interface 550 may be updated in response to receiving the selection of the zone being configured (e.g., in response to the selected zone corresponding to the tile 510). For example, the control interface 550 may be updated with the settings for the selected zone that is being configured. The control interface 550 may update the lighting intensity bar and the color temperature bar 540 with the lighting intensity setting and the color temperature settings that are stored in the selected scene for the selected zone. Other settings, such as full color settings, fade settings, or delay settings may also be populated in the control interface 550 in response to the selection of the zone being configured. The pre-population of the control settings may be a starting point for configuration and/or updating the settings for one or more zones.

The user may configure the lighting intensity of the selected zone by selecting a portion of the lighting intensity bar 542. The lighting intensity bar 542 may include a moveable (e.g., vertically moveable) control line 537 that indicates the selected intensity level (e.g., as a percentage) within the intensity bar 542. The user may select a location within the lighting intensity bar 542 and the network device may move the control line 537 to the selected location within the lighting intensity bar 542 to indicate the selected light intensity. The user may select the control line 537 itself and move the control line 537 to indicate the selected intensity (e.g., as a percentage) within the intensity bar 542. The portion of the lighting intensity bar 542 between 0% and the selected lighting intensity percentage at the control line 537 may be filled (e.g., filled with a different color) to indicate the selected lighting intensity. Though described herein as a control line 537, the control line 537 may be another type of control indicator or actuator configured to control and/or indicate the lighting intensity value.

In response to the selection of a lighting intensity in the lighting intensity bar 542, the network device on which the control interface 550 is being displayed may send a message configured to control the lighting loads in the selected zone to the selected lighting intensity. The control interface 550 may include a lighting intensity box 520, which may provide the lighting intensity selected within the lighting intensity bar 542 for configuring the selected zone (e.g., 50% as shown in FIG. 5B). The lighting intensity box 520 may display the selected lighting intensity in text, which may allow the selected lighting intensity to be more easily identifiable to the user. A user may enter a desired lighting intensity value into the lighting intensity box 520. Also, or alternatively, the user may configure the selected lighting intensity value using the actuator button 548. The selection of the actuator button 548 may adjust the control interface 550 to display fine-tune adjustment buttons for more granular control of the intensity level, as further described herein with reference to FIG. 5X herein.

The color temperature bar 540 may include a palette 552 and/or an actuator 538. As described herein, the palette 552 may show a range of colors ranging from cool colors at the top of the palette 552 to warm colors at the bottom of the palette 552. These colors may correspond to colors that lie along the black body curve. For example, the palette 552 may show colors along a range of correlated color temperatures (CCTs) ranging from “warm white” (e.g., roughly 2600 K-3700 K) to “neutral white” (e.g., 3700 K-5000 K) to “cool white” (e.g., 5000 K-8300 K). The actuator 538 may be superimposed over the palette 552. The actuator 538 may be movable (e.g., vertically movable) within the palette 552 and may be used to select different CCTs along the black body curve.

The color indicator box 524 may show the selected color temperature, which may provide the color temperature selected within the color temperature bar 540 for configuring the selected zone (e.g., 3200K, as illustrated in FIG. 5B). The color indicator box 524 may display the selected color temperature in text, which may allow the selected color temperature to be more easily identifiable to the user. A user may enter a desired color temperature value into the color indicator box 524 and the color temperature may be reflected by the actuator 538 over the palette 552. The lighting intensity box 514 and/or the color temperature box 516 in the tile 510 may be maintained as the current settings stored for the zone in the scene while the settings are being updated for the zone using the control interface 550. The settings in the lighting intensity box 514 and/or the color temperature box 516 in the tile 510 may be updated after the user actuates the “Save to” button 522, which, when actuated, may save the configuration of and/or changes to the zone for the respective scene.

Rather than manually selecting a color temperature with the actuator 538, the user may automatically configure the color temperature for the selected lighting intensity value by actuating the daylight button 526. When the user actuates the daylight button 526, the color temperature may be automatically selected by the control/configuration application. When selected, the daylight button 526 may automatically set the color temperature for a zone based on the lighting intensity defined for the zone. For example, the color temperature may be automatically selected using a relationship (e.g., a pre-determined or pre-defined relationship) between the color temperature and the selected lighting intensity for the zone. The automatically selected color temperature may mimic the color temperature of a dimmed incandescent lamp (e.g., black-body dimming) at the selected lighting intensity. Each lighting intensity value may be stored in a dataset with a corresponding color temperature value that is accessed by the control/configuration application for automatically selecting the color temperature value.

When the user actuates the daylight button 526, the graphical user interface 500 may display a window, such as the window 570 shown in FIG. 5D, for selecting whether the color temperature should automatically change with the lighting intensity value. The window 570 may include an “On” button 572 and an “Off” button 574. If the user actuates the “On” button 572, the color temperature for the zone may be automatically selected based on the lighting intensity defined for the zone. Each lighting intensity may be defined in storage with a corresponding color temperature value on the black-body curve. As the user changes the lighting intensity value towards 0%, the intensity values may correspond to warmer color temperature values along the black-body curve. As the user increases the lighting intensity value toward 100%, the intensity values may correspond to cooler color temperature values along the black-body curve. For example, the color temperature may mimic warm dimming. If the user actuates the “Off” button 574, the user may manually select the color temperature for the zone and the dimming may be performed at that color temperature value. Hence, through daylight button 526 and user interface 570 a user may activate/deactivate (turn on/off) the daylighting feature whereby color temperature automatically may change/be automatically set based on the lighting intensity value. Further, a user may simply define a scene for a given zone by actuating the daylight button 526 and actuating the “On” button in window 570 whereby the color temperature of the lighting control devices is automatically changed/set based on the lighting intensity value defined for the scene (e.g., the color temperature for the zone is automatically set based on the lighting intensity defined for the scene). In addition, when the daylight button 526 is selected, the lighting devices in the zone may be set to the auto vibrancy state, as described herein.

After the user selects the “On” button 572, the color temperature bar 540 in the control interface 550 shown in FIG. 5B may be blank, faded out, may not be displayed, or otherwise indicate (e.g., in text being overlaid on the color temperature bar 540) that the color temperature settings are being automatically controlled. When the color temperature settings are being automatically controlled, the color temperature bar 540 in the control interface may be disabled to disable manual control of the color temperature by the user. When the color temperature settings are being automatically controlled, the daylight button 526 may still be selectable to display the window 570 shown in FIG. 5D and allow the user to turn on/off the automatic selection of the color temperature settings.

Referring again to FIG. 5B, a user may select other control type icons 530, 532, 534, 536 for configuring the respective settings associated with the selected control type icon for the zone in the scene. For example, when the user selects control type icon 530 to configure the full color settings of the zone, the control interface 550 may display a lighting intensity bar for selecting the lighting intensity and a color palette that shows plurality of colors that lie within the color gamut formed by the various RGBW LEDs that are available for full color control (e.g., similar to the color palette 454 illustrated in FIGS. 4D and 5I). The full color settings may include the color temperature values for on the black-body curve, as described herein. The user may select a location within the color palette to define a color for the corresponding zone and similarly use the lighting intensity bar 542 to control an intensity of the selected color. When the user selects the control type icon 532 to configure the vibrancy settings of the zone, the control interface 550 may display a vibrancy bar (e.g., similar to the lighting intensity bar 542) and/or a vibrancy selector (e.g., similar to the “Vibrancy” selector 468 shown in FIGS. 4F and 5Y) that allows the user to select the vibrancy for the selected zone or automatically optimize the CRI value for the light emitted in the zone as discussed below. When the user selects the control type icon 534 to configure the fade settings for a zone, the control interface 550 may display a time bar (e.g., similar to the lighting intensity bar 542) and/or time box (e.g., text box for time) that allows the user to select a fade time over which the zone may be configured to fade into the selected scene. When the user selects the control type icon 536 to configure the delay settings for a zone, the control interface 550 may display a time bar (e.g., similar to the lighting intensity bar 542) and/or time box (e.g., text box for time) that allows the user to select a delay time prior to implementing the scene. After the user completes configuring the setting for the zone, the user may actuate the “Save to” button 522, which, when actuated, may save the configuration of and/or changes to the respective scene.

In response to the selection of the “Save to” button 522, the user may also select another scene to which to store the configuration for one or more zones. For example, the user may select the “Save to” button 522 and then select the scene icon 504b (e.g., “Night” scene), the scene icon 504c (e.g., “Evening” scene), and/or the scene icon 504d (e.g., “Cleaning” scene) to save the current configuration for controlling one or more selected zones in response to the triggering event for the selected scene. The network device may identify the zone in the selected scene for which the configuration is being stored and store the lighting intensity and/or color setting in the configuration data with the zone identifier(s) for being controlled in response to activation of the selected scene. Although lighting intensity and color setting are provided as examples, other configuration data may similarly be saved.

The lighting control devices in a given load control system may have different lighting capabilities. For example, some of the lighting control devices may be capable of performing full color and color temperature control, while other lighting control devices may be limited to performing intensity control. As described herein, the tile 510 may include an Affected button 518. The user may select the Affected button 518 to configure the settings (e.g., intensity, color, color temperature, etc.) in the zone that are affected when the corresponding scene is implemented. The Affected button 518 may be displayed when a given zone is selected for configuration in the scene, as shown by the selected tile 510.

When the user actuates the Affected button 518, the graphical user interface 500 may display a window, such as window 560 as shown in FIG. 5C, that includes settings for configuring the portions of the selected zone that are affected/unaffected by the control settings for a scene. The window 560 may include an “All affected” button 562, an “Intensity only” button 564, a “Color only” button 566, and/or an “Unaffected” button 568. The user may select one of the buttons 562, 564, 566, 568 to indicate which settings of a given zone are affected by a scene when the scene is implemented/activated. For example, when the user selects the “All affected” button 562, the zone will be set to the color and lighting intensity settings defined for the scene when the scene is implemented. Similarly, when the user selects the “Unaffected” button 568, the zone's color and lighting intensity settings will be unaffected by the configured settings for the scene when the scene is implemented/activated. When the zone is selected to be unaffected by the scene, the lighting control devices in the zone may remain at their present lighting intensity and/or color when the scene is implemented in the load control system. When the user selects the “Intensity only” button 564, the lighting control devices in the zone may be set to the lighting intensity settings defined by the scene when the scene is implemented, but the color of the lighting control devices may be unaffected/remain at their current settings. When the user selects the “Color only” button 566, the lighting control devices in the zone may be set to the color settings defined by the scene when the scene is implemented, but the lighting intensity of the lighting control devices may be unaffected/in at their current settings.

Referring again to FIG. 5B, the graphical user interface 500 may include a “Master Control” button 508. The “Master Control” button 508 may be used to uniformly configure and/or control light settings across all of the zones in a scene at the same time. For example, a user may uniformly configure and/or control the lighting settings (e.g., lighting intensity or color temperature settings) of each of the zones in a scene at the same time by selecting “Master Control” button 508. When the lighting control devices in each of the zones in the scene are configured at the same lighting intensity (e.g., the lighting intensity of the Chandelier 1 zone, the Chandelier 2 zone, the Pendants 1 zone, the Pendants 2 zone, the Pendants 3 zone, the Pendants 4, etc. are the same), that lighting intensity of each of the lighting loads in the scene may be displayed on the lighting intensity bar 542 and the lighting intensity may be collectively controlled to the same lighting intensity. This may allow for an “absolute control” of each of the zones in a scene, i.e., control of each of the zones in a scene to the same lighting intensity. When the lighting control devices in each of the zones in the scene are at the different lighting intensities (e.g., the lighting intensity of one or more of the lighting control devices in the Chandelier 1 zone, the Chandelier 2 zone, the Pendants 1 zone, the Pendants 2 zone, the Pendants 3 zone, the Pendants 4, etc. are different), the user may perform “relative control” of each lighting control device, i.e., to similarly raise and/or lower the lighting intensities of the lighting loads in each of the zones of the scene at the same time relative to each zones current configuration.

FIGS. 5E and 5F show additional examples of the graphical user interface 500 that may be displayed by the control/configuration application to a user via a network device to enable master control of the lighting control devices in each of the zones to be controlled for a given scene. As described herein, the “Master Control” button 508 may be selected to collectively configure and/or control the zones in a scene. Looking first at the configuration of the lighting intensity of the zones in a scene, FIGS. 5E and 5F illustrate that, in response to the selection of the “Master Control” button 508, the user interface 500 may display different features for enabling collective control of multiple zones based on whether the lighting intensity is the same or different in the zones configured for being controlled in the scene. The control interface 550 of the graphical user interface 500 may be updated in response to selection of the “Master Control” button 508 shown in FIG. 5B, or portions thereof may be updated in a portion of the graphical user interface 500. The control of the

Referring to FIG. 5E, after selecting the “Master Control” button 508, the control interface 550 may enable absolute control of the zones in the scene based on the lighting intensity of the zones being the same (here, 50%) upon actuation of the “Master Control” button 508. When the zones that are being collectively configured and/or controlled are at the same lighting intensity value (e.g., the lighting intensity of the Chandelier 1 zones, the Chandelier 2 zone, and the Pendants zones are the same), the network device may determine to display the control interface 550 that enables absolute control of the zones. The control interface 550 may include the light intensity bar 542 that identifies the common lighting intensity value of the zones being collectively controlled (e.g., 50% as shown in FIG. 5E). The user may perform absolute control to uniformly configure the lighting intensity across the zones by adjusting the lighting intensity reflected in the lighting intensity bar 542 as described herein. Similarly, the user may adjust the common lighting intensity for the zones in the intensity box 520 and/or by selecting the actuator button 548, as described herein.

As certain zones may be configured to be affected or unaffected by the lighting intensity being configured, the selection of the “Master Control” button 508 may cause the control interface 550 to ignore the current configuration of the affected and unaffected zones and the control interface 550 may cause the common lighting intensity to be displayed for each of the affected zones, which may be stored after selection of the lighting intensity in the lighting intensity bar 542. The lighting intensity value that is indicated in the tiles for each zone may be updated based on the affected or unaffected setting that is stored with the zone for each tile. For example, the lighting intensity values displayed in the tiles 510, 546 may be updated to reflect the common lighting intensity value being selected in the lighting intensity bar. In another example, if one of the zones represented by the tiles 510, 546 is configured to be unaffected by the changes in the common lighting intensity, the lighting intensity value in the tile 510, 546 for the unaffected zone may not change with the selection of the common lighting intensity value. The common lighting intensity value may be updated for the affected zones.

As shown in FIG. 5F, after selecting the “Master Control” button 508, the control interface 550 may enable relative control of the lighting control devices based on the lighting intensity values of the zones being different upon actuation of the “Master Control” button 508. The relative control of the different zones may cause different control instructions to be sent to each of the zones, rather than performing absolute control by transmitting the same control instructions to each zone.

When the zones that are being collectively configured or controlled are currently set to a different lighting intensity value (e.g., as the lighting intensity of the Chandelier 1 zone, the Chandelier 2 zone, and the Pendants zones are different), the network device may determine to update the control interface 550 for enabling relative control of the zones. The lighting intensity bar 542 of the control interface 550 may include actuators 582a, 582b, which may respectively be used to enable a relative increase or decrease in the lighting intensity values across the multiple zones relative to each zones current setting. For example, a user may actuate or tap actuator 582a to perform a relative increase in the lighting intensity across the multiple zones by 1%, though another predefined relative amount may be chosen.

Actuating the actuator 582a may enable a relative increase in the lighting intensity of each of the zones in the scene (e.g., Chandelier 1 zone, Chandelier 2 zone, and Pendants may each be increased by 1%), resulting in the lighting intensity of the Chandelier 1 zone being increased to 57% and the Chandelier 2 zone being increased to 51%. Each of the Pendants zones will be similarly increased by 1%. Actuating the actuator 582b may enable a relative decrease in the lighting intensity of each of the zones in the scene (e.g., Chandelier 1 zone, Chandelier 2 zone, and Pendants may each be decreased by 1%), resulting in the lighting intensity of the Chandelier 1 zone being decreased to 55% and the Chandelier 2 zone being decreased to 49%. Each of the Pendants zones will be similarly decreased by 1%. Also, or alternatively, the user may hold actuators 582a, 582b to continuously perform a relative increase or decrease the lighting intensity across the multiple zones, respectively. When the lighting intensity in the zones are different, the intensity box 520 may indicate that the lighting intensity in the zones are different (e.g., by including text that the lighting intensities are “mixed” or are not uniform).

When the lighting intensities of the different zones for the scene are set to different intensities, the lighting intensities may be synchronized for absolute control. As shown in FIG. 5F, the control interface 550 may include a “Set to same” button 584 that may be configured to synchronize the lighting control devices of the zones in a scene to the same lighting intensity when the lighting intensities across two or more of the zones are different. The user may select the “Set to same” button 584 such that each of the zones may be set to the same lighting intensity. For example, upon actuation of the “Set to same” button 584 the lighting intensity for each zone may be set to one of the lighting intensities of one of the zones in the scene, or to a default value. Each zone may be further configured by the user via any of the lighting intensity bar 542, actuator button 548, or the lighting intensity box 520. As another example, upon actuation of the “Set to same” button 584, the user may then select a lighting intensity value to which the other zones should synchronize their lighting intensity values. For example, after a user selects the “Set to same” button 584, the user may select a lighting intensity value in the lighting intensity bar 542 to which to set the lighting intensity settings for each of the zones in the scene. The lighting intensity bar 542 may be enabled in response to the “Set to same” button 542. After selection of the “Set to same” button 584, the lighting intensity bar 542 may be updated as shown in FIG. 5E to allow the user to select a lighting intensity value. The control interface 550 may then similarly control each of the zones in the scene to the same lighting intensity, as shown in FIG. 5E, for example. After changing the lighting intensity in the control interface 550, the user may save the settings for the zone by actuating the “Save to” button 522, which may save the configuration of and/or changes to the zone for the respective scene. After the zones are configured using the “Master Control” button 508 and/or the “Set to Same” button 542, the user may continue to update the configuration of the individual zones (e.g., by configuring lighting intensity values, color settings, affected or unaffected configurations, etc.)

The “Master Control” button 508 may also be used to uniformly configure and/or control additional settings for the zones in a scene. For example, as illustrated in FIG. 5E, the color temperature settings may be collectively configured for the zones in a scene upon selection of the “Master Control” button. After selecting the control type icon 528, the graphical user interface 500 may display the control interface 550 to allow for selection of color temperature settings for the zones in the scene. As shown in FIG. 5E, the color temperature settings for each zone indicated by tiles 510 and 546 are different (e.g., the color temperature values of the Chandelier 1 zone, the Chandelier 2 zone, and the Pendants zones are different). The color indicator box 524 may thus indicate that the color settings for two or more of the zones are different (e.g., by including text that the color temperature settings are “mixed” or are not uniform). When the zones in the scene are configured with different color temperature/full color settings, the color temperature bar 540 in the control interface 550 may be blank, faded out, may not be displayed, or otherwise indicate the different color temperature settings. When the zones in the scene are configured with different color temperature settings, the color temperature bar 540 may be disabled. When the zones in the scene are configured with the same color temperature settings, the color temperature bar 540 may be enabled. When the color temperature bar 540 is enabled, a user may select the daylight button 526 to configure each of the zones with the same color temperature setting for a corresponding lighting intensity value selected on the lighting intensity bar 542.

The control interface 550 may include a “Set to the same” button 584a. The “Set to the same” button 584a may enable/allow the color temperature settings of the zones in the scene to be synchronized to the same color temperature value. After the user selects the “Set to same” button 584a, the color temperature bar 540 may be updated as shown in FIG. 5F to allow the user to select a color temperature value to which the color temperature settings for each of the zones (e.g., the color temperature values of the Chandelier 1 zone, the Chandelier 2 zone, and the Pendants zones) may be set. For example, the color temperature bar 540 may display the color temperature palette 552 and/or indications of color temperature values to allow the user to select a common color temperature setting for the zones. As the zones are different color temperature/color values, the color temperature bar 540 may fail to provide an indication of a selected color temperature setting, and the color temperature settings indicated in each of the tiles representing the different zones may fail to be updated, until the user performs a selection.

The user may select a location in the color temperature bar 540 to select a color temperature value to which the color temperature settings for each of the zones (e.g., the color temperature values of the Chandelier 1 zone, the Chandelier 2 zone, and the Pendants zones) may be set. After the user selection within the color temperature bar 540, the color temperature bar may display the actuator 538, as shown in FIG. 5G, to indicate the selected color temperature value for each of the zones in the scene. The user interface 500 may update the color temperature settings indicated in each of the tiles to identify the selected color temperature value as shown. The color indicator box 524 may also be updated to reflect the common color temperature value. The color temperature settings for each of the zones may then be collectively configured and/or controlled using absolute control through actuation of actuator 538 and/or entry of a color temperature value in color indicator box 524.

As certain zones may be configured to be affected or unaffected by the color temperature settings being configured, the selection of the “Master Control” button 508 may cause the control interface 550 to ignore the current configuration of the affected and unaffected zones and the control interface 550 may cause the common color temperature settings to be displayed for each of the affected zones, which may be stored after selection of the color temperature in the color temperature bar 540. The color temperature value that is indicated in the tiles for each zone may be updated based on the affected or unaffected setting that is stored with the zone for each tile. For example, the color temperature values displayed in the tiles 510, 546 may be updated to reflect the common color temperature value being selected in the color temperature bar 540. In another example, if one of the zones represented by the tiles 510, 546 is configured to be unaffected by the changes in the common color temperature, the color temperature value in the tile 510, 546 for the unaffected zone may not change with the selection of the common color temperature value. The common color temperature value may be updated for the affected zones.

FIGS. 5H-5J illustrate an example of the user interface 500 in which the full color settings of the zones in a scene may be uniformly controlled in response to the “Master Control” button 508. As illustrated in FIG. 5H, after selecting the “Master Control” button 508 and then the control type icon 530, the control interface 550 of the graphical user interface 500 may enable a user to synchronize full color control for each of the zones configured for full color in the scene. For example, the control interface 550 may display a full color bar 540a that may enable the user to select the full color settings for one or more zones. The full color settings, which may include the color temperature or warm-dim settings, for each zone indicated by tiles may be different (e.g., the full color values of the Chandelier 1 zone, the Chandelier 2 zone, and the Pendants zones are different). The color indicator box 524 may indicate that the full color settings for each of the zones are different (e.g., by including text that the full color settings are “mixed” or are not uniform). When the zones in the scene are configured with different full color settings, the full color bar 540a in the control interface 550 may be blank, faded out, may not be displayed, or otherwise indicate that the full color settings of the zones are different. When the zones in the scene are configured with different full color settings, the full color bar 540a may be disabled. When the zones in the scene are configured with different color temperature settings, the full color bar 540a may be disabled.

The “Set to the same” button 584a may enable a user to synchronize the full color settings of the zones in the scene to the same full color values. After the user selects the “Set to same” button 584a, the full color bar 540a may be updated as shown in FIG. 5I to allow the user to select a full color value to which the full color settings for each of the zones (e.g., the Chandelier 1 zone, the Chandelier 2 zone, and the Pendants zones) may be set. For example, the full color bar 540a may display a full color palette 586 and/or indications of available full color values to allow the user to select a common full color setting for the zones. The full color palette 586 may show a plurality of colors that lie within the color gamut formed by the various LEDs of the lighting loads in the zones. As the zones are set to different color values, the full color bar 540a may fail to provide an indication of a selected full color settings, and the full color settings indicated in each of the tiles representing different zones may fail to be updated, until the user performs a selection.

The user may select a location in the full color bar 540a to select a color value to which the full color settings for each of the zones (e.g., the Chandelier 1 zone, the Chandelier 2 zone, and the Pendants zones) may be set. Referring now to FIG. 5J, after the user selection within the full color bar 540a, the full color bar may display an actuator 588 to indicate the selected color value for each of the zones in the scene. As described herein, the actuator 588 may be movable/slide-able by the user to any of a plurality of locations/colors within full color palette 586. The color indicator box 524 may illustrate the x-y coordinates of the selected color on an x-axis and a y-axis, respectively. For example, referring to FIG. 5J, the purple color selected for the color of the zones in the scene may be indicated by the x-y coordinates “0.271, 1.019”. The graphical user interface 500 may update the full color settings indicated in each of the tiles to identify the selected color values as shown in FIG. 5J. The full color settings for each of the zones may then be collectively configured and/or controlled using absolute control via actuator 588 or box color indicator box 524. After the configuration of the color temperature settings or the full color settings using the master control, the user may configure each of the zones from the selected color individually and/or indicate whether a zone will be affected or unaffected by the color temperature settings or the full color settings that have been selected.

As certain zones may be configured to be affected or unaffected by the color settings being configured, the selection of the “Master Control” button 508 may cause the control interface 550 to ignore the current configuration of the affected and unaffected zones and the control interface 550 may cause the common full color settings to be displayed for each of the affected zones, which may be stored after selection of the full color value in the full color bar 540a. The full color value that is indicated in the tiles for each zone may be updated based on the affected or unaffected setting that is stored with the zone for each tile. For example, the full color values displayed in the tiles 510, 546 may be updated to reflect the common full color value being selected in the full color bar 540a. In another example, if one of the zones represented by the tiles 510, 546 is configured to be unaffected by the changes in the common full color value, the full color value in the tile 510, 546 for the unaffected zone may not change with the selection of the common full color value. The common full color value may be updated for the affected zones.

The control/configuration application may adjust the graphical user interface's display based on the screen size of the network device. For example, FIGS. 5K and 5L illustrate an example graphical user interface 501 that may be displayed by the control/configuration application when the display of the network device is smaller (e.g., smaller than that display of the network device that displays the graphical user interface 500). Further, as the display of the network device that displays the graphical user interface 501 is smaller, the graphical user interface 501 may allow a user to configure a single setting from the graphical user interface 501, rather than simultaneously configure multiple settings (e.g., as shown in the graphical user interface 500). For example, the user interface 501 may separately display the lighting intensity settings and the color control settings (e.g., color temperature, full color) for configuration and/or control.

As illustrated in FIGS. 5K and 5L, the control interface 550 may display a single bar for configuring the settings of the zones. For example, the control interface 550 shows the lighting intensity bar 542. As the lighting intensity bar 542 may be displayed separately from the color temperature bar 540 or the full color bar 540a, the configuration of the lighting intensity may have a separate/additional control type icon 528a for enabling control of the lighting intensity settings. The selection of the control type icon 528 may separately cause the control interface 550 to display the color temperature bar 540 for configuration of the color temperature settings. The selection of the control type icon 530 may separately cause the control interface 550 to display the full color bar 540a for configuration of the full color settings. Similarly, selection of the control type icon 532 may cause the control interface 550 to display a vibrancy bar (e.g., such as the vibrancy bar 598 described herein with respect to FIG. 5Y), while selection of the control type icon 534 may be selected to configure the fade settings (e.g., rate at which the selected zone transitions to the settings defined by the scene) for a zone and/or selection of the control type icon 536 may cause the control interface 550 to display a time bar (e.g., similar to the time bar 503 described herein with respect to FIG. 5Z).

The user may similarly control and/or configure the zones in the scene using the graphical user interface 501 as described herein for graphical user interface 500. For example, the user may actuate the “Master Control” button 508, which, as described herein, may be used to uniformly configure and/or control settings for the zones in a scene. The control interface 550 may enable absolute control of the lighting control devices in the zones when the settings are the same. For example, as illustrated in FIG. 5K, the control interface 550 may include the lighting intensity bar 542, which, as described herein, may be used to uniformly configure the lighting intensity, for example, by selecting a portion of the lighting intensity bar 542.

Referring now to FIG. 5L, the control interface 550 of the graphical user interface 501 may allow for relative control of the lighting control devices in the zones when the zones that are being collectively configured and/or controlled are at different settings (e.g., the lighting intensity values of the Chandelier 1 zone, the Chandelier 2 zone, and the Pendants zones are different) as describe herein. For example, as illustrated in FIG. 5L, the lighting intensity bar 542 may include the actuators 582a, 582b. And, as described herein, a user may actuate or tap actuator 582a to perform a relative increase in the lighting intensity across the zones by 1%. Similarly, the user may actuate or tap actuator 582b to perform a relative decrease in the lighting intensity across the zones by 1%, though other predefined intensities may be implemented.

Referring again to FIG. 5B, the graphical user interface 500 displayed by the control/configuration application may be updated to display different resolutions of lighting intensity on the lighting intensity bar 542 and/or the color temperature bar 540 for configuration and/or control of the zones in a scene on the network device. The lighting intensity bar 542 may include indications of lighting intensity values, such as perceived lighting intensity values such as 20%, 40%, 60%, and 80%, or other values as a default. For example, the user may actuate the lighting intensity bar 542 and hold down for a period of time to put the lighting intensity bar 542 into a fine-tuning mode and thus change a resolution state of the lighting intensity bar 542. The user may change the resolution state in other ways, for example, by actuating another button on the graphical user interface 500 or performing another actuation on the lighting intensity bar 542. The user may swipe in a direction across the lighting intensity bar 542 to change the resolution state. The user may pinch the user's fingers closer together or further away from each other on the lighting intensity bar 542 to enable a fine-tuning mode and change the lighting intensity bar 542 to a lower-resolution state or a higher-resolution state, respectively. The control interface 550 shown in FIG. 5B may be updated as shown in FIG. 5M in response to the actuation of the lighting intensity bar 542 (e.g., press and holding down on the lighting intensity bar 542 for a period of time, swipe in a direction, pinch to zoom, etc.). As shown in FIG. 5M, once in the fine-tuning mode the light intensity bar 542 may be updated to show a different resolution state of the lighting intensity bar 542. The lighting intensity bar 542 may be further updated to display different resolution states to allow a user to make even further granular changes in lighting intensity or faster changes in lighting intensity in response to additional actuations on the lighting intensity bar 542 (e.g., swipes across the lighting intensity bar 542 to achieve increase the resolution). For example, once in the fine-tuning mode as described herein, a user may swipe across the lighting intensity bar 542 one or more times in a first direction (e.g., right) to increase the resolution state of the lighting intensity bar 542. Similarly, the user may swipe across the lighting intensity bar 542 one or more times in a second direction (e.g., left) to decrease the resolution state of the lighting intensity bar 542 and to possibly exit the fine-tuning mode. And as the user swipes across lighting intensity bar 542 in a given directions, the resolution state of the lighting intensity bar 542 may increase or decrease, respectively. Though swipes in a certain direction are provided as an example, other input may be provided by the user to activate different resolution states. For example, the user may activate a button on the graphical user interface. The user may pinch the user's fingers closer together or further away from each other to enable lower and higher resolution states, respectively.

As indicated, the user may actuate the lighting intensity bar 542 (e.g., press and hold anywhere on the lighting intensity bar 542 for a predefined period of time, swipe across the lighting intensity bar 542, or pinch and expand the user's fingers) to cause the graphical user interface 500 to provide a fine-tuning mode that provides the user with a higher-resolution state or a lower-resolution state of the lighting intensity bar 542. With higher-resolution states, as compared to FIG. 5B for example, of the lighting intensity bar 542 the user may be allowed to more precisely select or identify the lighting intensity value for a zone. The higher-resolution state may allow a user to identify the difference in more precise changes in the lighting intensity value of a zone in real time as adjustments are being made to the lighting intensity values of the zone in the space. The higher-resolution state may allow for changes in the same or smaller increments than in a lower resolution state. For example, the lighting intensity bar 542 shown in FIG. 5B may be in a lower-resolution state that allows for changes in increments of five or ten percent in the intensity values, while the higher-resolution state shown in FIG. 5M for the lighting intensity bar 542 may allow for changes in smaller increments (e.g., one percent).

After entering the fine-tuning mode as shown in FIG. 5M and providing the user with a finer resolution as compared to that shown in FIG. 5B for example, the user may swipe in a first direction (e.g., swipes to the right) across the lighting intensity bar 542 to activate a higher-resolution state of the lighting intensity bar 542 as shown in FIG. 5N. Upon entering the fine-tuning mode as shown in FIG. 5M and in response to the user swiping in the first direction as shown in FIG. 5N, tick marks may be displayed on the lighting intensity bar 542 to more precisely indicate lighting intensity values. The tick marks at the higher-resolution states may indicate lower-percentage changes in the lighting intensity than at lower-resolution states. For example, a lower-resolution state of the lighting intensity bar 542 may provide tick marks at each ten-percent marker, while a higher-resolution state of the lighting intensity bar 542 may include tick marks at every five-percent marker. Each of the lighting intensity bars 542 of FIG. 5B, FIG. 5M, and FIG. 5N may allow a user to adjust the lighting intensity in a zone at the same increment (e.g., 1%), or a different predefined increment. However, the resolution state of the lighting intensity bar 542 of FIG. 5B may make such fine adjustments difficult due to the potential inaccuracy of the selection of smaller incremental values with a user's finger at lower resolution states, while the resolution state of the lighting intensity bar 542 of FIG. 5M may make this easier, and the resolution state of the lighting intensity bar 542 of FIG. 5N may make this yet easier. The higher-resolution state may allow a user to identify the difference in more precise changes of a zone in real time as adjustments are being made in the space. In general, a user may move between the different resolution states (e.g., via actuations, such as swipes, of the lighting intensity bar 542) depending on the user's desired precision in setting a given intensity level.

The user interface 500 may include a coach-mark indication 592a as shown in FIG. 5M that indicates to the user that the user can swipe in the first direction (e.g., “Swipe Right”) to display a higher-resolution state that is available. For example, after the user enters the fine-tuning mode of FIG. 5M, the user interface 500 may provide the coach-mark indication 592a to indicate that additional higher-resolution states are available to the user. The coach-mark indication 592a may be overlaid on top of the lighting intensity bar 542 to indicate that the user has swiped in the first direction or can swipe in the first direction to provide a higher-resolution state of the lighting intensity bar 542, such as swiping to the right in the lighting intensity bar 542 of FIG. 5M to obtain the lighting intensity bar 542 of FIG. 5N.

There may be multiple resolution states that may be provided as the user continues to swipe/move in a given direction (e.g., more than two as shown here). For example, there may be multiple higher-resolution states that may be displayed as the user continues to swipe in the first direction (e.g., swipe to the right) across the lighting intensity bar 542. In response to each user swipe in the first direction, additional tick marks may be displayed on the lighting intensity bar 542 to indicate additional values. Each swipe in the first direction may correspond to a different state of the lighting intensity bar 542. For example, after a first swipe to the right across the lighting intensity bar 542, the lighting intensity bar 542 may include tick marks that indicate each 10% increase in lighting intensity values. After a second swipe to the right across the lighting intensity bar 542, the lighting intensity bar 542 may include tick marks that indicate each 5% increase in lighting intensity values. After a third swipe to the right across the lighting intensity bar 542, the lighting intensity bar 542 may include tick marks that indicate each 1% increase in lighting intensity values. The user interface 500 may continue to provide the coach-mark indication 592a after the user has swiped in the first direction to indicate that the user may continue to swipe in the first direction to provide a higher-resolution state of the lighting intensity bar 542.

In response to the user entering the fine-tuning mode and swiping in the first direction on the lighting intensity bar 542, the higher-resolution state of the lighting intensity bar 542 may provide a zoomed-in sub-portion of the lighting intensity bar 542 as shown in FIGS. 5M and 5N for example. Each resolution state of the lighting intensity bar 542 may correspond to a predefined sub-portion that defines a percentage of the lighting intensity bar 542 to be provided above and/or below the current lighting intensity value (e.g., indicated by the control line 537). For example, with each swipe to the right on the lighting intensity bar 542, the control interface 550 may display additional tick marks and zoom in closer to the current lighting intensity value that is selected at the time the user performs the swipe. Each time the user swipes in the first direction, the zoomed-in view of the lighting intensity bar 542 may show a smaller predefined lighting intensity range above the control line 537 and a smaller predefined lighting intensity range below the control line 537. The zoomed-in resolution states of the lighting intensity bar may allow the lighting intensity bar 542 to occupy the same space in the user interface 500, but allow for a greater distance between each lighting intensity value for finer adjustments to be made to the lighting intensity values within the same distance on the user interface. The zoomed-in sub-portion of the lighting intensity bar 542 may allow for more gradual changes in the intensity of the lighting load in response to changes in the control line 537 over the same distance as a zoomed-out view of the lighting intensity bar 542. A lower-resolution state that has a zoomed out view may allow for more rapid or larger changes in the intensity of the lighting load in response to changes in the control line 537 over the same distance on the light intensity bar, as compared to a higher-resolution state. In other words, for a given defined movement by a user in each of the lighting intensity bars 542 as shown in FIGS. 5A, 5M, and 5N for example, the resulting change in intensity level will be different in each interface, with the lighting intensity change being less in lighting intensity bar 542 of FIG. 5N as compared to lighting intensity bar 542 of FIG. 5M and similarly lighting intensity bar 542 of FIG. 5B. As the control line 537 of the lighting intensity bar 542 is moved up or down, additional lighting intensity values may be displayed, such that the lighting intensity bar is displaying a total predefined range of lighting intensity values for the resolution state. When a higher or lower resolution state is selected resulting in a zoomed-in or zoomed-out view of the lighting intensity bar 542, the control interface may update the lighting intensity bar 542 to include values that center around the control line 537. For example, the lighting intensity bar 542 may be displayed with a predefined range of lighting intensity values above and below the control line 537. If the predefined range of lighting intensity values are not available above or below the control line 537 due to the range meeting a low-end (e.g., 0%) or high-end (e.g., 100%) lighting intensity, the control interface 550 may start at the low-end or high-end intensity and display the total predefined range for the resolution state.

A higher-resolution state allows for more gradual changes in the intensity of the lighting load in response to changes in the control line 537 over the same distance of the lighting intensity bar 542, as compared to a lower-resolution state. A lower-resolution state may allow for more rapid changes in the intensity of the lighting load in response to changes in the control line 537 over the same distance on the lighting intensity bar 542, as compared to a higher-resolution state. For example, referring to FIG. 5M, the control interface 550 may receive a user input that causes the control interface 550 to move the control line 537 in the lighting intensity bar 542 from a first lighting intensity value (e.g., 40%) to a second lighting intensity value (e.g., 50%). The input may be a selection of the second lighting intensity value (e.g., 50%) or a selection of the control line 537 at the first lighting intensity value (e.g., 40%) and dragging the control line 537 to a second lighting intensity value (e.g., 50%). The control line 537 may be moved a distance 555 on the lighting intensity bar 542 to reflect the change in the lighting intensity value from the first lighting intensity value (e.g., 40%) to the second lighting intensity value (e.g., 40%). Referring now to FIG. 5N, the control interface 550 may receive a user input that causes the control interface 550 to move the control line 537 in the lighting intensity bar 542 by the same distance 555. However, as the lighting intensity bar is being displayed in a higher-resolution state the range of lighting intensity values over which the lighting loads in the zone are being configured to be controlled may be relatively smaller. For example, in the higher-resolution state of the lighting intensity bar 542 shown in FIG. 5N, the movement of the control line 537 over the distance 555 may control the lighting intensity from a first lighting intensity value (e.g., 61%) to a second lighting intensity value (e.g., 64%) that comprises a relatively smaller range of lighting intensity values. In fact, the user may move the control line 537 a larger distance than the distance 555 on the lighting intensity bar 542 at the higher-resolution state shown in FIG. 5N and still control the lighting loads in the zone within a smaller range of lighting intensity values than if the user moved the control line 537 the distance 555 on the lighting intensity bar 542 at the lower-resolution state shown in FIG. 5M.

The user may be able to maintain visual contact with the lighting control devices in the zone as the lighting intensity value is changed in the higher-resolution state and visually identify more subtle changes that result in the user environment as a result of more subtle changes in the lighting intensity value within the lighting intensity bar 542 to enable the user to set (e.g., save) a more precise lighting intensity value for the zone in a given scene.

As shown in FIG. 5N, the user may swipe in a second direction (e.g., swipe to the left) across the lighting intensity bar 542 to activate a lower-resolution state of the lighting intensity bar 542. The user interface 500 may include a coach-mark indication 592b that indicates to the user that the user has swiped in the second direction to display a lower-resolution state and/or can swipe in the second direction (e.g., “Swipe Left”) to display a lower-resolution state that is available. For example, after the user swipes in the second direction on the interface of FIG. 5N, the user interface 500 may provide the coach-mark indication 592b to indicate that additional lower-resolution states are available to the user, with a subsequent swipe left resulting in a lower resolution state. The coach-mark indication 592b may also, or alternatively, be displayed when the user has reached the highest resolution state of the lighting intensity bar 542 or when a higher-resolution state is unavailable, in which case a swipe left may move to a lower resolution state. The coach-mark indication 592b may be overlaid on top of the lighting intensity bar 542 to indicate that the user can swipe in the second direction to provide a lower-resolution state of the lighting intensity bar 542.

Each swipe in the second direction may revert the lighting intensity bar 542 to a lower-resolution state that includes predefined tick marks for indicating a corresponding resolution. For example, after a first swipe to the left across the lighting intensity bar 542, the lighting intensity bar 542 may include tick marks that indicate each 5% increase in lighting intensity values. After a second swipe to the left across the lighting intensity bar 542, the lighting intensity bar 542 may include tick marks that indicate each 10% increase in lighting intensity values. After a third swipe left across the lighting intensity bar 542, the lighting intensity bar 542 may remove each of the tick marks or otherwise revert to an original resolution state of the lighting intensity bar 542. Each resolution state may provide a different display in the lighting intensity bar 542 and/or a different type of control. For example, the resolution of the incremental steps for control may change as the resolution state changes. The resolution state of the lighting intensity bar 542 shown in FIG. 5B may allow the user to control the lighting intensity value in 10% increments, the higher-resolution state of the lighting intensity bar 542 shown in FIG. 5M may allow the user to control the lighting intensity value in 5% increments, and the higher-resolution state of the lighting intensity bar 542 shown in FIG. 5N may allow the user to control the lighting intensity value in 1% increments. The user interface 500 may continue to provide the coach-mark indication 592b after the user has swiped in the second direction to indicate that the user may continue to swipe in the second direction to provide a lower-resolution state of the lighting intensity bar 542. As an alternative, upon reaching the highest resolution state, such as shown in FIG. 5N, a swipe in the second direction may return the user to an original resolution state of the lighting intensity bar 542, such as shown in FIG. 5B.

In response to the user swiping in the second direction on the lighting intensity bar 542, the lower-resolution state of the lighting intensity bar 542 may provide a zoomed-out sub-portion of the lighting intensity bar 542. Each resolution state of the lighting intensity bar 542 may correspond to a predefined sub-portion that defines a percentage of the lighting intensity bar 542 to be provided above and/or below the current lighting intensity value (e.g., indicated by the control line 537). For example, with each swipe to the left on the lighting intensity bar 542, the control interface 550 may display fewer tick marks and zoom out further from the current lighting intensity value that is selected at the time the user performs the swipe. Each time the user swipes in the second direction, the zoomed-out view of the lighting intensity bar 542 may show a larger predefined lighting intensity range above the control line 537 and a larger predefined lighting intensity range below the control line 537. The zoomed-out resolution states of the lighting intensity bar may allow the lighting intensity bar 542 to occupy the same space in the user interface 500, and allow for a smaller distance between each lighting intensity increment for faster adjustments to be made to the lighting intensity value within the same distance on the user interface. In other words, for a given defined movement by a user in each of the lighting intensity bars 542 as shown in FIGS. 5B, 5M, and 5N for example, the resulting change in intensity level will be different in each interface, with the lighting intensity change being more in lighting intensity bar 542 of FIG. 5B as compared to lighting intensity bar 542 of FIG. 5M and similarly lighting intensity bar 542 of FIG. 5N for the same movement in control line 537.

As shown in FIGS. 5M and 5N, the lighting intensity bar 542 may be in a higher-resolution state that may be zoomed in such that the user may be unable to see the entire range of values in the lighting intensity bar 542. For example, a high-end portion and/or a low-end portion of the lighting intensity bar 542 may be outside of the current view of the user. If the control line 537 reaches the high-end or low-end, or a predefined distance from the high-end or the low-end, of the current view of the lighting intensity bar 542, the control interface 550 may change to enable the user to continue to provide control across the entire range of the lighting intensity bar 542. For example, the range of values displayed in the lighting intensity bar 542 may scroll up or down (e.g., when the location of the control line 537 is a predefined distance from the high-end or low-end, respectively, of the lighting intensity bar 542).

Referring again to FIG. 5B, the graphical user interface 500 displayed by the control/configuration application may be updated to display different resolutions of color temperature on the color temperature bar 540 for configuration and/or control of the zones in a scene on the network device. The color temperature bar 540 may include indications of color temperature values at 2000K, 3000K, 4000K, and 5000K, or other values as a default. For example, the user may actuate the color temperature bar 540 for a period of time to put the color temperature bar 540 into a fine-tuning mode and thus to change a resolution state of the color temperature bar 540, as similarly described above for the lighting intensity bar 542. The control interface 550 shown in FIG. 5B may be updated as shown in FIG. 5O in response to the actuation of the color temperature bar 540 (e.g., holding down on the color temperature bar 540 for a period of time, swiping right, pinching fingers to expand, etc.). As shown in FIG. 5O, the color temperature bar 540 may be updated to show a different resolution state of the color temperature bar 540. The color temperature bar 540 may be updated to display different resolution states to allow for more granular changes in color temperature or faster changes in color temperature. A higher-resolution state may allow for more gradual changes in the color temperature of the lighting load in response to changes in the actuator 538 over the same distance on the color temperature bar 540, as compared to a lower-resolution state. A lower-resolution state may allow for more rapid changes in the color temperature of the lighting load in response to changes in the actuator 538 on the color temperature bar 540, as compared to a higher-resolution state.

As indicated, the user may actuate the color temperature bar 540 (e.g., press and hold anywhere on the color temperature bar 540 for a predefined period of time, swipe across the color temperature bar 540, etc.) to cause the graphical user interface 500 to provide a fine-tuning mode that provides the user with a higher-resolution state or a lower-resolution state of the color temperature bar 540. The higher-resolution state , as compared to FIG. 5 for example, of the color temperature bar 540 the user may be allowed to more precisely select or identify the color temperature value for a zone. The higher-resolution state may allow a user to identify the difference in more precise changes in the color temperature value of a zone in real time as adjustments are being made to the color temperature values of the zone in the space. The user may be able to maintain visual contact with the lighting control devices in the zone as the color temperature value is changed and visually identify more subtle changes that result in the user environment as a result of more subtle changes in the color temperature value within the color temperature bar 540 to enable the user to set (e.g., save) a more precise color temperature bar 540 for the zones in a given scene.

After entering the fine-tuning mode of FIG. 5O and providing the user with a finer resolution as compared to that shown in FIG. 5B, for example, the user may swipe in a first direction (e.g., swipes to the right) across the color temperature bar 540. In response to the user swiping in the first direction, tick marks may be displayed on the color temperature bar 540 to more precisely indicate color temperature values, such as shown by color temperature bar 540 of FIG. 5P. The tick marks at the higher-resolution states may be indicate lower-percentage changes in the color temperature than at lower-resolution states. For example, a lower-resolution state of the color temperature bar 540 may provide tick marks at each 500K change in color temperature, while a higher-resolution state of the color temperature bar 540 may include tick marks at each 100K change in color temperature. Each of the color temperature bars 540 of FIG. 5B, FIG. 5O, and FIG. 5P may allow a user to adjust the color temperature in a zone at the same increment level (e.g., 1 degree). However, the resolution state of the color temperature bar 540 of FIG. 5B may make such fine adjustments difficult, while the resolution state of the color temperature bar 540 of FIG. 5O may make this easier, and the resolution state of the color temperature bar 540 of FIG. 5P may make this yet easier. Each resolution state may provide a different display in the color temperature bar 540 and/or a different type of control. For example, the resolution of the incremental steps for control may change as the resolution state changes. The resolution state of the color temperature bar 540 shown in FIG. 5B may allow the user to control the color temperature value in 2500K increments, the higher-resolution state of the color temperature bar 540 shown in FIG. 5O may allow the user to control the color temperature value in 1000K increments, and the higher-resolution state of the color temperature bar 540 shown in FIG. 5P may allow the user to control the color temperature value in 500K increments. In general, a user may move between the different resolution states (e.g., via actuations, such as swipes, of the color temperature bar 540) depending on the user's desired precision in setting a given color temperature.

A higher-resolution state allows for more gradual changes in the color temperature of the lighting load in response to changes in the actuator 538 over the same distance of the color temperature bar 540, as compared to a lower-resolution state. A lower-resolution state may allow for more rapid changes in the color temperature of the lighting load in response to changes in the actuator 538 over the same distance on the color temperature bar 540, as compared to a higher-resolution state. For example, referring to FIG. 5O, the control interface 550 may receive a user input that causes the control interface 550 to move the actuator 538 in the color temperature bar 540 from a first color temperature value (e.g., 4000K) to a second color temperature value (e.g., 3300K). The input may be a selection of the second color temperature value (e.g., 3300K) or a selection of the actuator 538 at the first color temperature value (e.g., 4000K) and dragging the actuator 538 to the second color temperature value (e.g., 3300K). The actuator 538 may be moved a distance 557 on the color temperature bar 540 to reflect the change in the color temperature value from the first color temperature value (e.g., 4000K) to the second color temperature value (e.g., 3300K). Referring now to FIG. 5P, the control interface 550 may receive a user input that causes the control interface 550 to move the actuator 538 in the color temperature bar 540 by the same distance 557. However, as the actuator 538 is being displayed in a higher-resolution state the range of color temperature values over which the lighting loads in the zone are being configured to be controlled may be relatively smaller. For example, in the higher-resolution state of the color temperature bar 540 shown in FIG. 5P, the movement of the actuator 538 over the distance 557 may control the color temperature from a first color temperature value (e.g., 4000K) to a second color temperature value (e.g., 3600K) that comprises a relatively smaller range of color temperature values. In fact, the user may move the actuator 538 a larger distance than the distance 557 on the color temperature bar 540 at the higher-resolution state shown in FIG. 5P and still control the lighting loads in the zone within a smaller range of color temperature values than if the user moved the actuator 538 the distance 557 on the color temperature bar 540 at the lower-resolution state shown in FIG. 5O.

The user may be able to maintain visual contact with the lighting control devices in the zone as the color temperature value is changed in the higher-resolution state and visually identify more subtle changes that result in the user environment as a result of more subtle changes in the color temperature value within the color temperature bar 540 to enable the user to set (e.g., save) a more precise color temperature settings for the zone in a given scene.

The graphical user interface 500 may also overlay a coach-mark indications 592a, 592b on top of the color temperature bar 540, as shown in FIG. 5O and FIG. 5P and as similarly described herein for the lighting intensity bar 542. The coach-mark indications 592a, 592b may indicate that the user can swipe to display a higher-resolution state or lower-resolution state, respectively. The user may swipe in a first direction (e.g., swipes to the right) across the color temperature bar 540 to activate a higher-resolution state of the color temperature bar 540, as illustrated in FIG. 5O. In response to the user swiping in the first direction, tick marks may be displayed on the color temperature bar 540 to more precisely indicate color temperature values such as shown by color temperature bar 540 of FIG. 5P.

As described herein, there may be multiple resolution states that may be provided as the user continues to swipe in a given direction. For example, there may be multiple higher-resolution states that may be displayed as the user continues to swipe in the first direction (e.g., swipe to the right) across the color temperature bar 540. In response to each user swipe in the first direction, additional tick marks may be displayed on the color temperature bar 540 and/or may correspond to a different state of the color temperature bar 540. Similarly, the user may swipe in a second direction (e.g., swipe to the left) across the color temperature bar 540 to activate a lower-resolution state of the color temperature bar 540. And, as described herein, tick marks may be removed from the color temperature bar 540 response to the user swiping in the second direction. Further, the color temperature bar 540 may display fewer tick marks between the color temperature values with each swipe in the second direction. As an alternative, upon reaching the highest resolution state, such as shown in FIG. 5P, a swipe in the second direction may return the user to an original resolution state of the color temperature bar 540, such as shown in FIG. 5B.

In response to the user swiping in the second direction on the color temperature bar 540, the lower-resolution state of the color temperature bar 540 may provide a zoomed-out sub-portion of the color temperature bar 540. Each resolution state of the color temperature bar 540 may correspond to a predefined sub-portion that defines a percentage of the color temperature bar 540 to be provided above and/or below the current color temperature value (e.g., indicated by the actuator 538). For example, with each swipe to the left on the color temperature bar 540, the control interface 550 may display fewer tick marks and zoom out further from the current color temperature value that is selected at the time the user performs the swipe. The zoomed-in sub-portion of the color temperature bar 540 may allow for more gradual changes in the intensity of the lighting load in response to changes in the actuator 538 over the same distance as a zoomed-out view of the color temperature bar 540. A lower-resolution state that has a zoomed out view may allow for more rapid changes in the color temperature of the lighting load in response to changes in the actuator over the same distance on the light intensity bar, as compared to a higher-resolution state.

As shown in FIGS. 5O and 5P, and as described herein for lighting intensity bar 542, the color temperature bar 540 may be in a higher-resolution state that may be zoomed in such that the user may be unable to see the entire range of values in the color temperature bar 540 (e.g., as shown in FIG. 5P). For example, a high-end portion and/or a low-end portion of the color temperature bar 540 may be outside of the current view of the user. If the actuator 538 reaches the high-end or low-end, or a predefined distance from the high-end or the low-end, of the current view of the color temperature bar 540, the control interface 550 may change to enable the user to continue to provide control across the entire range of the color temperature bar 540. For example, the range of values displayed in the color temperature bar 540 may scroll up or down (e.g., when the location of the actuator 538 is a predefined distance from the high-end or low-end, respectively, of the color temperature bar 540). Overall and as similarly described for or lighting intensity bar 542, for a given defined movement by a user in each of the color temperature bars 540 as shown in FIGS. 5B, 50, and 5P for example, the resulting change in color temperature will be different in each interface, with the color temperature change being less in color temperature bar 540 of FIG. 5P as compared to color temperature bar 540 of FIG. 5O and similarly color temperature bar 540 of FIG. 5B.

As described herein, the control/configuration application may adjust the graphical user interface's display based on the screen size of the network device. For example, FIGS. 5Q, 5R, and 5S illustrate an example graphical user interface 590 that may be displayed by the control/configuration application when the display of network device is smaller (e.g., smaller than that display of the network device that displays the graphical user interface 500). Further, as the display of the network device that displays the graphical user interface is smaller, the graphical user interface may allow a user to configure a single setting, rather than simultaneously configure multiple settings. For example, the user interface 590 may separately display the lighting intensity settings and the color temperature/full color settings for configuration and/or control. The user may similarly control and/or configure the zones in the scene using the graphical user interface 590. For example, the user may actuate the lighting intensity bar 542 (e.g., press and hold anywhere on the lighting intensity bar 542 for a predefined period of time, swipe across the lighting intensity bar 542, or otherwise actuate the lighting intensity bar 542) to cause the graphical user interface 590 to provide a fine-tuning mode that provides the user with a higher-resolution state or a lower-resolution state of the lighting intensity bar 542.

As shown in FIGS. 5Q, 5R, and 5S, the graphical user interface 590 may be used to control the lighting intensity of the one or more lighting control devices assigned to a respective zone. Similar to the graphical user interface 500 described herein, the user may swipe across the lighting intensity bar 542 to adjust the resolution state of the lighting intensity bar 542. For example, in response to a continued actuation of the lighting intensity bar 542, tick marks may be displayed on the lighting intensity bar 542 to more precisely indicate lighting intensity values, as illustrated in FIGS. 5Q-5S.

The graphical user interface 590 may also overlay the coach-mark indications 592a, 592b on top of the lighting intensity bar 542. The coach-mark indications 592a, 592b may indicate that the user can swipe to display a higher-resolution state or lower-resolution state, respectively. As described herein, the higher-resolution state may provide tick marks for lower-percentage changes in the lighting intensity than at lower-resolution states. Similarly, the lower-resolution state may provide tick marks for higher-percentage changes in the lighting intensity than at higher-resolution states.

Although not shown, the control/configuration application may adjust the graphical user interface's display to configure the color temperature values based on the screen size of the network device. For example, the control/configuration application may adjust the graphical user interface for configuration of the color temperature values in a manner similar to the graphical user interface 590 described in FIGS. 5Q, 5R, and 5S and as describe herein in FIGS. 5B, 50 and 5P. Similar to the examples described in FIGS. 5Q, 5R, and 5S, the graphical user interface may display a control interface that includes the color temperature bar 540. Further, a user may actuate the color temperature bar 540 (e.g., press and hold anywhere on the color temperature bar 540, swipe across the color temperature bar 540, or otherwise actuate the color temperature bar 540) to cause the graphical user interface 500 to provide a fine-tuning mode that provides the user with a higher-resolution state or a lower-resolution state of the color temperature bar 540 as described herein in FIGS. 5B, 5O and 5P.

FIGS. 5T to 5W provide another example of a fine-tuning mode. For example, FIGS. 5T to 5W illustrate and example graphical user interface 591 that may be displayed by the control/configuration application. The graphical user interface 591 may be displayed in a control interface wider-screen application (e.g., such as the control interface 550 shown in FIG. 5B for example). The graphical user interface 591 may be displayed as an alternative option to the graphical user interface 500, or the configuration may similarly be incorporated into the graphical user interface 500. For example, the configuration of the control interface 580, or portions thereof, may be incorporated into the control interface 500 of the graphical user interface 500.

Referring first to FIG. 5T, the graphical user interface 591 may be configured to display a control interface 580. The control interface 580 may display a tile 510a that may be selected to illustrate the settings for the “Overhead” zone. The control interface 580 may include the “Save to” button 522, the “Flash” button 506, and control type icons 528a, 530 as similarly describe herein. In addition, the control interface 580 may include a lighting intensity bar 542a.

The control interface 580 may be displayed in response to the selection of the control type icon 528a. The lighting intensity bar 542a may be an example of or similar to the lighting intensity bar 542. The lighting intensity bar may be configured to display a perceived lighting intensity levels 593 and measured lighting intensity levels 595. The lighting intensity box 520 may display the perceived lighting intensity levels 593. The human eye responds to lower light levels by enlarging the pupil, allowing more light to enter the eye. This response results in a difference between measured and perceived lighting intensity levels. Relatively smaller changes in measured lighting levels at lower intensity levels (e.g., zero to ten percent for measured lighting intensity levels) may be perceived as relatively larger changes in lighting intensity levels. The perceived lighting intensity level may indicate the lighting intensity level of a given lighting load that is perceived by a user, which may change as the measured lighting intensity levels (e.g., measured in foot-candles) change. The perceived lighting intensity may indicate how bright a given lighting load appears to the users. The measured lighting intensity level may indicate the lighting intensity level of a given lighting load, as measured in foot-candles. The perceived lighting intensity level may be calculated as a function of the measured lighting intensity level. An example, is provided in Equation 1 below:

$$Perceived Light Level ( \% ) = 100 \times \sqrt{\frac{Measured Light ( \% )}{100}} \qquad Equation 1$$

As illustrated in FIG. 5T, the control interface 580 may be configured to a fine-tuning mode to enable finer granularity in the adjustment of the lighting intensity level in the lighting intensity bar 542a. For example, the control interface may be configured to enable finer granularity in the adjustment of the lighting intensity level in the lighting intensity bar 542a via the resolution button 594. The resolution button 594 may be actuated to enable different resolution states for the intensity bar 542a. When actuated to enable a higher-resolution state, the resolution button 594 may enable a user to adjust the lighting intensity level to a finer granularity, for example, by displaying the lighting intensity bar 542a at the higher-resolution state (e.g., similar to the fine-tuning mode described in FIGS. 5M to 5N).

FIG. 5U, for example illustrates an example where the resolution button 594 has been actuated to enable to the higher-resolution state of the lighting intensity bar 542a. The lighting intensity bar 542b may be displayed in response to the actuation of the resolution button 594 at a higher-resolution state than the lighting intensity bar 542a. For example, the lighting intensity bar 542b may be configured to display additional tick marks as compared to the lighting intensity bar 542a that represent additional values and smaller changes in lighting intensity levels. The tick marks in the lighting intensity bar 542b may be included at a lower-percentage changes in the lighting intensity than the resolution state of the lighting intensity bar 542a. The lighting intensity bar 542b may take up a large portion of the control interface 580, as the lighting intensity bar 542b is providing a higher-resolution of control. When actuated, the control interface 580 may also be configured to change the icon associated with the resolution button 594 to indicate that the resolution button 594 has been actuated.

The higher-resolution state of the lighting intensity bar 542b may allow the user to more precisely select or identify the lighting intensity value for a zone. The higher-resolution state may allow a user to identify the difference in more precise changes in the lighting intensity value of a zone in real time as adjustments are being made to the lighting intensity values of the zone in the space. The user may be able to maintain visual contact with the lighting loads in the zone as the lighting intensity value is changed and visually identify more subtle changes that result in the user environment as a result of more subtle changes in the lighting intensity value within the lighting intensity bar 542. The higher-resolution state may enable the user to set (e.g., save) a more precise lighting intensity value for the zone in a given scene. The resolution button 594 may again be actuated to disable the higher-resolution state from being displayed, which may cause the control interface 580 to display the lighting intensity bar 542a having a lower-resolution state. Put differently, the control interface 580 may be configured to transition between displaying the lighting intensity bar 542a and the lighting intensity bar 542b to display different resolution states in response to actuations of the resolution button 594. As described herein, the higher-resolution state allows for more gradual changes in the intensity of the lighting load over a smaller range of intensity values in response to changes in the control line 537 over the same distance of the lighting intensity bar 542a, as compared to a lower-resolution state. A lower-resolution state may allow for more rapid changes in the intensity of the lighting load over a larger range of intensity values in response to changes in the control line 537 over the same distance on the lighting intensity bar 542a, as compared to a higher-resolution state. Once the user has selected an intensity value in either the lighting intensity bar 542a or 542b, the user may select the “Save to” button 522 to save the lighting intensity level to the selected zones for the selected scene. Further, although two different resolution states, the control/configuration application and/or the control interface 580 may be configured to provide any number of resolutions states of the lighting intensity bar. In addition, multiple gestures or actuations may be used to transition between the various resolution states (e.g., actuating the resolution button 594, swiping across the lighting intensity bar, as illustrated in FIGS. 5M to 5S, etc.).

In addition, the higher-resolution state of the lighting intensity bar 542b shown in FIG. 5U may provide a zoomed-in sub-portion of the lighting intensity bar 542a shown in FIG. 5T. As the higher-resolution state is providing more detailed intensity values to the user, only a portion of the intensity values may be displayed. For example, while the lighting intensity bar 542a may provide lighting intensity values from 0% to 100% (in perceived lighting intensity), the lighting intensity bar 542b may provide lighting intensity values from 59% to 81%. The higher-resolution state of the lighting intensity bar 542b may allow the user to make finer adjustments to the lighting intensity levels of lighting loads in response to similar input on the user interface. For example, while the tick marks of the lighting intensity bar 542a indicate 20% increases in the lighting intensity value, the tick marks of the lighting intensity bar 542b indicate 1% increases in the lighting intensity value. The higher-resolution state may allow for finer adjustments as the control line 537 is moved across the user interface. For example, the higher-resolution state allow for more gradual changes in the lighting intensity of the lighting load in response to changes in the control line 537 over the same distance on the lighting intensity bar 542b, as compared to a lower-resolution state. The lower-resolution state may allow for more rapid changes in the lighting intensity of the lighting load in response to changes in the control line 537 over the same distance on the lighting intensity bar 542b, as compared to a higher-resolution state.

FIGS. 5V to 5W illustrate another example of a fine-tuning feature when performing color control. For example, as illustrated in FIG. 5V, the control interface 580 may be configured to display in response to actuation of the control type icon 530 for enabling selection of color settings for a selected zone (e.g., “Clicky Lamp” zone) indicated by the tile 510b. The control interface 580 may be configured to display the color indicator box 524, the full color palette 586a, and the actuator 588 (e.g., when the control type icon 530 is actuated, as described herein). In addition, the control interface 580 may include the resolution button 594 and a picture button 596. The picture button 596 may allow a user to select the color value based on a picture or image. For example, using the picture button 596, a user may capture an image of a given color, and the control/configuration application may configure the color value for the zone based on the image. The resolution button 594 may enable a higher-resolution mode and finer granularity in the adjustment of the color. FIG. 5W illustrates an example of the control interface 580 when the resolution button 594 is actuated to enable the higher-resolution mode. As shown in FIG. 5W, the control interface 580 may be configured to display a full color palette 586b when the resolution button 594 is actuated. The full color palette 586b may be displayed at a higher-resolution state than the full color palette 586a. In addition, the full color palette 586b may be configured to take up a larger portion of the control interface 580 than the full color palette 586a. With the full color palette 586b being displayed at the higher resolution state, the control interface may be configured to enable finer granularity in the adjustment of the full color of a given load. For example, since the full color palette 586b displays a larger portion of the control interface 580, a user may be provided with an increased granularity of selecting the color setter using the actuator 588.

The higher-resolution state of the full color palette 586b may allow the user to more precisely select or identify the color setting for a zone. The higher-resolution state may allow a user to identify the difference in more precise changes in the color value of a zone in real time as adjustments are being made to the color values of the zone in the space. The higher-resolution state of the full color palette 586b may include more colors over a larger surface area for user selection, or the same colors over a larger surface area. The higher-resolution state of the full color palette 586b may include a zoomed-in sub-portion of the lower-resolution state of the full color palette 586a. For example, a portion of the colors may be displayed that surround the actuator 588 (e.g., a predefined area around the actuator 588). The user may be able to maintain visual contact with the lighting loads in the zone as the color value is changed and visually identify more subtle changes that result in the user environment as a result of more subtle changes in the color value within the full color palette 586b to enable the user to set (e.g., save) a more precise color value for the zone in a given scene. The resolution button 594 may again be actuated to enable a lower-resolution mode, which may cause the control interface 580 to display the full color palate 586a. Put differently, the control interface 580 may be configured to transition between displaying the full color palette 586a and the full color palette 586b in response to actuations of the resolution button 594.

A higher-resolution state allows for more gradual changes in the full color values of the lighting load in response to changes in the actuator 588 over the same distance of the full color palette 586a, as compared to a lower-resolution state. A lower-resolution state may allow for more rapid changes in the full color values of the lighting load in response to changes in the actuator 588 over the same distance on the full color palette 586a, as compared to a higher-resolution state. For example, referring to FIG. 5V, the control interface 580 may receive a user input that causes the control interface 580 to move the actuator 588 in the full color palette 586a from a first full color value on the x-axis or the y-axis to a second full color value. The first full color value and the second full color value may be indicated as a different value on one of the x-axis or the y-axis, or on both the x-axis and the y-axis, of the full color gamut. The input may be a selection of the second full color value or a selection of the actuator 588 at the first full color value and dragging the actuator 588 to the second full color value. The actuator 588 may be moved a distance on the full color palette 586a to reflect the change in the color value from the first full color value to the second full color value. Referring now to FIG. 5W, the control interface 580 may receive a user input that causes the control interface 580 to move the actuator 588 in the full color palette 586a by the same distance. However, as the actuator 588 is being displayed in a higher-resolution state the range of full color values over which the lighting loads in the zone are being configured to be controlled may be relatively smaller. For example, in the higher-resolution state of the full color palette 586a shown in FIG. 5W, the movement of the actuator 588 in a distance on at least one of the x-axis or the y-axis may control the full color value from a first full color value to a second full color value that comprises a relatively smaller range of full color values.

Once the user has selected a color setting in either the full color palette 586a or 586b, the user may select the “Save to” button 522 to save the color setting to the selected zones for the scene. Further, although two different resolution states are described for selecting color settings for a scene, the control/configuration application and/or the control interface 580 may be configured to provide any number of resolutions states of the full color palette. In addition, multiple gestures or actuations may be used to transition between the various resolution states (e.g., actuating the resolution button 594, swiping across the full color palette, as illustrated in FIGS. 5M to 5S, etc.).

Different resolution states may similarly be displayed for a color temperature bar, such as the color temperature bar 540, in response to actuations of a resolution button. For example, an actuation of a button may cause the color temperature bar to be displayed in a higher-resolution state that includes additional tick marks for additional color temperature values. The color temperature bar may also be displayed over a larger portion of the user interface in the higher-resolution state. The resolution button may be selected to return the color temperature bar to a lower resolution state.

Referring again to FIG. 5B, the control interface 550 may enable finer granularity in the adjustment of the lighting intensity level in the lighting intensity bar 542. For example, the user may select the actuator button 548 to enable finer granularity adjustment in the lighting intensity bar 542. As shown in FIG. 5X, the lighting intensity bar 542 may display fine-tune adjustment buttons 597a, 597b after user selection of the actuator button 548. As illustrated herein, the control interface may display fine-tune adjustment buttons 597a, 597b next to or within a predefined portion of the lighting intensity bar 542. And, as described herein, a user may actuate the fine-tune adjustment buttons 597a, 597b to respectively increase or decrease the lighting intensity of the zone a predefined intensity value. For example, actuations of the fine-tune adjustment buttons 597a, 597b may allow the user to more easily perform more precise or granular selections of the lighting level, which may be reflected in the lighting intensity bar 542 and/or the lighting intensity box 520. The fine-tune adjustment buttons 597a, 597b may respectively be used to increase or decrease the lighting intensity value for the selected zone. For example, a user may actuate or tap fine-tune adjustment button 597a to increase the lighting intensity by a predefined percentage (e.g., 1%, 3%, 5%, etc.). Similarly, a user may actuate or tap fine-tune adjustment button 597b to decrease the lighting intensity by a predefined percentage (e.g., 1%, 3%, 5%, etc.). Also, or alternatively, the user may hold fine-tune adjustment buttons 597a, 597b to continuously increase or decrease the lighting intensity, respectively. The predefined percentage by which the lighting intensity may be increased or decreased by the fine-tune adjustment buttons 597a, 597b may correspond to the resolution state at which the lighting intensity is being displayed, as described herein with respect to FIGS. 5M to 5N. For example, the fine-tune adjustment buttons 597a, 597b may increase or decrease the lighting intensity by a smaller amount (e.g., 1%) when the lighting intensity bar 542 is at a higher-resolution state. The actuators 597a, 597b may increase or decrease the lighting intensity by a larger amount (e.g., 5%) when the lighting intensity bar 542 is at a lower-resolution state. Although not shown, the ability to perform finer granularity adjustments using the actuators 597a, 597b and the ability to adjust the resolution states of the lighting intensity bar 542 and the color temperature bar 540, may also be available when the “Master Control” button 508 is selected.

The graphical user interface 500 may display vibrancy controls in the control interface 550 for selecting the vibrancy settings for one or more zones in a given scene. As described herein, a user may tune the individual colors that make light at a given color (e.g., full color or CCT) by adjusting the vibrancy settings of a given zone, which may affect the light reflected off of objects in the space and/or the SPD of the light. A respective lighting load may be configured to one of two states or modes with respect to vibrancy: an auto vibrancy state/mode, and/or an adjustable state/mode (e.g., the user may manually select the vibrancy level). As described herein, the control type icon 532 may be selected to configure the vibrancy settings for a zone. As a result, the vibrancy controls and/or settings for one or more zones may be displayed after selecting the control type icon 532.

Referring now to FIG. 5Y, the control interface 550 may include an “Auto/Manual” actuator 589. If, for example, the “Auto/Manual” actuator 589 is set to “Manual,” as illustrated in FIG. 5Y, the lighting devices in the zone may be configured to the adjustable vibrancy state/mode and the control interface 550 may include a vibrancy bar 598, which may provide the user with the ability to manually adjust vibrancy levels. As shown, the vibrancy bar 598 may be displayed with the lighting intensity bar 542. The vibrancy bar 598 may further include a moveable control line 595, which may be used like the lighting intensity bar 542 and the moveable control line 537. For example, a user may select a location within the vibrancy bar 598 and the network device may move the control line 3842 to the selected location within the vibrancy bar 598 to indicate the selected vibrancy. Also, or alternatively, the user may select the control line 595 itself and move the control line 595 to indicate the selected vibrancy within the vibrancy bar 598 or enter a value in box 599.

In general, increasing/decreasing vibrancy may increase/decrease the apparent saturation of the color of objects in the space without changing (or substantially without changing) the color point of the lighting load. Vibrancy may be enabled for lighter or less saturated colors (e.g., colors towards the right side of the full color palette 586, towards the black body curve). For example, the effect produced by adjusting the vibrancy via the control line 595 may decrease as the color saturation increases. The vibrancy may be disabled, or less controllable, for more saturated colors (e.g., colors toward the left side of the full color palette 586). For example, as the selected color point on the full color palette 586 becomes more saturated (e.g., toward the left of the full color palette 586, away from the black body curve), flexibility in changing the color mixing of RGBW LEDs, for example, to increase vibrancy while maintaining the desired color point may be reduced, as there may be fewer color mixing options of the RGBW LEDs to achieve the desired color or CCT.

Moving the control line 595 upwards along the vibrancy bar 598 may increase the vibrancy of the lighting loads in a zone for a selected color. As described herein, the lighting loads may be RGBW lighting loads, although one of ordinary skill in the art will understand that the concepts disclosed herein may be applicable to lighting loads with at least four LEDs having different spectra. As the vibrancy of a lighting load is increased, the contribution of the white, or substantially white, LED(s) (e.g., yellow and/or mint green LED) of the lighting load in a zone may decrease (e.g., given a certain color point and/or CCT), while increasing one or more of the RGB LEDs to maintain the color point while increasing saturation. Similarly, moving control line 595 downwards along the vibrancy bar 598 may decrease the vibrancy of the lighting loads in a zone. In addition, as the vibrancy of the lighting loads is decreased, the contribution of the white, or substantially white, LED(s) of the lighting loads in the zone may increase (e.g., given a certain color point of CCT) and correspondingly decreasing the intensity of one or more of the RGB LEDs. The user may select a color point for a lighting load (using color temperature bar 540 or full color bar 540a) and adjust the vibrancy of the lighting load (e.g., by moving the control line 595 along the vibrancy bar 598) at the selected color point. Also or alternatively, the user may select the vibrancy of a lighting load and adjust the color point of the lighting load given the selected vibrancy.

Although not shown in FIG. 5Y, the “Auto/Manual” actuator 589 may be set to “Auto.” When the “Auto/Manual” actuator 589 is set to “Auto,” the lighting devices in the zone may be configured to the auto vibrancy state/mode and the control/configuration application may automatically configure the CRI value of the lighting loads for the zone based on the selected color. The control/configuration application may automatically configure the CRI value of the zone such that the CRI values of the light emitted in the zone is optimized (e.g., optimizing the CRI value towards or above a threshold CRI value based on the desired color). For example, the control applicant may adjust the CRI value of the zone such the CRI value of the emitted light is optimized towards or above a threshold CRI value. In certain instances (e.g., for certain color point or CCT) the CRI value may be unable to be a value that is greater than or equal to the CRI threshold value. In those instances, the “Auto/Manual” actuator 589 being set to “Auto,” may cause the lighting loads to increase the CRI value towards (e.g., as close as possible to) the CRI threshold value.

As described herein, in certain scenarios, increasing the CRI value to be greater than or equal to the CRI threshold value (e.g., setting “Auto/Manual” actuator 589 to “Auto”) may automatically change the vibrancy. As a result, when the “Auto/Manual” actuator 589 is “Auto” the vibrancy of the lighting loads in a zone may automatically increase and/or decrease, which may be reflected in the control line 595 along the vibrancy bar 598 being automatically moved. In addition, when the “Auto/Manual” actuator 589 to “Auto”, the vibrancy of the lighting loads may be automatically determined and/or may be unconfigurable by the user. For example, the control line 595 and vibrancy bar 598 may be disabled (e.g. grayed out and/or non-configurable) when the “Auto/Manual” actuator 589 is set to “Auto,” and may be enabled (as shown in FIG. 5Y) when the “Auto/Manual” actuator 589 is set to “Manual”. However, when the “Auto/Manual” actuator 589 is “Auto” and vibrancy control is disabled to the user, the control line 595 may still be moved along across the vibrancy bar 598 by the control/configuration application to indicate the automatically selected vibrancy level based on the determined CRI value.

The user may adjust the color or CCT of the lighting loads in a zone while the Auto/Manual” actuator 589 to “Auto”, for example. As the user adjusts the color or CCT value, the Auto/Manual” actuator 589 being “Auto” may automatically adjust vibrancy of lighting loads based on the determined CRI value. In addition, as described herein, the “Auto/Manual” actuator 589 being set to “Auto” may cause the CRI of the lighting loads to be increased to a value greater than or equal to the CRI threshold value as the user adjusts the color point.

As described herein, each scene may be comprised of zones of lighting control devices that have different lighting capabilities (e.g., lighting intensity dimming, color temperature control, full color control, vibrancy control, etc.). The control/configuration application executing on the lighting control device may identify the lighting capabilities of different lighting control devices and provide different control types for configuration based on the lighting capabilities of the lighting control devices in the zones being configured.

Referring now to FIG. 5Z, the graphical user interface 500 may dynamically adjust based on the lighting capabilities (e.g., lighting intensity dimming, color temperature control, full color control, vibrancy control, etc.) of the lighting control devices that are being configured. For example, the control interface 550 in the graphical user interface 500 may display the control types for configuration that are applicable to the lighting control devices in the selected zones. For example, the control interface 550 shown in FIG. 5Z provides the control type icon 536 as the single control type that may be configured for the selected zone being configured. The zone may include lighting control devices that have the capability of transitioning to an on state or an off state, but that may be incapable of controlling lighting intensity, color temperature, full color, vibrancy, or other lighting capabilities. The control interface 550 may include an actuator 547, which may be similar to and function like the actuator 424 described in FIG. 4B. For example, a user may toggle the actuator 547 to transition the lighting control devices in a zone to an on state or to an off state when the scene is configured.

Because the lighting control devices that are being configure have limited capabilities (e.g., capable of transitioning to an on state or an off state), the control interface 550 may omit control type icons 528, 530, 532, 534 that correspond to other lighting capabilities. As described herein, the control type icon 536 may be selected to configure the delay (e.g., the period of time after which the zone begins the transition to the setting defined by the scene) for a zone. Accordingly, when the control type icon 536 is selected the control interface 550 may further include time bar 503. And a user my adjust the time bar 503 to configure the delay for the zone, for example, by scrolling through the values on the time bar 503 to input the desired number of hours, minutes, and/or seconds of delay. The control interface 550 may be similarly updated to include other control type icons that correspond to the capabilities of other types of lighting control devices as they are included in one or more zones being configured. For example, the control type icon 528 may be displayed to enable configuration of the color temperature settings (e.g., intensity and/or warm/cool color) for a zone when the lighting control devices are capable of controlling color temperature. The control type icon 530 may be displayed to enable configuration of the full color settings (e.g., intensity and/or color) for a zone when the lighting control devices are capable of controlling full color. The control type icon 528a may be displayed to enable configuration of the lighting intensity settings for a zone when the lighting control devices are capable of dimming control.

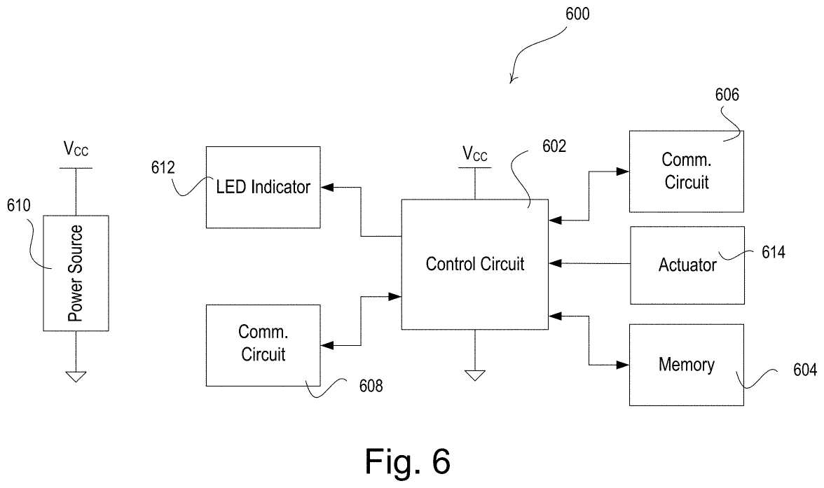

FIG. 6 is a block diagram illustrating another example system controller 600 (such as system controller 150 and 250a/250b, described herein). The system controller 600 may include one or more general purpose processors, special purpose processors, conventional processors, digital signal processors (DSPs), microprocessors, microcontrollers, integrated circuits, programmable logic devices (PLD), field programmable gate arrays (FPGA), application specific integrated circuits (ASICs), or any suitable controller or processing device or the like (hereinafter collectively referred to as processor(s) or control circuit(s) 602). The control circuit 602 may be configured to execute one or more software-based applications that include instructions that when executed by the control circuit may configure the control circuit to perform signal coding, data processing, power control, input/output processing, or any other function, process, and/or operation for example that enables the system controller 600 to perform as described herein. One will recognize that functions, features, processes, and/or operations described herein of the system controller 600 may also and/or alternatively be provided by firmware and/or hardware in addition to and/or as an alternative to software-based instructions. The control circuit 602 may store information in and/or retrieve information from the memory 604, including configuration information/configuration information file(s), backup file(s), creation times, and signature(s) as described herein. Memory 604 may also store software-based instructions for execution by the control circuit 602 and may also provide an execution space as the control circuit executes instructions. Memory 604 may be implemented as an external integrated circuit (IC) or as an internal circuit of the control circuit 602. Memory 604 may include volatile and non-volatile memory modules/devices and may be non-removable memory modules/devices and/or a removable memory modules/devices. Non-removable memory may include random-access memory (RAM), read-only memory (ROM), a hard disk, or any other type of non-removable memory storage. Removable memory may include a subscriber identity module (SIM) card, a memory stick, a memory card, or any other type of removable memory. One will appreciate that the memory used to store configuration information file(s), and/or backup file(s), and/or computer-executable (e.g., software-based) instructions, etc. that may be the same and/or different memory modules/devices of the system controller. As one example, configuration information file(s) and computer-executable (e.g., software-based) instructions may be stored in non-volatile memory modules/devices while backup(s) may be stored in volatile and/or non-volatile memory modules/devices. The computer-executable instructions may be executed by the control circuit 602 to operate as described herein.

The system controller 600 may include one or more communications circuits/network interface devices or cards 606 for transmitting and/or receiving information. The communications circuit 606 may perform wireless and/or wired communications. The system controller 600 may also, or alternatively, include one or more communications circuits/network interface devices/cards 608 for transmitting and/or receiving information. The communications circuit 606 may perform wireless and/or wired communications. Communications circuits 606 and 608 may be in communication with control circuit 602. The communications circuits 606 and/or 608 may include radio frequency (RF) transceivers or other communications modules configured to perform wireless communications via an antenna(s). The communications circuit 606 and communications circuit 608 may be configured to perform communications via the same communication channels or different communication channels. For example, the communications circuit 606 may be configured to communicate (e.g., with a network device, over a network, etc.) via a wireless communication channel (e.g., BLUETOOTH®, near field communication (NFC), WIFI®, WI-MAX®, cellular, etc.) and the communications circuit 608 may be configured to communicate (e.g., with control devices and/or other devices in the load control system) via another wireless communication channel (e.g., WI-FI® or a proprietary communication channel, such as CLEAR CONNECT™).

The control circuit 602 may be in communication with an LED indicator(s) 612 for providing indications to a user. The control circuit 602 may be in communication with an actuator(s) 614 (e.g., one or more buttons) that may be actuated by a user to communicate user selections to the control circuit 602. For example, the actuator 614 may be actuated to put the control circuit 602 in an association mode and/or communicate association messages from the system controller 600.

Each of the modules within the system controller 600 may be powered by a power source 610. The power source 610 may include an AC power supply or DC power supply, for example. The power source 610 may generate a supply voltage Vcc for powering the modules within the system controller 600. One will recognize that system controller 600 may include other, fewer, and/or additional modules.

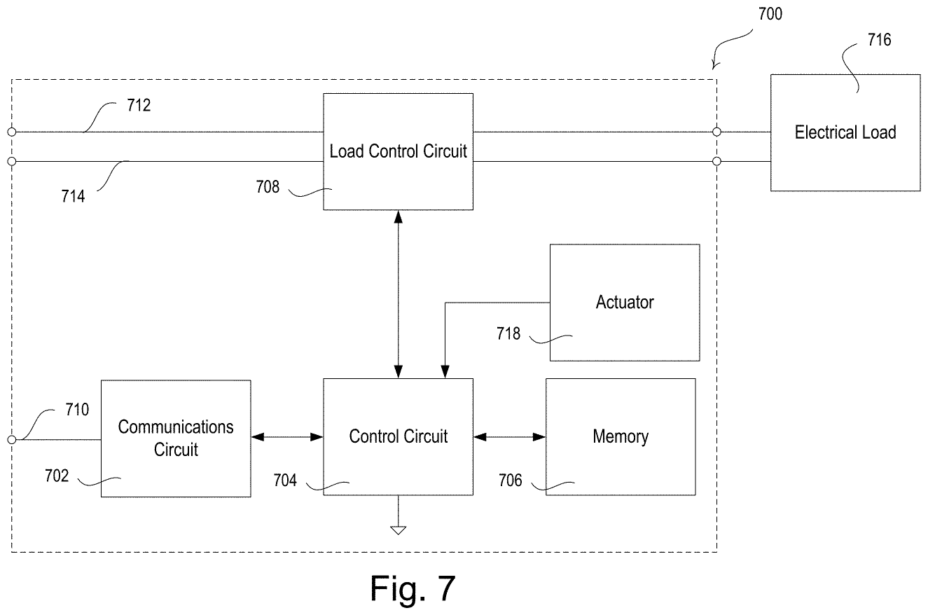

FIG. 7 is a block diagram illustrating an example control-target device 700, e.g., a load control device, as described herein. The control-target device 700 may be a dimmer switch, an electronic switch, an electronic ballast for lamps, an LED driver for LED light sources, an AC plug-in load control device, a temperature control device (e.g., a thermostat), a motor drive unit for a motorized window treatment, or other load control device. The control-target device 700 may include one or more communications circuits/network interface devices or cards 702. The communications circuit 702 may include a receiver, an RF transceiver, and/or other communications module configured to perform wired and/or wireless communications via communications link 710. The control-target device 700 may include one or more general purpose processors, special purpose processors, conventional processors, digital signal processors (DSPs), microprocessors, microcontrollers, integrated circuits, programmable logic devices (PLD), field programmable gate arrays (FPGA), application specific integrated circuits (ASICs), or any suitable controller or processing device or the like (hereinafter collectively referred to as processor(s) or control circuit(s) 704). The control circuit 704 may be configured to execute one or more software-based applications that include instructions that when executed by the control circuit may configure the control circuit to perform signal coding, data processing, power control, input/output processing, or any other function, feature, process, and/or operation for example that enables the control-target device 700 to perform as described herein. One will recognize that functions, features, processes, and/or operations described herein for the control-target device 700 may also and/or alternatively be provided by firmware and/or hardware in addition to and/or as an alternative to software-based instructions. The control circuit 704 may store information in and/or retrieve information from the memory 706. For example, the memory 706 may maintain a registry of associated control devices and/or control configuration information. Memory 706 may also store computer-executable (e.g., software-based) instructions for execution by the control circuit 704 and may also provide an execution space as the control circuit executes instructions. Memory 706 may be implemented as an external integrated circuit (IC) or as an internal circuit of the control circuit 704. Memory 706 may include volatile and non-volatile memory modules/devices and may be non-removable memory modules/devices and/or a removable memory modules/devices. Non-removable memory may include random-access memory (RAM), read-only memory (ROM), a hard disk, or any other type of non-removable memory storage. Removable memory may include a subscriber identity module (SIM) card, a memory stick, a memory card, or any other type of removable memory. The control circuit 704 may also be in communication with the communications circuit 702.

The control-target device 700 may include a load control circuit 708. The load control circuit 708 may receive instructions from the control circuit 704 and may control an electrical load 716 based on the received instructions. The load control circuit 708 may send status feedback to the control circuit 704 regarding the status of the electrical load 716. The load control circuit 708 may receive power via a hot connection 712 and a neutral connection 714 and may provide an amount of power to the electrical load 716. The electrical load 716 may include any type of electrical load.

The control circuit 704 may be in communication with an actuator 718 (e.g., one or more buttons) that may be actuated by a user to communicate user selections to the control circuit 704. For example, the actuator 718 may be actuated to put the control circuit 704 in an association mode or discovery mode and may communicate association messages or discovery messages from the control-target device 700. One will recognize that control-target device 700 may include other, fewer, and/or additional modules.

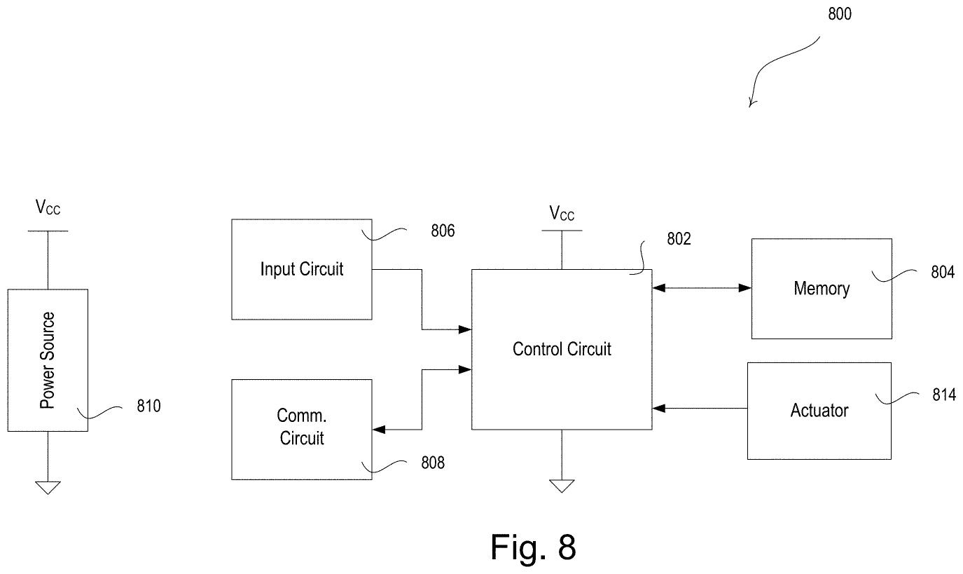

FIG. 8 is a block diagram illustrating an example control-source device 800 as described herein. The control-source device 800 may be a remote control device, an occupancy sensor, a daylight sensor, a window sensor, a temperature sensor, and/or the like. The control-source device 800 may include one or more general purpose processors, special purpose processors, conventional processors, digital signal processors (DSPs), microprocessors, microcontrollers, integrated circuits, programmable logic devices (PLD), field programmable gate arrays (FPGA), application specific integrated circuits (ASICs), or any suitable controller or processing device or the like (hereinafter collectively referred to as processor(s) or control circuit(s) 802). The control circuit 802 may be configured to execute one or more software-based applications that include instructions that when executed by the control circuit may configure the control circuit to perform signal coding, data processing, power control, input/output processing, or any other function, feature, process, and/or operation for example that enables the control-source device 800 to perform as described herein. One will recognize that functions, features, processes, and/or operations described herein for the control-source device 800 may also and/or alternatively be provided by firmware and/or hardware in addition to and/or as an alternative to computer-executable (e.g., software-based) instructions. The control circuit 802 may store information in and/or retrieve information from the memory 804. Memory 804 may also store computer-executable (e.g., software-based) instructions for execution by the control circuit 802 and may also provide an execution space as the control circuit executes instructions. Memory 804 may be implemented as an external integrated circuit (IC) or as an internal circuit of the control circuit 802. Memory 804 may include volatile and non-volatile memory modules/devices and may be non-removable memory modules/devices and/or a removable memory modules/devices. Non-removable memory may include random-access memory (RAM), read-only memory (ROM), a hard disk, or any other type of non-removable memory storage. Removable memory may include a subscriber identity module (SIM) card, a memory stick, a memory card, or any other type of removable memory.

The control-source device 800 may include one or more communications circuits/network interface devices or cards 808 for transmitting and/or receiving information. The communications circuit 808 may transmit and/or receive information via wired and/or wireless communications via communications circuit 808. The communications circuit 808 may include a transmitter, an RF transceiver, and/or other circuit configured to perform wired and/or wireless communications. The communications circuit 808 may be in communication with control circuit 802 for transmitting and/or receiving information.

The control circuit 802 may also be in communication with an input circuit(s) 806. The input circuit 806 may include an actuator(s) (e.g., one or more buttons) and/or a sensor circuit (e.g., an occupancy sensor circuit, a daylight sensor circuit, or a temperature sensor circuit) for receiving input that may be sent to a control-target device for controlling an electrical load. For example, the control-source device may receive input from the input circuit 806 to put the control circuit 802 in an association mode and/or communicate association messages from the control-source device. The control circuit 802 may receive information from the input circuit 806 (e.g. an indication that a button has been actuated or sensed information). Each of the modules within the control-source device 800 may be powered by a power source 810. One will recognize that control-source device 800 may include other, fewer, and/or additional modules.

In addition to what has been described herein, the methods and systems may also be implemented in a computer program(s), software, firmware, or other computer-executable instructions incorporated in one or more computer-readable media for execution by a computer(s) or processor(s), for example. Examples of computer-readable media include electronic signals (transmitted over wired or wireless connections) and tangible/non-transitory computer-readable storage media. Examples of tangible/non-transitory computer-readable storage media include, but are not limited to, a read only memory (ROM), a random-access memory (RAM), removable disks, and optical media such as CD-ROM disks, and digital versatile disks (DVDs).

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure.

What is claimed is:

1. A method comprising:
displaying a graphical user interface that enables configuration of a scene for controlling a zone comprising at least one lighting control device configured to control a corresponding lighting load, wherein the graphical user interface comprises a lighting intensity bar for configuring the lighting intensity of the lighting load for the scene, and wherein the lighting intensity bar is configured to display in at least one of a first and a second of a plurality of resolution states to enable different resolutions of control for a user;
when the lighting intensity bar is displayed in the graphical user interface in the first resolution state, receiving a first input from the user in the lighting intensity bar, wherein the first input is configured to cause the lighting intensity to change over a first range of lighting intensity values from a current lighting intensity value to a first lighting intensity value, and wherein the first input causes a control indicator in the lighting intensity bar to move by a first distance on the graphical user interface to indicate the change in the lighting intensity over the first range of lighting intensity values;
controlling the lighting load of the zone to the first lighting intensity value in response to the first input;
receiving an indication to change the lighting intensity bar from the first resolution state to the second resolution state;
when the lighting intensity bar is displayed in the graphical user interface in the second resolution state, receiving a second input from the user in the lighting intensity bar, wherein the second input is configured to cause the lighting intensity to change over a second range of lighting intensity values from the first lighting intensity value to a second lighting intensity value, and wherein the second input causes the control indicator in the lighting intensity bar to move by a second distance on the graphical user interface to indicate the change in the lighting intensity over the second range of lighting intensity values, wherein the second distance over which the control indicator moves is greater than or equal to the first distance, and wherein the second range of lighting intensity values is less than the first range of lighting intensity values over which the lighting load is controlled; and
controlling the lighting load of the zone to the second lighting intensity value in response to the second input.

2. The method of claim 1, wherein the second resolution state of the lighting intensity bar includes tick marks at a lower-percentage change in the lighting intensity than the first resolution state of the lighting intensity bar.

3. The method of claim 2, wherein the second resolution state of the lighting intensity bar provides a zoomed-in sub-portion of the first range of lighting intensity values that are displayed when the lighting intensity bar is in the first resolution state.

4. The method of claim 1, wherein the indication includes an actuation of a button or a gesture by a user on the graphical user interface.

5. The method of claim 4, wherein the gesture comprises one of a swiping gesture or a pinch of the user's fingers together or away from each other.

6. The method of claim 1, wherein the graphical user interface comprises a palette for configuring a color setting for the scene, and wherein the palette is configured to display in at least a third and a fourth of the plurality of resolution states to enable different resolutions of control for the user.

7. The method of claim 6, the method further comprising:
when the palette is displayed in the graphical user interface in the third resolution state, receiving a third input from the user in the palette, wherein the third input is configured to cause the color setting to change over a first range of color values from a current color value to a first color value, and wherein the third input causes an actuator in the palette to move by a third distance on the graphical user interface to indicate the change in the color setting over the first range of color values;
controlling the lighting load of the zone to the first color value in response to the third input received from the user;
receiving an indication to change the palette from the third resolution state to a fourth resolution state;
when the palette is displayed in the graphical user interface in the fourth resolution state, receiving a fourth input from the user in the palette, wherein the fourth input is configured to cause the color setting to change over a second range of color values from the first color value to a second color value, wherein the fourth input causes the actuator in the palette to move by a fourth distance on the graphical user interface to indicate the change in the color setting over the second range of lighting intensity values, wherein the fourth distance over which the actuator moves on the palette is greater than or equal to the third distance, and wherein the second range of color values is less than the first range of color values; and
controlling the lighting load of the zone to the second color value in response to the fourth input received from the user.

8. The method of claim 7, wherein the color setting is a color temperature setting, wherein the first range of color values comprise a first range of color temperature values on a black-body curve, and wherein the second range of color values comprise a second range of color temperature values on the black-body curve.

9. The method of claim 7, wherein the color setting is a full color setting, wherein the first range of color values comprise a first range of full color values on an x-axis or a y-axis of the palette, and wherein the second range of color values comprise first range of full color values on an x-axis or a y-axis of the palette.

10. The method of claim 7, the method further comprising:
receiving an indication from a user to save the second lighting intensity value and the second color setting to the scene;
updating system configuration data to control the zone according to the second lighting intensity value and the second color setting in response to an activation of the scene;
receiving a triggering event configured to trigger the activation of the scene; and
controlling the zone to the second lighting intensity value and the second color setting.

11. The method of claim 10, further comprising:
receiving an indication that the zone is an unaffected zone in the scene that is defined as being unaffected by the second lighting intensity value saved for the scene; and
in response to receiving the triggering event, preventing control of the unaffected zone to the second lighting intensity value, and wherein the unaffected zone maintains a current lighting intensity value to which the zone was controlled prior to the triggering event.

12. The method of claim 11, further comprising:
in response to receiving the triggering event, controlling the zone to the second color setting.

13. The method of claim 10, further comprising:
receiving an indication that the zone is an unaffected zone in the scene that is defined as being unaffected by the second color value saved for the scene; and
in response to receiving the triggering event, preventing control of the zone to the second color value, and wherein the zone maintains a current color setting to which the zone was controlled prior to the triggering event.

14. The method of claim 13, further comprising:
in response to receiving the triggering event, controlling the zone according to the second lighting intensity value.

15. The method of claim 1, the method further comprising:
receiving an indication to automatically select a color temperature setting based on the lighting intensity;
in response to receiving the first input, automatically selecting a first predefined color temperature value that corresponds to the first lighting intensity value, and wherein the lighting load of the zone is controlled to the first predefined color temperature value in response to the first input; and
in response to receiving the second input, automatically selecting a second predefined color temperature value that corresponds to the second lighting intensity value, and wherein the lighting load of the zone is controlled to the second predefined color temperature value in response to the second input.

16. The method of claim 15, further comprising:
receiving an indication from a user to save the second lighting intensity value to the scene;
updating system configuration data to control the zone to according to the second lighting intensity value and the second predefined color temperature value in response to an activation of the scene;
receiving a triggering event configured to trigger the activation of the scene; and
controlling the zone to the second lighting intensity value and the second color temperature value.

17. The method of claim 15, further comprising:
receiving an indication to enable manual selection of the color temperature setting by the user;
receiving a third color temperature value based on user input via the graphical user interface; and
updating system configuration data to control the zone to according to the second lighting intensity value and the third color temperature value in response to an activation of the scene.

18. The method of claim 1, wherein the zone is one of a plurality of zones configured to be controlled for the scene, the method further comprising:
determining that the lighting intensity for each zone of the plurality of zones is configured at a common lighting intensity;
displaying the common lighting intensity on the lighting intensity bar to allow absolute control of the plurality of lighting zones; and
in response to the first input and the second input, controlling the plurality of zones according to the common lighting intensity.

19. The method of claim 1, wherein the zone is one of a plurality of zones configured to be controlled for the scene, the method further comprising:
determining that the lighting intensity for each zone of the plurality of zones is configured at a different lighting intensity;
displaying one or more actuators on the graphical user interface configured to allow a relative change in the lighting intensity for each zone of the plurality of zones; and
in response to the first input and the second input, controlling each zone of the plurality of zones according to the relative change in the lighting intensity.

20. The method of claim 1, wherein the scene is a first scene of a plurality of scenes, the method further comprising:
receiving an indication from a user to save the second lighting intensity value to a second scene configured to control the lighting load of the zone in response to an activation of the second scene;
updating system configuration data to control the zone to according to the second lighting intensity value in response to the activation of the second scene;
receiving a triggering event configured to trigger the activation of the second scene; and
controlling the zone to the second lighting intensity value.

21. A method comprising:
receiving system configuration data for a load control system, wherein the system configuration data comprises a plurality of scenes for controlling one or more zones in an area of a building, wherein each zone comprises at least one lighting control device configured to control a corresponding lighting load;
displaying a graphical user interface that enables configuration of the plurality of scenes for controlling the one or more zones in the area, wherein the graphical user interface comprises: a scene identification interface that comprises an indication of each of the plurality of scenes, a zone identification interface that identifies each of the one or more zones with a corresponding lighting intensity and color setting, and a control interface that comprises a lighting intensity bar for configuring the lighting intensity and a palette for configuring the color setting for at least one of the one or more zones;
receiving a selection of a scene indicated in the scene identification interface;
in response to receiving the selection of the scene, updating the lighting intensity and the color setting identified for each of the one or more zones in the zone identification interface according the selected scene;
receiving a selection of a zone identified in the zone identification interface;
in response to receiving the selection of the zone, updating the lighting intensity bar and the palette with the respective lighting intensity setting and color setting that are stored in the selected scene for the selected zone;
receiving a change to at least one of the lighting intensity setting or the color setting via the control interface, wherein the change is from a first lighting intensity setting to a second lighting intensity setting or a first color setting to a second color setting;
controlling the lighting intensity or the color setting of the corresponding lighting load in the selected zone to the second lighting intensity setting or the second color setting;
receiving an indication from a user to save the change to the selected scene; and
updating the system configuration data to control the selected zone to the second lighting intensity setting or the second color setting in response to an activation of the selected scene;
receiving a triggering event configured to trigger the activation of the selected scene; and
controlling the one or more zones according to the updated system configuration data.

22. The method of claim 21, wherein the lighting intensity bar is configured to display in at least one of a first and a second of a plurality of resolution states to enable different resolutions of control for the user, the method further configured to:
when the lighting intensity bar is displayed in the graphical user interface in the first resolution state, receiving a first input from the user in the lighting intensity bar, wherein the first input is configured to cause the lighting intensity to change over a first range of lighting intensity values from a current lighting intensity value to a first lighting intensity value, and wherein the first input causes a control indicator in the lighting intensity bar to move by a first distance on the graphical user interface to indicate the change in the lighting intensity over the first range of lighting intensity values;
controlling the lighting load of the selected zone to the first lighting intensity value in response to the first input;
receiving an indication to change the lighting intensity bar from the first resolution state to the second resolution state;
when the lighting intensity bar is displayed in the graphical user interface in the second resolution state, receiving a second input from the user in the lighting intensity bar, wherein the second input is configured to cause the lighting intensity to change over a second range of lighting intensity values from the first lighting intensity value to a second lighting intensity value, and wherein the second input causes the control indicator in the lighting intensity bar to move by a second distance on the graphical user interface to indicate the change in the lighting intensity over the second range of lighting intensity values, wherein the second distance over which the control indicator moves is greater than or equal to the first distance, and wherein the second range of lighting intensity values is less than the first range of lighting intensity values over which the lighting load is controlled; and
controlling the lighting load of the selected zone to the second lighting intensity value in response to the second input.

23. The method of claim 22, wherein the second resolution state of the lighting intensity bar includes tick marks at a lower-percentage change in the lighting intensity than the first resolution state of the lighting intensity bar.

24. The method of claim 23, wherein the second resolution state of the lighting intensity bar provides a zoomed-in sub-portion of the first range of lighting intensity values that are displayed when the lighting intensity bar is in the first resolution state.

25. The method of claim 22, wherein the indication includes an actuation of a button or a gesture by a user on the graphical user interface.

26. The method of claim 25, wherein the gesture comprises one of a swiping gesture or a pinch of the user's fingers together or away from each other.

27. The method of claim 22, wherein the palette is configured to display in at least a third and a fourth of the plurality of resolution states to enable different resolutions of control for the user.

28. The method of claim 22, the method further comprising:
when the palette is displayed in the graphical user interface in the third resolution state, receiving a third input from the user in the palette, wherein the third input is configured to cause the color setting to change over a first range of color values from a current color value to a first color value, and wherein the third input causes an actuator in the palette to move by a third distance on the graphical user interface to indicate the change in the color setting over the first range of color values;
controlling the lighting load of the selected zone to the first color value in response to the third input received from the user;
receiving an indication to change the palette from the third resolution state to the fourth resolution state;
when the palette is displayed in the graphical user interface in the fourth resolution state, receiving a fourth input from the user in the palette, wherein the fourth input is configured to cause the color setting to change over a second range of color values from the first color value to a second color value, wherein the fourth input causes the actuator in the palette to move by a fourth distance on the graphical user interface to indicate the change in the color setting over the second range of lighting intensity values, wherein the fourth distance over which the actuator moves on the palette is greater than or equal to the third distance, and wherein the second range of color values is less than the first range of color values; and
controlling the lighting load of the selected zone to the second color value in response to the fourth input received from the user.

29. The method of claim 28, wherein the color setting is a color temperature setting, wherein the first range of color values comprise a first range of color temperature values on a black-body curve, and wherein the second range of color values comprise a second range of color temperature values on the black-body curve.

30. The method of claim 28, wherein the color setting is a full color setting, wherein the first range of color values comprise a first range of full color values on an x-axis or a y-axis of the palette, and wherein the second range of color values comprise first range of full color values on an x-axis or a y-axis of the palette.

31. The method of claim 28, the method further comprising:
receiving an indication from the user to save the second lighting intensity value and the second color setting to the selected scene;
updating system configuration data to control the selected zone according to the second lighting intensity value and the second color setting in response to the activation of the selected scene;
receiving a triggering event configured to trigger the activation of the selected scene; and
controlling the selected zone to the second lighting intensity value and the second color setting.

32. The method of claim 31, further comprising:
receiving an indication that the selected zone is an unaffected zone in the selected scene that is defined as being unaffected by the second lighting intensity value saved for the selected scene; and
in response to receiving the triggering event, preventing control of the unaffected zone to the second lighting intensity value, and wherein the unaffected zone maintains a current lighting intensity value to which the selected zone was controlled prior to the triggering event.

33. The method of claim 32, further comprising:
in response to receiving the triggering event, controlling the selected zone to the second color setting.

34. The method of claim 31, further comprising:
receiving an indication that the selected zone is an unaffected zone in the selected scene that is defined as being unaffected by the second color value saved for the selected scene; and
in response to receiving the triggering event, preventing control of the selected zone to the second color value, and wherein the selected zone maintains a current color setting to which the selected zone was controlled prior to the triggering event.

35. The method of claim 34, further comprising:
in response to receiving the triggering event, controlling the selected zone according to the second lighting intensity value.

36. The method of claim 22, the method further comprising:
receiving an indication to automatically select a color temperature setting based on the lighting intensity;
in response to receiving the first input, automatically selecting a first predefined color temperature value that corresponds to the first lighting intensity value, and wherein the lighting load of the selected zone is controlled to the first predefined color temperature value in response to the first input; and
in response to receiving the second input, automatically selecting a second predefined color temperature value that corresponds to the second lighting intensity value, and wherein the lighting load of the selected zone is controlled to the second predefined color temperature value in response to the second input.

37. The method of claim 36, further comprising:
receiving an indication from a user to save the second lighting intensity value to the selected scene;
updating system configuration data to control the selected zone to according to the second lighting intensity value and the second predefined color temperature value in response to the activation of the selected scene;
receiving the triggering event configured to trigger the activation of the selected scene; and
controlling the selected zone to the second lighting intensity value and the second color temperature value.

38. The method of claim 36, further comprising:
receiving an indication to enable manual selection of the color temperature setting by the user;
receiving a third color temperature value based on user input via the graphical user interface; and
updating system configuration data to control the selected zone to according to the second lighting intensity value and the third color temperature value in response to the activation of the selected scene.

39. The method of claim 22, wherein the selected zone is one of a plurality of zones configured to be controlled for the selected scene, the method further comprising:
determining that the lighting intensity for each zone of the plurality of zones is configured at a common lighting intensity;
displaying the common lighting intensity on the lighting intensity bar to allow absolute control of the plurality of lighting zones; and
in response to the first input and the second input, controlling the plurality of zones according to the common lighting intensity.

40. The method of claim 22, wherein the selected zone is one of a plurality of zones configured to be controlled for the selected scene, the method further comprising:
determining that the lighting intensity for each zone of the plurality of zones is configured at a different lighting intensity;
displaying one or more actuators on the graphical user interface configured to allow a relative change in the lighting intensity for each zone of the plurality of zones; and
in response to the first input and the second input, controlling each zone of the plurality of zones according to the relative change in the lighting intensity.

41. The method of claim 22, wherein the selected scene is a first scene of the plurality of scenes, the method further comprising:
receiving an indication from a user to save the second lighting intensity value to a second scene configured to control the lighting load of the selected zone in response to an activation of the second scene;
updating system configuration data to control the selected zone to according to the second lighting intensity value in response to the activation of the second scene;
receiving the triggering event configured to trigger the activation of the second scene; and
controlling the selected zone to the second lighting intensity value.

42. The method of claim 22, further comprising:
updating the lighting intensity and color setting in the zone identification interface in response to the change to the at least one of the lighting intensity setting or the color setting via the control interface.

43. A device comprising:
a display; and
a control circuit configured to:
display, via the display, a graphical user interface that enables configuration of a scene for controlling a zone comprising at least one lighting control device configured to control a corresponding lighting load, wherein the graphical user interface comprises a lighting intensity bar for configuring the lighting intensity of the lighting load for the scene, and wherein the lighting intensity bar is configured to display in at least one of a first and a second of a plurality of resolution states to enable different resolutions of control for a user;
when the lighting intensity bar is displayed in the graphical user interface in the first resolution state, receive a first input from the user in the lighting intensity bar, wherein the first input is configured to cause the lighting intensity to change over a first range of lighting intensity values from a current lighting intensity value to a first lighting intensity value, and wherein the first input causes a control indicator in the lighting intensity bar to move by a first distance on the graphical user interface to indicate the change in the lighting intensity over the first range of lighting intensity values;
control the lighting load of the zone to the first lighting intensity value in response to the first input;
receive an indication to change the lighting intensity bar from the first resolution state to the second resolution state;
when the lighting intensity bar is displayed in the graphical user interface in the second resolution state, receive a second input from the user in the lighting intensity bar, wherein the second input is configured to cause the lighting intensity to change over a second range of lighting intensity values from the first lighting intensity value to a second lighting intensity value, and wherein the second input causes the control indicator in the lighting intensity bar to move by a second distance on the graphical user interface to indicate the change in the lighting intensity over the second range of lighting intensity values, wherein the second distance over which the control indicator moves is greater than or equal to the first distance, and wherein the second range of lighting intensity values is less than the first range of lighting intensity values over which the lighting load is controlled; and
control the lighting load of the zone to the second lighting intensity value in response to the second input.

44. A computer-readable storage medium having computer executable instructions stored thereon that, when executed by a control circuit, cause the control circuit to:
display a graphical user interface that enables configuration of a scene for controlling a zone comprising at least one lighting control device configured to control a corresponding lighting load, wherein the graphical user interface comprises a lighting intensity bar for configuring the lighting intensity of the lighting load for the scene, and wherein the lighting intensity bar is configured to display in at least one of a first and a second of a plurality of resolution states to enable different resolutions of control for a user;
when the lighting intensity bar is displayed in the graphical user interface in the first resolution state, receive a first input from the user in the lighting intensity bar, wherein the first input is configured to cause the lighting intensity to change over a first range of lighting intensity values from a current lighting intensity value to a first lighting intensity value, and wherein the first input causes a control indicator in the lighting intensity bar to move by a first distance on the graphical user interface to indicate the change in the lighting intensity over the first range of lighting intensity values;
control the lighting load of the zone to the first lighting intensity value in response to the first input;
receive an indication to change the lighting intensity bar from the first resolution state to the second resolution state;
when the lighting intensity bar is displayed in the graphical user interface in the second resolution state, receive a second input from the user in the lighting intensity bar, wherein the second input is configured to cause the lighting intensity to change over a second range of lighting intensity values from the first lighting intensity value to a second lighting intensity value, and wherein the second input causes the control indicator in the lighting intensity bar to move by a second distance on the graphical user interface to indicate the change in the lighting intensity over the second range of lighting intensity values, wherein the second distance over which the control indicator moves is greater than or equal to the first distance, and wherein the second range of lighting intensity values is less than the first range of lighting intensity values over which the lighting load is controlled; and
control the lighting load of the zone to the second lighting intensity value in response to the second input.

45. A device comprising:
a display; and
a control circuit configured to:
receive system configuration data for a load control system, wherein the system configuration data comprises a plurality of scenes for controlling one or more zones in an area of a building, wherein each zone comprises at least one lighting control device configured to control a corresponding lighting load;
display, via the display, a graphical user interface that enables configuration of the plurality of scenes for controlling the one or more zones in the area, wherein the graphical user interface comprises: a scene identification interface that comprises an indication of each of the plurality of scenes, a zone identification interface that identifies each of the one or more zones with a corresponding lighting intensity and color setting, and a control interface that comprises a lighting intensity bar for configuring the lighting intensity and a palette for configuring the color setting for at least one of the one or more zones;
receive a selection of a scene indicated in the scene identification interface;
in response to receiving the selection of the scene, update the lighting intensity and the color setting identified for each of the one or more zones in the zone identification interface according the selected scene;
receive a selection of a zone identified in the zone identification interface;
in response to receiving the selection of the zone, update the lighting intensity bar and the palette with the respective lighting intensity setting and color setting that are stored in the selected scene for the selected zone;
receive a change to at least one of the lighting intensity setting or the color setting via the control interface, wherein the change is from a first lighting intensity setting to a second lighting intensity setting or a first color setting to a second color setting;
control the lighting intensity or the color setting of the corresponding lighting load in the selected zone to the second lighting intensity setting or the second color setting;
receive an indication from a user to save the change to the selected scene;
update the system configuration data to control the selected zone to the second lighting intensity setting or the second color setting in response to an activation of the selected scene;
receive a triggering event configured to trigger the activation of the selected scene; and
control the one or more zones according to the updated system configuration data.

46. A computer-readable storage medium having computer executable instructions stored thereon that, when executed by a control circuit, cause the control circuit to:
receive system configuration data for a load control system, wherein the system configuration data comprises a plurality of scenes for controlling one or more zones in an area of a building, wherein each zone comprises at least one lighting control device configured to control a corresponding lighting load;
display, via the display, a graphical user interface that enables configuration of the plurality of scenes for controlling the one or more zones in the area, wherein the graphical user interface comprises: a scene identification interface that comprises an indication of each of the plurality of scenes, a zone identification interface that identifies each of the one or more zones with a corresponding lighting intensity and color setting, and a control interface that comprises a lighting intensity bar for configuring the lighting intensity and a palette for configuring the color setting for at least one of the one or more zones;
receive a selection of a scene indicated in the scene identification interface;
in response to receiving the selection of the scene, update the lighting intensity and the color setting identified for each of the one or more zones in the zone identification interface according the selected scene;
receive a selection of a zone identified in the zone identification interface;
in response to receiving the selection of the zone, update the lighting intensity bar and the palette with the respective lighting intensity setting and color setting that are stored in the selected scene for the selected zone;
receive a change to at least one of the lighting intensity setting or the color setting via the control interface, wherein the change is from a first lighting intensity setting to a second lighting intensity setting or a first color setting to a second color setting;
control the lighting intensity or the color setting of the corresponding lighting load in the selected zone to the second lighting intensity setting or the second color setting;
receive an indication from a user to save the change to the selected scene;
update the system configuration data to control the selected zone to the second lighting intensity setting or the second color setting in response to an activation of the selected scene;
receive a triggering event configured to trigger the activation of the selected scene; and
control the one or more zones according to the updated system configuration data.
